(19) United States
(12) Patent Application Publication
(10) Pub. No.: US 2026/0333361 A1
(43) Pub. Date: Oct. 22, 2026

(54) METHOD AND APPARATUS FOR TRANSMITTING UPLINK DATA IN WIRELESS COMMUNICATION SYSTEM

(71) Applicant: Samsung Electronics Co., Ltd., Suwon-si, Gyeonggi-do (KR)

(72) Inventors: Seongmok LIM, Suwon-si (KR); Ameha Tsegaye ABEBE, Suwon-si (KR); Kyunggyu LEE, Suwon-si (KR); Youngrok JANG, Suwon-si (KR); Hyoungju JI, Suwon-si (KR); Kyungjun CHOI, Suwon-si (KR)

(21) Appl. No.: 19/472,592

(22) PCT Filed: Apr. 5, 2024
(86) PCT No.: PCT/KR2024/004527

§ 371 Date: Oct. 3, 2025

(30) Foreign Application Priority Data
Apr. 7, 2023 (KR) 10-2023-0046385
Aug. 17, 2023 (KR) 10-2023-0107619

(51) Int. Cl. H04W 72/21; H04L 5/00

(52) U.S. Cl. CPC H04W 72/21; H04L 5/0051; H04L 5/0053

(57) ABSTRACT

The present disclosure relates to a 5G or 6G communication system for supporting higher data transmission rates. The present disclosure relates to operations of a terminal and a base station in a wireless communication system and, more particularly, the present disclosure provides a method performed by a terminal in a wireless communication system, comprising the steps of: transmitting, to a base station, capability information indicating whether multi-panel simultaneous transmission is supported; receiving, from the base station, a radio resource control (RRC) message including information about one or more transmission configuration indicator (TCI) states for uplink transmission and information about the multi-panel simultaneous transmission; receiving, from the base station, a medium access control (MAC) control element (CE) for activating at least one TCI state; and transmitting an uplink signal on the basis of the activated at least one TCI state.

### TECHNICAL FIELD

The disclosure relates generally to a wireless communication system and, more specifically, to a method and an apparatus for transmitting, based on multi-panel simultaneous transmission, an uplink control channel in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving systemnetworks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Based on the discussion above, the disclosure provides an apparatus and a method for transmitting, based on multi-panel simultaneous transmission, an uplink control channel in a wireless communication system.

### Solution to Problem

According to various embodiments of the disclosure, a method performed by a user equipment (UE) in a wireless communication system may include transmitting, to a base station, capability information indicating whether to support multi-panel simultaneous transmission, receiving, from the base station, a radio resource control (RRC) message including information on the multi-panel simultaneous transmission and information on one or more transmission configuration indicator (TCI) states for uplink transmission, receiving a medium access control (MAC) control element (CE) for activating at least one TCI state from the base station, and transmitting, based the at least one activated TCI state, an uplink signal.

According to various embodiments of the disclosure, a UE device in a wireless communication system may include a transceiver, and at least one controller coupled to the transceiver, wherein the at least one controller is configured to transmit, to a base station, capability information indicating whether to support multi-panel simultaneous transmission, receive, from the base station, a radio resource control (RRC) message including information on the multi-panel simultaneous transmission and information on one or more transmission configuration indicator (TCI) states for uplink transmission, receive a medium access control (MAC) control element (CE) for activating at least one TCI state from the base station, and transmit, based the at least one activated TCI state, an uplink signal.

### Advantageous Effects of Invention

Through the embodiments of the disclosure, an apparatus and a method for effectively providing a service in a wireless communication system are provided.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of a bandwidth part configuration in a wireless communication system according to an embodiment of the disclosure;

FIG. 4 illustrates radio protocol structures of a base station and a UE in single cell, carrier aggregation, and dual connectivity situations in a wireless communication system according to an embodiment of the disclosure.

FIG. 5 illustrates an example of an uplink/downlink (UL/DL) configuration in a wireless communication system according to an embodiment of the disclosure.

FIG. 6 illustrates an example of base station beam allocation according to transmission configuration indicator (TCI) state configurations in a wireless communication system according to an embodiment of the disclosure.

FIG. 7 illustrates an example of a beam application in a case where a unified TCI scheme is used in a wireless communication system according to an embodiment of the disclosure.

FIG. 8 illustrates a medium access control (MAC)-control element (CE) structure for activation and indication of a joint TCI state or a separate DL or UL TCI state in a wireless communication system according to an embodiment of the disclosure.

FIG. 9 illustrates an example of a control resource set configuration of a downlink control channel in a wireless communication system according to an embodiment of the disclosure.

FIG. 10 illustrates a structure of a downlink control channel in a wireless communication system according to an embodiment of the disclosure.

FIG. 11 illustrates an example of frequency domain resource allocation with regard to a physical downlink shared channel (PDSCH) in a wireless communication system according to an embodiment of the disclosure.

FIG. 12 illustrates an example of time domain resource allocation with regard to a PDSCH in a wireless communication system according to an embodiment of the disclosure.

FIG. 13 illustrates a process for a beam configuration and activation with regard to a PDSCH.

FIG. 14 illustrates an example of a medium access control (MAC)-control element (CE) for physical uplink control channel (PUCCH) resource group-based spatial relationship activation in a wireless communication system according to an embodiment of the disclosure.

FIG. 15 illustrates an example of physical uplink shared channel (PUSCH) repetition type B transmission in a wireless communication system according to an embodiment of the disclosure.

FIG. 16 illustrates an MAC-CE structure including single PHR information according to an embodiment of the disclosure.

FIG. 17 illustrates an MAC-CE structure including multiple pieces of PHR information according to an embodiment of the disclosure.

FIG. 18 illustrates an example of an antenna port configuration and resource allocation for cooperative communication in a wireless communication system according to an embodiment of the disclosure.

FIG. 19 illustrates an example of a downlink control information (DCI) configuration for cooperative communication in a wireless communication system according to an embodiment of the disclosure.

FIG. 20 illustrates an enhanced PDSCH TCI state activation/deactivation MAC-CE structure.

FIG. 21 illustrates another MAC-CE structure for activation and indication of multiple joint TCI states or separate DL or UL TCI states in a wireless communication system according to an embodiment of the disclosure.

FIG. 22 illustrates another MAC-CE structure for activation and indication of multiple joint TCI states or separate DL or UL TCI states in a wireless communication system according to an embodiment of the disclosure.

FIG. 23 is a flowchart illustrating an operation of a UE capable of supporting multi-panel simultaneous transmission.

FIG. 24 is a flowchart illustrating an operation of a base station supporting a UE capable of supporting multi-panel simultaneous transmission.

FIG. 25 illustrates a structure of a UE in a wireless communication system according to an embodiment of the disclosure.

FIG. 26 illustrates a structure of a base station in a wireless communication system according to an embodiment of the disclosure.

### MODE FOR THE INVENTION

Hereinafter, embodiments of the disclosure will be described in detail with reference to the accompanying drawings. In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink(DL)” may refer to a radio link via which a base station transmits a signal to a terminal, and an “uplink(UL)” may refer to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) (or eNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description of the disclosure, the term “a/b” may be understood as a or b.

### [NR Time-Frequency Resources]

Hereinafter, a frame structure of a 5G system will be described in more detail with reference to the accompanying drawings.

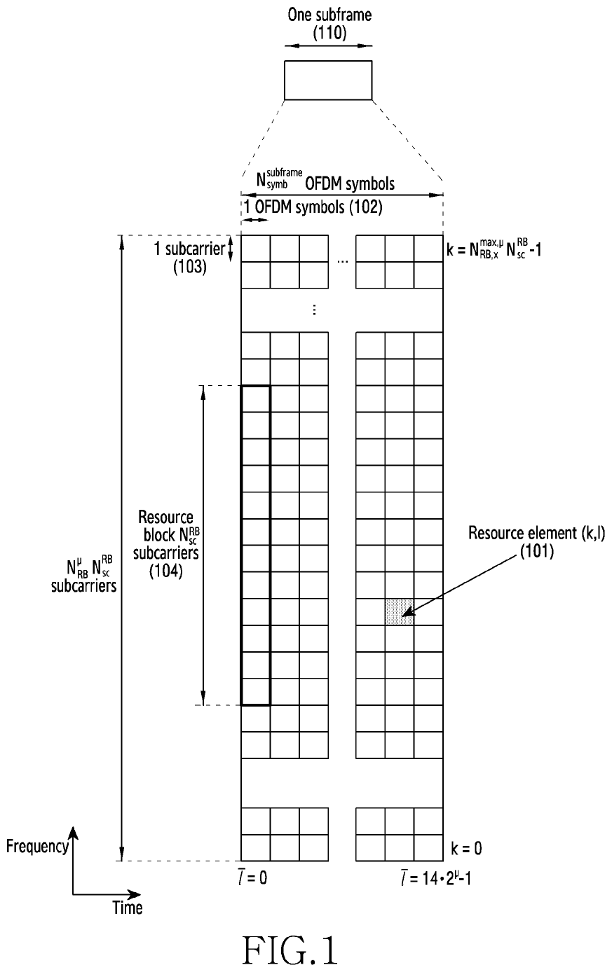

FIG. 1 illustrates a basic structure of a time-frequency domain in a wireless communication system according to an embodiment of the disclosure.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

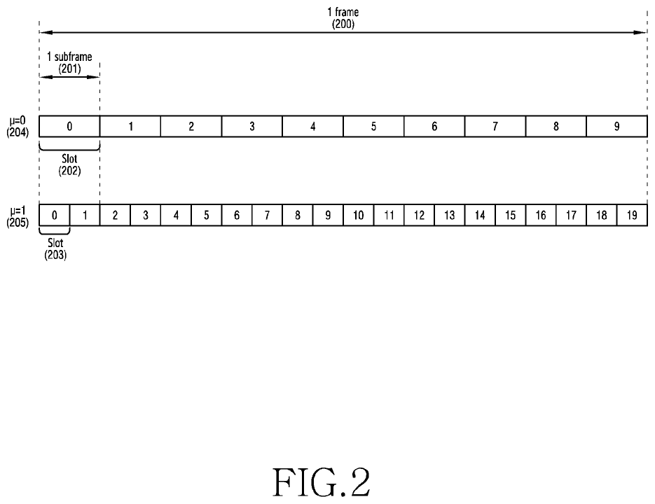

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values y for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. For example, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration p as in Table 1 below.

TABLE 1

| μ | ${N}_{symb}^{slot}$ | ${N}_{slot}^{f r ame , μ}$ | ${N}_{s l o t}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

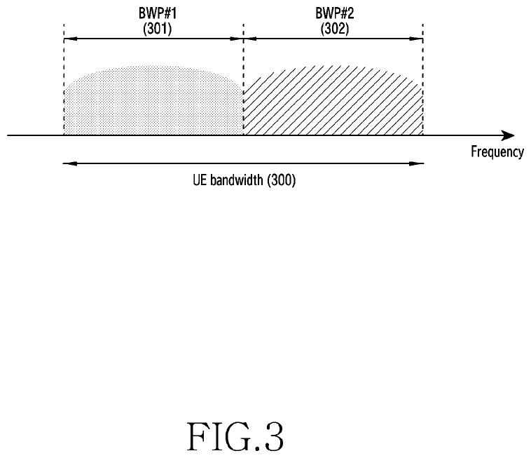

FIG. 3 illustrates an example of a bandwidth part configuration in a wireless communication system according to an embodiment of the disclosure;

FIG. 3 illustrates an example in which a UE bandwidth 300 is configured to include two bandwidth parts (e.g., bandwidth part #1 (BWP #1) 301 and bandwidth part #2 (BWP #2) 302). A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, n3, n4, n5}, |
| (subcarrier spacing) | |
| cyclicPrefix | ENUMERATED { extended } |
| (cyclic prefix) | |
| } | |

Obviously, the above example is not limiting, and various parameters related to the bandwidth part may be configured for the UE, in addition to the above configuration information. The base station may transfer the above information to the UE through higher layer signaling (e.g., radio resource control (RRC) signaling). One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (e.g., remaining system information (RMSI) or system information block 1 (SIB1)) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (e.g., configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth (for example, 100 MHz), and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (e.g., CORESET) configured for a downlink control channel, which may be used to transmit downlink control information (DCI) for scheduling a system information block (SIB), from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined as given below, for example.

TABLE 3

| | |
|---|---|
| | BWP switch delay |
| NR Slot | T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}. In addition, the UE may transmit/receive a data channel scheduled by the corresponding DCI in the changed new bandwidth part. According to an embodiment, if the base station wants to schedule a data channel by using the new bandwidth part, the base station may determine time domain resource allocation regarding the data channel, based on the UE's bandwidth part change delay time (T_{BWP}). For example, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (e.g., the last symbol of slot n+K−1).

### [Regarding CA/DC]

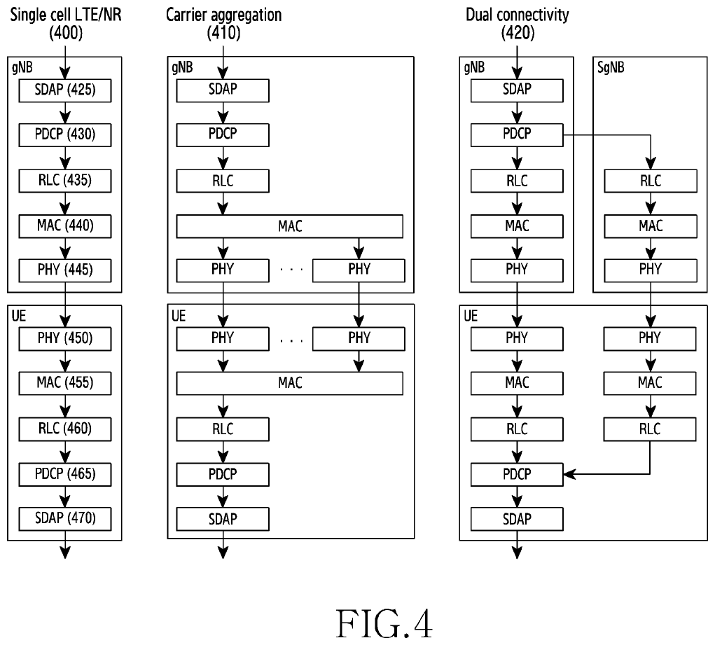

FIG. 4 illustrates radio protocol structures of a base station and a UE in single cell, carrier aggregation, and dual connectivity situations according to an embodiment of the disclosure.

Referring to FIG. 4, the radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MAC) 440 or 455, on each of UE and NR base station sides.

The main functions of the NR SDAP 425 or 470 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, the UE may be configured, through an RRC message, whether to use the header of the SDAP layer device with regard to each PDCP layer device or with regard to each bearer or with regard to each logical channel, or whether to use functions of the SDAP layer device. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering function of the NR PDCP device may refer to a function of reordering PDCP PDUs received from a lower layer in an order based on the PDCP sequence number (SN), and may include a function of transferring data to an upper layer in the reordered sequence. Alternatively, the reordering function of the NR PDCP device may include a function of instantly transferring data without considering the order, may include a function of recording PDCP PDUs lost as a result of reordering, may include a function of reporting the state of the lost PDCP PDUs to the transmitting side, or may include a function of requesting retransmission of the lost PDCP PDUs.

The main functions of the NR RLC 435 or 460 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may process RLC PDUs in the received order (e.g., regardless of the sequence number order, in the order of arrival) and deliver same to the PDCP device regardless of the order (out-of-sequence delivery), and in the case of segments, may receive segments which are stored in a buffer or which are to be received later, reconfigure same into one complete RLC PDU, process, and deliver same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the higher layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as the radio protocol structure 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as the radio protocol structure 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as the radio protocol structure 420.

### [Regarding Slot Format Indication]

Hereinafter, a method for indicating a slot format to a UE by a base station is described. In the 5G communication system, a downlink signal transmission interval and an uplink signal transmission interval may be dynamically changed. To this end, the base station may indicate, to the UE through a slot format indicator (SFI), whether each of the OFDM symbols included in one slot is a downlink symbol, an uplink symbol, or a flexible symbol. The flexible symbol may be a symbol which is neither a downlink symbol nor an uplink symbol, or may be a symbol that can be changed to a downlink or uplink symbol by UE-specific control information or scheduling information. In this case, the flexible symbol may include a gap guard required for a process of switching from the downlink to the uplink.

According to an embodiment, the UE having received the SFI may perform an operation of receiving a downlink signal from the base station in a symbol indicated as the downlink symbol, and perform an operation of transmitting an uplink signal to the base station in a symbol indicated as the uplink symbol. For the symbol indicated as the flexible symbol, the UE may perform a PDCCH monitoring operation, and may perform an operation of receiving a downlink signal from the base station (for example, in a case in which DCI format 1_0 or 1_1 is received) or perform an operation of transmitting an uplink signal to the base station (for example, in a case in which DCI format 0_0 or 0_1 is received) in the flexible symbol through another indicator (for example, DCI).

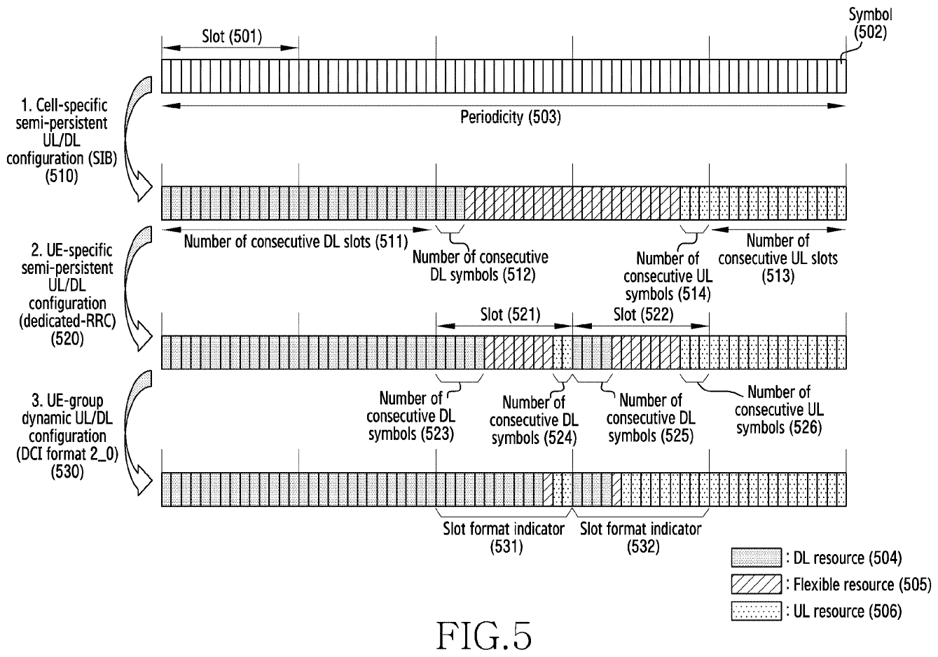

FIG. 5 illustrates an example of an uplink/downlink (UL/DL configuration) in a wireless communication system according to an embodiment of the disclosure. Referring to FIG. 5, three stages of the UL/DL configuration of symbols/slots are illustrated. Referring to FIG. 5, an example of a format including downlink symbol resources 504, flexible symbol resources 505, and uplink symbol resources 506 in units of slots 501 or symbols 502 is illustrated.

In a first stage, the base station may configure the UL/DL of the symbols/slots through cell-specific configuration information 510 for semi-static UL/DL configuration (for example, system information such as an SIB). Specifically, the cell-specific UL/DL configuration information 510 within the system information may include information indicating UL/DL pattern information and reference subcarrier spacing. The UL/DL pattern information may indicate a transmission periodicity 503 of each pattern, the number of consecutive downlink slots at the beginning of each pattern (number of consecutive full DL slots at the beginning of each DL-UL pattern) 511, the number of consecutive downlink symbols at the beginning of the next slot 512 (number of consecutive DL symbols in the beginning of the slot following the last full DL slot), the number of consecutive uplink slots from the end of each pattern 513 (number of consecutive full UL slots at the end of each DL-UL pattern), and the number of symbols of the previous slot 514 (number of consecutive UL symbols in the end of the slot preceding the first full UL slot). In this case, the UE may determine that the slot/symbol which is not indicated as the uplink or the downlink is the flexible slot/symbol.

In a second stage, UE-specific configuration information 520 transmitted through UE-dedicated higher layer signaling (for example, RRC signaling) may indicate symbols to be configured as the downlink or the uplink within the flexible slot or slots 521 and 522 including the flexible symbols. For example, the UE-specific uplink-downlink configuration information 520 may include a slot index indicating the slot 521 or 522 including the flexible symbol, the number of consecutive downlink symbols at the beginning of each slot 523 or 525 (number of consecutive DL symbols in the beginning of the slot), or the number of consecutive uplink symbols from the end of each slot 524 or 526 (number of consecutive UL symbols in the end of the slot), or may include at least one piece of information indicating the entire downlink or information indicating the entire uplink for each slot. In this case, the symbol/slot configured as the uplink or the downlink through the cell-specific configuration information 510 in the first stage cannot be changed to the downlink or the uplink through UE-specific higher layer signaling 520.

Last, in order to dynamically change a downlink signal transmission interval and an uplink signal transmission interval, downlink control information 530 of a downlink control channel may include a slot format indicator 531 or 532 indicating whether each symbol is a downlink symbol, an uplink symbol, or a flexible symbol in each of multiple slots, starting at the slot in which the UE detects the downlink control information. In this case, the slot format indicator 531 or 532 cannot indicate that the symbol/slot configured as the uplink or the downlink in the first and second stages is the downlink or the uplink. In the first and second stages, a slot format of each slot including at least one symbol which is not configured as the uplink or the downlink cannot be indicated by corresponding downlink control information

The slot format indicator may indicate an UL/DL configuration for 14 symbols in one slot as shown in [Table 4] below. The slot format indicator may be simultaneously transmitted to multiple UEs through a UE group (or cell) common control channel. For example, the downlink control information including the slot format indicator may be transmitted through a PDCCH which is CRC-scrambled by an identifier (for example, an SFI-RNTI) different from a UE-specific cell-radio network temporary identifier (C-RNTI). The downlink control information may include slot format indicators for one or more slots (for example, N slots). Here, a value of N may be an integer value larger than 0, or may be a value which the UE receives from the base station through higher layer signaling among a set of pre-defined available values such as 1, 2, 5, 10, and 20. The size of the slot format indicator may be configured for the UE by the base station through higher layer signaling.

TABLE 4

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL-ConfigurationCommon, |
| | or tdd-UL-DL-Configuration Dedicated and, if any, on detected DCI formate |

In [Table 4], D may indicate a downlink symbol, U may indicate an uplink symbol, and F may indicate a flexible symbol. According to [Table 4], the total number of slot formats that can be supported for one slot may be 256. In an NR system, the maximum size of information bits that can be used to indicate the slot formats may be 128 bits. The base station may configure information on the slot formats for the UE through higher-layer signaling (for example, dci-PayloadSize).

In this case, for a cell operating in a licensed or an unlicensed band, the base station may introduce one or more additional slot formats, or modify one or more of the existing slot formats, so as to configure and indicate the additional slot formats as shown in [Table 5]. [Table 5] shows an example of additional slot formats in which one slot includes only uplink symbols and flexible symbols (F).

TABLE 5

| | Symbol number (or index) within one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 56 | F | U | U | U | U | U | U | U | U | U | U | U | U | U |
| 57 | F | F | U | U | U | U | U | U | U | U | U | U | U | U |
| 58 | U | U | U | U | U | U | U | U | U | U | U | U | U | F |
| 59 | U | U | U | U | U | U | U | U | U | U | U | U | F | F |
| . . . | | | | | | | | | | | | | | |

In an embodiment, downlink control information used for indicating a slot format may indicate slot formats for multiple serving cells, and slot formats for the serving cell may be distinguished by a serving cell ID. Furthermore, for each serving cell, a slot format combination of one or more slots may be indicated by the downlink control information. For example, when the size of one slot format indicator index field within downlink control information is 3 bits and indicates a slot format for one serving cell, the 3-bit slot format indicator index field may indicate one of a total of 8 slot formats (or slot format combinations), and the base station may indicate the slot format indicator index field through UE common downlink control information (DCI).

In an embodiment, at least one slot format indicator index field included in the downlink control information may include a slot format combination indicator of multiple slots. For example, [Table 6] shows 3-bit slot format combination indicators including slot formats of [Table 4] and [Table 5]. Among the values of the slot format combination indicators, {0, 1, 2, 3, 4} indicate slot formats for one slot. The three remaining values {5, 6, 7} indicate slot formats for four slots, and the UE may apply the indicated slot format to the four slots sequentially from the slot in which downlink control information including the slot format combination indicators is detected.

TABLE 6

| Slot format | Slot |
|---|---|
| combination ID | Formats |
| 0 | 0 |
| 1 | 1 |
| 2 | 2 |
| 3 | 19 |
| 4 | 9 |
| 5 | 0 0 0 0 |
| 6 | 1 1 1 1 |
| 7 | 2 2 2 2 |

In an embodiment, when the UE is not configured to monitor DCI format 2_0 and some symbols of a specific slot are configured as flexible symbols (F) according to a slot format configured through higher-layer signaling, or a slot format of a specific slot is not configured, the UE may receive DCI, an RAR UL grant, a fallbackRAR UL grant, or a successRAR for some corresponding symbols within the corresponding slot and transmit at least one of a PUSCH, a physical uplink control channel (PUCCH), a physical random access channel (PRACH), or a sounding reference signal (SRS) indicated by the received information.

In an embodiment, when some symbols of a specific slot are configured as flexible symbols (F), based on a slot format configured through higher-layer signaling, the UE may not expect reception of an uplink transmission configuration (for example, a configured grant-based PUSCH, PUCCH, or SRS) to be transmitted in some corresponding symbols of the corresponding slot, based on higher-layer signaling.

In an embodiment, for example, when the UE receives scheduling of PUSCH transmission for multiple slots in DCI format 0_1 and at least one of the symbols through which the PUSCH should be transmitted are configured as the DL in one slot among multiple corresponding slot through higher-layer signaling, the UE may not perform PUSCH transmission in the corresponding slot.

In an embodiment, for example, when some symbols of a specific slot are configured as flexible symbols (F) through higher-layer signaling or a slot format for a specific slot is not configured, the UE receives DCI format 2_0, a slot format indicator value is not 255, flexible symbols (F) are indicated for some symbols of the corresponding slot, and the UE receives a DCI format, an RAR UL grant, or a successRAR indicating a PUSCH, a PUCCH, a PRACH, or an SRS within the corresponding flexible symbols, the UE may transmit the PUSCH, the PUCCH, the PRACH, or the SRS within the corresponding flexible symbols in the corresponding slot.

In some embodiments, when some symbols of a specific slot are configured as flexible symbols (F) through higher-layer signaling or a slot format for a specific slot is not configured, the UE receives DCI format 2_0, a slot format indicator value is not 255, and the UE is configured to transmit a PUCCH, a PUSCH, or a PRACH through higher-layer signaling for some symbols within the corresponding slot, the UE may transmit the preset PUCCH, PUSCH, or PRACH only when some corresponding symbols within the corresponding slot are indicated as uplink symbols (UL) through DCI format 2_0.

### [Rel-15/16 TCI State]

### [QCL, TCI State]

In a wireless communication system, one or more different antenna ports (alternatively, which may also be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 7 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 7 below.

TABLE 7

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to at least one of various parameters, such as angle of arrival (AoA), power angular spectrum (PAS) of AoA, angle of departure (AoD), PAS of AoD, transmit/receive channel correlation, transmit/receive beamforming, and spatial channel correlation.

The above QCL relations may be configured for the UE through RRC parameter TCI-state and QCL-info as in Table 8 below. Referring to Table 8, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) included in each TCI state includes the serving cell index and the BWP index of the reference RS indicated by the corresponding QCL information, the type and ID of the reference RS, and a QCL type as in Table 7 above.

TABLE 8

| | |
|---|---|
| TCI-State ::= | SEQUENCE { |
| tci-StateId | TCI-StateId, |
| (ID of corresponding TCI state) | |
| qcl-Type1 | QCL-Info, |

(QCL information of first refernece RS of RS (target RS) referring to corresponding TCI

| | | |
|---|---|---|
| state ID) | | |
| qcl-Type2 | QCL-Info | OPTIONAL, - |
| - Need R | | |

(QCL information of second refernece RS of RS (target RS) referring to corresponding

| | | |
|---|---|---|
| TCI state ID) | | |
| ... | | |
| } | | |
| QCL-Info ::= | SEQUENCE { | |
| cell | ServCellIndex | OPTIONAL, -- |
| Need R | | |

(serving cell index of reference RS indicated by corresponding QCL information)

| | | |
|---|---|---|
| bwp-Id | BWP-Id | OPTIONAL, -- |
| Cond CSI-RS-Indicated | | |

(BWP index of reference RS indicated by corresponding QCL information)

| | |
|---|---|
| referenceSignal | CHOICE { |
| csi-rs | NZP-CSI-RS-ResourceId, |
| ssb | SSB-Index |

(one of CSI-RS ID or SSB ID indicated by corresponding QCL information)

| }, | |
|---|---|
| qcl-Type | ENUMERATED {typeA, typeB, typeC, typeD}, |
| ... | |
| } | |

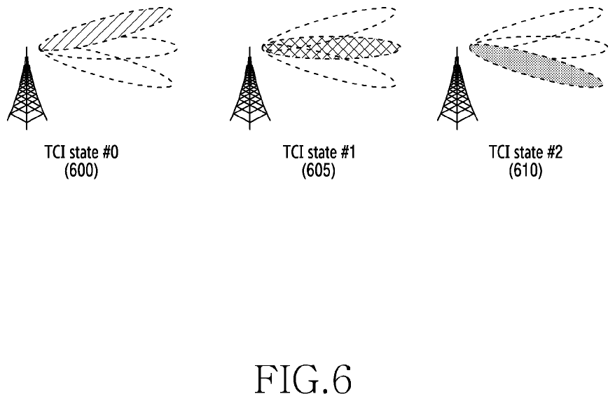

FIG. 6 illustrates an example of base station beam allocation according to transmission configuration indicator (TCI) state configurations in a wireless communication system according to an embodiment of the disclosure.

Referring to FIG. 6, the base station may transfer information regarding N different beams to the UE through N different TCI states. In the case of N=3 as in FIG. 6, the base station may configure qcl-Type2 parameters included in three TCI states 600, 605, and 610 in QCL type D while being associated with CSI-RSs or SSBs corresponding to different beams. The base station may announce that antenna ports referring to the different TCI states 600, 605, and 610 are associated with different spatial Rx parameters (for example, different beams).

Tables 9 to 13 below enumerate valid TC state configurations according to the target antenna port type. Table 9 enumerates valid TCI state configurations when the target antenna port is a CSI-RS for tracking (e.g., tracking reference signal (TRS)). The TRS may refer to an NZP CSI-RS which has no repetition parameter configured therefor, and trs-Info of which is configured as “true”, among CRI-RSs. In Table 10, configuration no. 3 may be used for an aperiodic TRS.

TABLE 9

| Valid | | | | |
|---|---|---|---|---|
| TCI state | | | DL RS 2 (If | qcl-Type2 (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Valid TC state configurations when the target antenna port is a CSI-RS for tracking (TRS)

Table 10 enumerates valid TCI state configurations when the target antenna port is a CSI-RS for CSI. The CSI-RS for CSI may refer to an NZP CSI-RS which has no parameter indicating repetition (e.g., repetition parameter) configured therefor, and trs-Info of which is not configured as “true”, among CRI-RSs.

TABLE 10

| Valid | | | | |
|---|---|---|---|---|
| TCI state | | | DL RS 2 (If | qcl-Type2 (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Valid TC state configurations when the target antenna port is a CSI-RS for CSI

Table 11 enumerates valid TC state configurations when the target antenna port is a CSI-RS for beam management (BM) (which has the same meaning as CSI-RS for L1 RSRP reporting). The CSI-RS for BM refers to an NZP CSI-RS which has are petition parameter configured to have a value of “on” or “off”, and trs-Info of which is not configured as “true”, among CRI-RSs.

TABLE 11

| Valid | | | | |
|---|---|---|---|---|
| TCI state | | | DL RS 2 (If | qcl-Type2 (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Valid TCI state configurations when the target antenna port is a CSI-RS for BM (for L1 RSRP reporting)

Table 12 enumerates valid TCI state configurations when the target antenna port is a PDCCH DMRS.

TABLE 12

| Valid | | | | |
|---|---|---|---|---|
| TCI state | | | DL RS 2 (If | qcl-Type2 (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Valid TCI state configurations when the target antenna port is a PDCCH DMRS

Table 13 enumerates valid TCI state configurations when the target antenna port is a PDSCH DMRS.

TABLE 13

| Valid | | | | |
|---|---|---|---|---|
| TCI state | | | DL RS 2 (If | qcl-Type2 (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

Valid TCI state configurations when the target antenna port is a PDSCH DMRS

A representative QCL configuration method based on Tables 9 to 13 may include configuring and operating the target antenna port and reference antenna port for each step as “SSB”→“TRS”→“CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [Rel-17 Unified TCT State]

### [Unified TCT State]

Hereinafter, a method for indicating and activating a single TCI state, based on a unified TCI scheme, will be described. The unified TCI scheme may refer to a scheme in which the conventional transmission/reception beam management in Rel-15 and Rel-16 is separated into a TCI state scheme used for a UE's downlink reception and a spatial relation info scheme used for uplink transmission, but the transmission/reception beam management is managed in an integrated manner by using a TCI state. Therefore, in a case where a UE receives an indication from a base station, based on the unified TCI scheme, the UE may perform beam management even for uplink transmission by using a TCI state. If the higher layer signaling TCI-State having the higher layer signaling tci-stateId-r17 is configured for a UE by a base station, the UE may perform an operation based on the unified TCI scheme by using the TCI-State. The TCI-State may exist in two types, that is, joint TCI state or separate TCI state.

The first type may be a joint TCI state in which all TCI states to be applied to uplink transmission and downlink reception may be indicated to a UE by a base station through one TCI-State. If a TCI-State based on a joint TCI state has been indicated to the UE, a parameter to be used for downlink channel estimation may be indicated to the UE by using an RS corresponding to qcl-Type1 in the TCI-State based on a joint TCI state, and a parameter to be used as a downlink reception beam or reception filter may be indicated to the UE by using an RS corresponding to qcl-Type2 therein. If a TCI-State based on a joint TCI state has been indicated to the UE, a parameter to be used as an uplink transmission beam or transmission filter may be indicated to the UE by using an RS corresponding to qcl-Type2 therein in the TCI-State based on a joint DL/UL TCI state. If a joint TCI state has been indicated to the UE, the UE may apply the same beam to both uplink transmission and downlink reception.

The second type may be a separate TCI state, and a UL TCI state to be applied to uplink transmission and a DL TCI state to be applied to downlink reception may be individually indicated to a UE by a base station. If a UL TCI state has been indicated to the UE, a parameter to be used as an uplink transmission beam or transmission filter may be indicated to the UE by using a reference RS or source RS configured in the UL TCI state. If a DL TCI state has been indicated to the UE, a parameter to be used for downlink channel estimation may be indicated to the UE by using an RS corresponding to qcl-Type1 in the DL TCI state, and a parameter to be used as a downlink reception beam or reception filter may be indicated to the UE by using an RS corresponding to qcl-Type2 therein.

If both a DL TCI state and a UD TCI state have been indicated to the UE, a parameter to be used as an uplink transmission beam or transmission filter may be indicated to the UE by using a reference RS or source RS configured in the UL TCI state, a parameter to be used for downlink channel estimation may be indicated to the UE by using an RS corresponding to qcl-Type1 configured in the DL TCI state, and a parameter to be used as a downlink reception beam or reception filter may be indicated to the UE by using an RS corresponding to qcl-Type2 configured therein. If the DL TCI state indicated to the UE and the reference RS or source RS configured in the UL TCI state are different, the UE may apply individual beams to uplink transmission and downlink reception, respectively, based on the UL TCI state and DL TCI state indicated thereto.

A maximum of 128 joint TCI states may be configured for a particular bandwidth part in a particular cell for the UE by the base station through higher layer signaling. Alternatively, a maximum of 64 or 128 DL TCI states among separate TCI states may be configured for a particular bandwidth part in a particular cell through higher layer signaling, based on a UE capability report, and a DL TCI state among separate TCI states and a joint TCI state may use the same higher layer signaling structure. As an example, if 128 joint TCI states have been configured, and if 64 DL TCI states have been configured among separate TCI states, the 64 DL TCI states may be included in the 128 joint TCI states.

According to an embodiment, a maximum of 32 or 64 UL TCI states among separate TCI states may be configured for a particular bandwidth part in a particular cell through higher layer signaling, based on a UE capability report, and a UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

Such use of different or identical higher layer signaling structures may be defined in specifications, or may be distinguished through different higher layer signaling configured by the base station, based on a UE capability report containing information regarding which is to be used among two schemes that the UE may support.

According to an embodiment, the UE may use one scheme, among a joint TCI state and a separate TCI state configured by the base station, thereby receiving an indication regarding transmission/reception beam according to a unified TCI scheme. The base station may configure, for the UE, whether or not one of the joint TCI state and the separate TCI state is to be used, through higher layer signaling.

According to an embodiment, the UE may receive an indication regarding transmission/reception beam by using a scheme selected from a joint TCI state and a separate TCI state through higher layer signaling, and the base station may indicate a transmission/reception beam in two methods (a MAC-CE-based indication method and a MAC-CE-based activation and DCI-based indication method).

According to an embodiment, if the UE receives an indication regarding transmission/reception beam by using a joint TCI state through higher layer signaling, the UE may receive a MAC-CE indicating a joint TCI state from the base station, thereby performing a transmission/reception beam application operation, and the base station may schedule reception regarding a PDSCH including the MAC-CE for the UE through a PDCCH. If the MAC-CE includes one joint TCI state set, the UE may determine an uplink transmission beam or transmission filter and a downlink reception beam or reception filter by using joint TCI states included in the indicated joint TCI state set 3 ms after transmission of a PUCCH including HARQ-ACK information indicating whether or not the PDSCH is successfully received. If the MAC-CE includes two or more joint TCI state sets, the UE may identify that multiple joint TCI state sets indicated by the MAC-CE correspond to respective codepoints of the TCI state field of DCI format 1_1 or 1_2 and then activate the indicated joint TCI state sets, 3 ms after transmission of a PUCCH including HARQ-ACK information indicating whether or not the PDSCH is successfully received. Thereafter, the UE may receive DCI format 1_1 or 1_2 and may apply one joint TCI state indicated by the TCI state field in corresponding DCI to uplink transmission and downlink reception beams. DCI format 1_1 or 1_2 may include downlink data channel scheduling information (with DL assignment) or may not include the same (without DL assignment).

According to an embodiment, if the UE receives an indication regarding transmission/reception beam by using a separate TCI state through higher layer signaling, the UE may receive a MAC-CE indicating a separate TCI state from the base station, thereby performing a transmission/reception beam application operation, and the base station may schedule reception regarding a PDSCH including the MAC-CE for the UE through a PDCCH. If the MAC-CE includes one separate TCI state set, the UE may determine an uplink transmission beam or transmission filter and a downlink reception beam or reception filter by using separate TCI states included in the indicated separate TCI state set 3 ms after transmission of a PUCCH including HARQ-ACK information indicating whether or not the PDSCH is successfully received. A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If the MAC-CE includes two or more separate TCI state sets, the UE may identify that multiple separate TCI state sets indicated by the MAC-CE correspond to respective codepoints of the TCI state field of DCI format 1_1 or 1_2 and then activate the indicated separate TCI state sets, 3 ms after transmission of a PUCCH including HARQ-ACK information indicating whether or not the PDSCH is successfully received. Each codepoint of the TCI state field of DCI format 1_1 or 1_2 may indicate one DL TCI state, may indicate one UL TCI state, or may indicate one DL TCI state and one UL TCI state. The UE may receive DCI format 1_1 or 1_2 and may apply separate TCI state sets indicated by the TCI state field in corresponding DCI to uplink transmission and downlink reception beams. DCI format 1_1 or 1_2 may include downlink data channel scheduling information (with DL assignment) or may not include the same (without DL assignment).

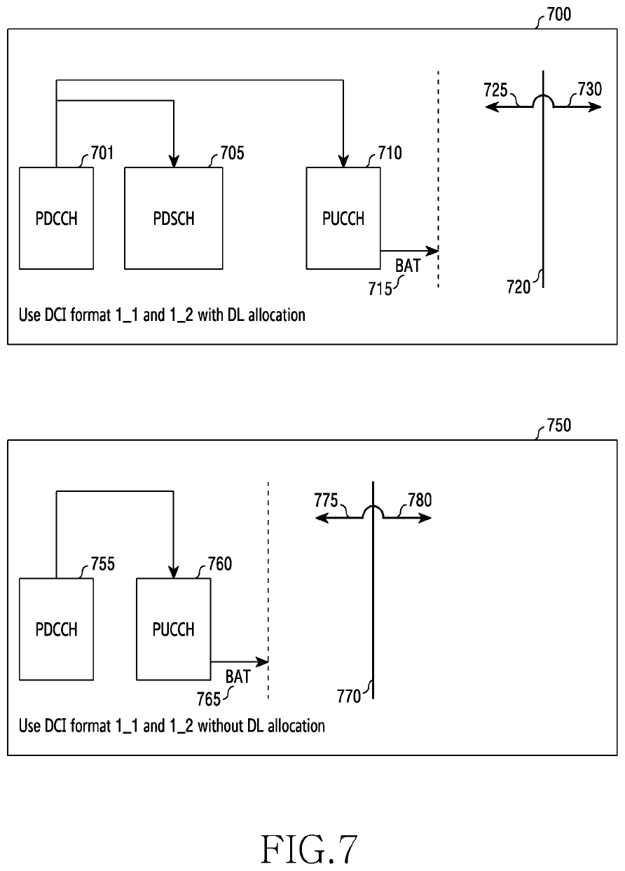

FIG. 7 illustrates a beam application time in a case where a unified TCI scheme is used in a wireless communication system according to an embodiment of the disclosure. As described above, the UE may receive DCI format 1_1 or 12 including downlink data channel scheduling information (with DL assignment) or not including the same (without DL assignment) from the base station, and may apply one joint TCI state or separate TCI state set indicted by the TCI state field in corresponding DCI to uplink transmission and downlink reception beams.

DCI format 1_1 or 1_2 with DL assignment (700): If a UE receives, from a base station, DCI format 1_1 or 1_2 including downlink data channel scheduling information (701) so that one joint TCI state or one separate TCI state set based on a unified TCI scheme is indicated, the UE may receive a PDSCH scheduled based on the received DCI (705), and transmit a PUCCH including a HARQ-ACK indicating whether reception of the DCI and the PDSCH has been successful (710). The HARQ-ACK may include whether reception has been successful, for both the DCI and the PDSCH, if the UE fails to receive at least one of the DCI and the PDSCH, the UE may transmit a NACK, and if the UE succeeds in receiving both of them, the UE may transmit an ACK.

DCI format 1_1 or 1_2 without DL assignment (750): If a UE receives, from a base station, DCI format 1_1 or 1_2 not including downlink data channel scheduling information (755) so that one joint TCI state or one separate TCI state set based on a unified TCI scheme is indicated, the UE may assume at least one combination of the following items for the DCI.
1) The DCI includes a CRC scrambled using a CS-RNTI.
2) The values of all bits assigned to all fields used as redundancy version (RV) fields are 1.
3) The values of all bits assigned to all fields used as modulation and coding scheme (MCS) fields are 1.
4) The values of all bits assigned to all fields used as new data indication (NDI) fields are 0.
5) In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit a PUCCH including a HARQ-ACK indicating whether DCI format 1_1 or 1_2 for which the items described above are assumed has been successfully received (760).
With regard to both DCI format 1_1 or 1_2 with DL assignment (700) and without DL assignment (750), if the new TCI state indicated through DCI 701 or 755 is the same as a TCI state that has previously been indicated and thus been being applied to uplink transmission and downlink reception beams, the UE may maintain the previously applied TCI state. If the new TCI state is different from the previously indicated TCI state, the UE may determine, as a time point for application of the joint TCI state or separate TCI state set, which is indictable by a TCI state field included in the DCI, a time point 730 or 780 after the first slot 720 or 770 after passage of a time interval as long as a beam application time (BAT) 715 or 765 after PUCCH transmission, and may use the previously indicated TCI state at a time point 725 or 775 before the slot 720 or 770.
With regard to both DCI format 1_1 or 1_2 with DL assignment (700) and without DL assignment (750), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through an MAC-CE or DCI to reception for control resource sets connected to all UE-specific search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific search spaces and to reception of a PDSCH scheduled by a PDCCH transmitted from the control resource sets, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for control resource sets connected to all UE-specific search spaces and reception of a PDSCH scheduled by a PDCCH transmitted from the control resource sets.

If one separate TCI state set indicated through a MAC-CE or DCI includes one DL TCI state and one UL TCI state, a UE may apply the DL TCI state to reception for control resource sets connected to all UE-specific search spaces and reception of a PDSCH scheduled by a PDCCH transmitted from the control resource sets, and apply the UL TCI state to all PUSCH and PUCCH resources.

### [Unified TCI State MAC-CE]

Hereinafter, a single TCI state indication and activation method based on a unified TCI scheme will be described. A PDSCH including a MAC-CE described below may be scheduled for a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. For example, the UE may activate each entry of the MAC-CE received from the base station in each codepoint of the TCI state field in DCI format 1_1 or 1_2.

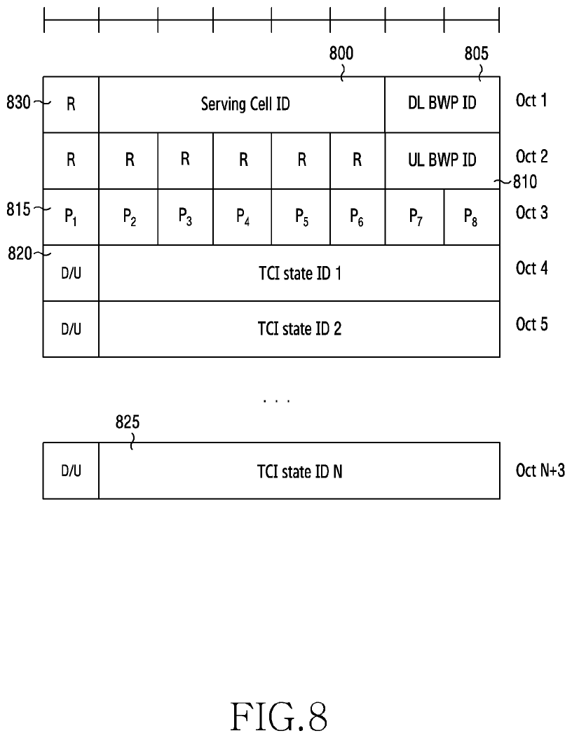

FIG. 8 illustrates a medium access control (MAC)-control element (CE) structure for activation and indication of a joint TCI state or a separate DL or UL TCI state in a wireless communication system according to an embodiment of the disclosure. Each field in the MAC-CE structure may have the following meaning.
Serving Cell ID 800: This field may indicate which serving cell to which a corresponding MAC-CE is to be applied. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.
DL BWP ID 805: This field may indicate which DL BWP to which the MAC-CE is to be applied, and the meanings of codepoints in the field may correspond to codepoints of a bandwidth part indicator in DCI, respectively. The length of this field may be 2 bits.
UL BWP ID 810: This field may indicate which UL BWP to which the MAC-CE is to be applied, and the meanings of codepoints in the field may correspond to codepoints of a bandwidth part indicator in DCI, respectively. The length of this field may be 2 bits.
Pᵢ 815: This field may indicate whether each codepoint of a TCI state field in DCI format 1_1 or 1_2 has multiple TCI states or one TCI state. If the value of Pᵢ is 1, this indicates that a corresponding i-th codepoint has multiple TCI states, and may imply that the codepoint may include a separate DL TCI state and a separate UL TCI state. If the value of Pi is 0, this indicates that a corresponding i-th codepoint has a single TCI state, and may imply that the codepoint may include one type among a joint TCI state, a separate DCI TCI state, or a separate UL TCI state.
D/U 820: This field may indicate whether a TCI state ID field in the same octet is a joint TCI state, a separate DL TCI state, or a separate UL TCI state. If the field is 1, a TCI state ID field in the same octet may be a joint TCI state or a separate DL TCI state, and If the field is 0, a TCI state ID field in the same octet may be a separate UL TCI state.
TCI state ID 825: This field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R 830: This indicates a reserved bit and may be configured to be 0.

With regard to the MAC-CE structure of FIG. 8, a UE may include, in the MAC-CE structure, a third octet including P₁, P₂, . . . , and P₈ fields in FIG. 8 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. According to another embodiment, with regard to the MAC-CE structure of FIG. 8, a UE may omit the third octet including P₁, P₂, . . . , and P₈ fields illustrated in FIG. 8, in a case where unifiedTCI-StateType-r17 in MIMOparam-r17 in the higher layer signaling ServingCellConfig being configured to be joint. In this case, the UE may save the payload of the MAC-CE by a maximum of 8 bits according to higher layer signaling configured by a base station. In addition, all D/U fields positioned on the first bits in octets starting from a fourth octet in FIG. 8 may be considered as R fields, and all the R fields may be configured to be 0 bits.

### [Downlink: PDCCH]

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

According to an embodiment, the DCI may be subjected to channel coding and modulation processes and then transmitted through a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. The RNTI may not be explicitly transmitted, but may be transmitted while being included in a CRC calculation process. Upon receiving a Di message transmitted through the PDCCH, the UE may identify the CRC by using the allocated RNTI, and if the CRC identification result is right, the UE may identify that the corresponding message has been transmitted to the UE.

According to an embodiment, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SF) may be scrambled by an SFI-RNTI. D for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 1_0 in which the CRC is scrambled by a C-RNTI may include the following pieces of information given in Table 14 below, for example.

```
TABLE 14
  - Identifier for DCI formats - [1] bit
  -  $Frequency domain resource assignment - [ ⌈ {log}_{2} ( {N}_{R B}^{UL , BWP} ( {N}_{R B}^{UL , BWP} + 1 ) / 2 ) ⌉ ] bits$
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - Transmit power control (TPC) command for scheduled PUSCH - [2] bits
  - Uplink/supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 15 below, for example.

```
TABLE 15
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
              $* For resource allocation type 0 , ⌈ {N}_{R B}^{UL , BWP} / P ⌉ bits$
              $* For resource allocation type 1 , ⌈ {log}_{2} ( {N}_{R B}^{UL , BWP} ( {N}_{R B}^{UL , BWP} + 1 ) / 2 ) ⌉ bits$
  - Time domain resource assignment - 1, 2, 3, or 4 bits
  - Virtual resource block (VRB)-to-physical resource block (PRB) mapping - 0 or 1
bit, only for resource allocation type 1.
              * 0 bit if only resource allocation type 0 is configured;
              * 1 bit otherwise.
  - Frequency hopping flag - 0 or 1 bit, only for resource allocation type 1.
              * 0 bit if only resource allocation type 0 is configured;
              * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
              * 1 bit for semi-static HARQ-ACK codebook;
              * 2 bits for dynamic HARQ-ACK codebook with single HARQ-ACK
              codebook.
  - 2nd downlink assignment index - 0 or 2 bits
              * 2 bits for dynamic HARQ-ACK codebook with two HARQ-ACK sub-
              codebooks;
              * 0 bit otherwise.
  - TPC command for scheduled PUSCH - 2 bits
  -  $SRS resource inidcator - ⌈ {log}_{2} ( {\sum }_{k = 1}^{{L}_{max} \sum } ( \begin{matrix}{N}_{SRS} \\ k\end{matrix} ) O ) □□ ⌉ or ⌈ {log}_{2} ( {N}_{SRS} ) ⌉ bits$
              $* ⌈ {log}_{2} ( {\sum }_{k = 1}^{{L}_{max} \sum } ( \begin{matrix}{N}_{SRS} \\ k\end{matrix} ) O ) □□ ⌉ bits for non - codebook based PUSCH$
              transmission;
              * [log₂(N_{SRS})] bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal (DDMRS)
association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 16 below, for example.

```
TABLE 16
  - Identifier for DCI formats - [1] bit
  -  $Frequency domain resource assignment - [ ⌈ {log}_{2} ( {N}_{RB}^{DL , BWP} ( {N}_{RB}^{DL , BWP} + 1 ) 2 ⌉ ] bits$
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Physical uplink control channel (PUCCH) resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 17 below, for example.

```
TABLE 17
  - Carrier indicator - 0 or 3 bits
  - Identifier for DCI formats - [1] bits
  - Bandwidth part indicator - 0, 1 or 2 bits
  - Frequency domain resource assignment
              $* For resource allocation type 0 , ⌈ {N}_{R B}^{DL , BWP} / P ⌉ bits$
              $* For resource allocation type 1 , ⌈ {log}_{2} ( {N}_{R B}^{DL , BWP} ( {N}_{R B}^{DL , BWP} + 1 ) / 2 ) ⌉ bits$
  - Time domain resource assignment - 1, 2, 3, or 4 bits
  - VRB-to-PRB mapping - 0 or 1 bit, only for resource allocation type 1.
              * 0 bit if only resource allocation type 0 is configured;
              * 1 bit otherwise.
  - Physical resource block (PRB) bundling size indicator - 0 or 1 bit
  - Rate matching indicator - 0, 1, or 2 bits
  - Zero power (ZP) channel state information (CSI)-reference signal (RS) trigger -
0, 1, or 2 bits
  For transport block 1:
  - Modulation and coding scheme - 5 bits
  - New data indicator - 1 bit
  - Redundancy version - 2 bits
  For transport block 2:
  - Modulation and coding scheme - 5 bits
  - New data indicator - 1 bit
  - Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ_feedback timing indicator - 3 bits
  - Antenna ports - 4, 5 or 6 bits
  - Transmission configuration indication - 0 or 3 bits
  - SRS request - 2 bits
  - CBG transmission information - 0, 2, 4, 6, or 8 bits
  - CBG flushing out information - 0 or 1 bit
  - DMRS sequence initialization - 1 bit
```

### [PDCCH: CORESET, REG, CCE, and Search Space]

Hereinafter, a downlink control channel in a 5G communication system will be described in more detail with reference to the accompanying drawings.

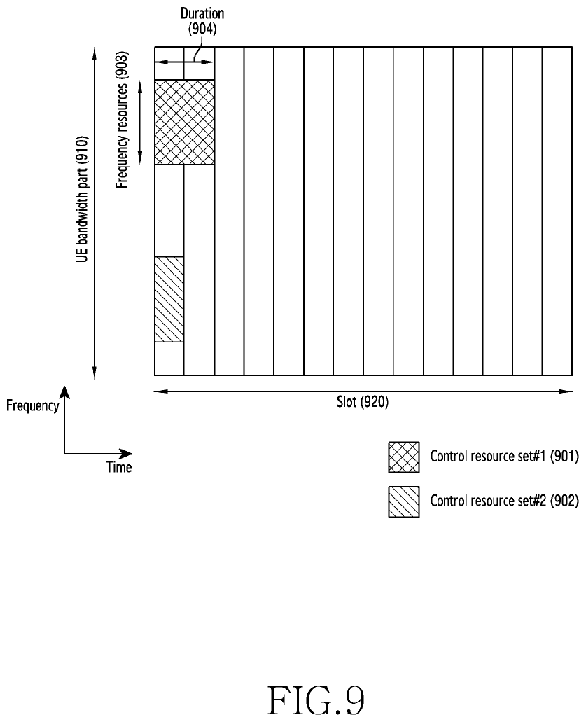

FIG. 9 illustrates an example of a control resource set configuration of a downlink control channel in a wireless communication system according to an embodiment of the disclosure. Specifically, FIG. 9 illustrates an example in which a UE bandwidth part 910 is configured along the frequency axis, and two control resource sets (control resource set #1 901 and control resource set #2 902) are configured within one slot 920 along the time axis. The control resource sets 901 and 902 may be configured in a specific frequency resource 910 within the entire UE bandwidth part 903 along the frequency axis. The control resource sets 901 and 902 may be each configured as one or multiple OFDM symbols along the time domain, and the number of the OFDM symbols may be defined as a control resource set duration 904.

According to an embodiment, referring to the example illustrated in FIG. 9, control resource set #1 901 is configured to have a control resource set duration corresponding to two symbols, and control resource set #2 902 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE may mean that information such as a control resource set identity, the control resource set's frequency location, and the control resource set's symbol duration is provided. For example, the control resource set may include the following pieces of information: given in Table 18 below.

TABLE 18

| ControlResourceSet ::= | SEQUENCE { |
|---|---|
| -- Corresponds to L1 parameter ‘CORESET-ID’ | |
| controlResourceSetId | ControlResourceSetId, |
| (control resource set identity)) | |
| frequency DomainResources | BIT STRING (SIZE (45)), |

(frequency domain resource assignment information)

| | |
|---|---|
| duration | INTEGER (1..maxCoReSetDuration), |

(time domain resource assignment information )

| cce-REG-Mapping Type | CHOICE { | |
|---|---|---|
| (CCE-to-REG mapping scheme) | | |
| interleaved | SEQUENCE { | |
| reg-BundleSize | ENUMERATED {n2, n3, n6}, | |
| (REG bundle size) | | |
| precoderGranularity | ENUMERATED | {sameAsREG-bundle, |
| all ContiguousRBs}, | | |
| interleaverSize | ENUMERATED {n2, n3, n6} | |
| (interleaver size) | | |
| shiftIndex | INTEGER(0..maxNrofPhysicalResourceBlocks-1) | |
| OPTIONAL | | |
| (interleaver shift) | | |
| }, | | |
| nonInterleaved | NULL | |
| }, | | |
| tci-StatesPDCCH | SEQUENCE(SIZE (1..maxNrofTCI-StatesPDCCH)) OF | |
| TCI-StateId | OPTIONAL, | |
| (QCL configuration information) | | |
| tci-PresentInDCI | ENUMERATED {enabled } | |
| OPTIONAL, -- Need S | | |
| } | | |

In Table 18, tci-StatesPDCCH (simply referred to as transmission configuration indication (TCI) state) configuration information may include information of one or multiple SS/PBCH block indexes or channel state information reference signal (CSI-RS) indexes, which are quasi-co-located (QCLed) with a DMRS transmitted in a corresponding control resource set.

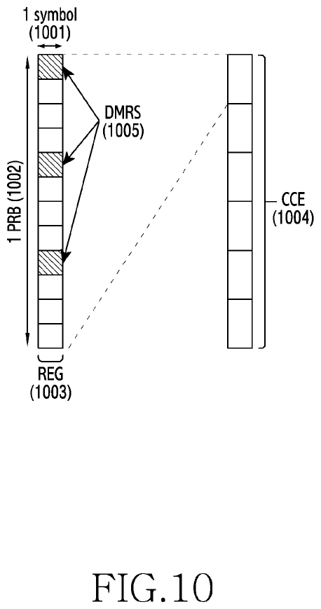

FIG. 10 illustrates a structure of a downlink control channel in a wireless communication according to an embodiment of the disclosure. Specifically, FIG. 10 illustrates an example of a basic unit of time and frequency resources constituting a downlink control channel available in 5G.

According to FIG. 10, the basic unit of time and frequency resources constituting a control channel may be referred to as a resource element group (REG) 1003, and the REG 1003 may be defined by one OFDM symbol 1001 along the time axis and one physical resource block (PRB) 1002, that is, 12 subcarriers, along the frequency axis. The base station may configure a downlink control channel allocation unit by concatenating the REGs 1003.

Provided that the basic unit of downlink control channel allocation in 5G is a control channel element 1004 as illustrated in FIG. 10, one CCE 1004 may include multiple REGs 1003. To describe the REG 1003 illustrated in FIG. 10, for example, the REG 1003 may include 12 REs, and if one CCE 1004 includes six REGs 1003, one CCE 1004 may then include 72 REs. A downlink control resource set, once configured, may include multiple CCEs 1004, and a specific downlink control channel may be mapped to one or multiple CCEs 1004 and then transmitted according to the aggregation level (AL) in the control resource set. The CCEs 1004 in the control resource set are distinguished by numbers, and the numbers of CCEs 1004 may be allocated according to a logical mapping scheme.

The basic unit of the downlink control channel illustrated in FIG. 10, that is, the REG 1003, may include both REs to which DCI is mapped, and an area to which a reference signal (DMRS 1005) for decoding the same is mapped. As in FIG. 10, three DRMSs 1003 may be transmitted inside one REG 1005. The number of CCEs necessary to transmit a PDCCH may be 1, 2, 4, 8, or 16 according to the aggregation level (AL), and different number of CCEs may be used to implement link adaption of the downlink control channel. For example, when AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the information configured for the UE by the base station ma include the following pieces of information in Table 19 below.

TABLE 19

| | |
|---|---|
| SearchSpace ::= | SEQUENCE { |

-- Identity of the search space. SearchSpaceId = 0 identifies the SearchSpace configured via PBCH

| | |
|---|---|
| (MIB) or ServingCellConfigCommon. | |
| searchSpaceId | SearchSpaceId, |
| (search space identity) | |
| controlResourceSetId | ControlResourceSetId, |
| (control resource set identity) | |
| monitoring SlotPeriodicity AndOffset | CHOICE { |
| (monitoring slot level periodicity) | |
| sl1 | NULL |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |
| OPTIONAL, | |
| duration(monitoring duration) | INTEGER (2..2559) |
| monitoringSymbols WithinSlot | BIT STRING (SIZE (14)) |
| OPTIONAL, | |
| (monitoring symbols within slot) | |
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| }, | |
| searchSpace Type | CHOICE { |
| (search space type) | |

-- Configures this search space as common search space (CSS) and DCI formats to monitor.

| | |
|---|---|
| common | SEQUENCE { |
| (common search space) | |
| } | |
| ue-Specific | SEQUENCE { |
| (UE-specific search space) | |

-- Indicates whether the UE monitors in this USS for DCI formats 0-0 and 1-0 or for formats

0-1 and 1-1.

formats ENUMERATED {formats0-0-And-1-0, formats0-1-And-1-1},

```
        ...
      }
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to the configuration information transmitted by the base station, a common search space or a UE-specific search space may include one or multiple search space sets. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

Combinations of DCI formats and RNTIs given below may be monitored in a UE-specific search space. Obviously, the examples given below are not limiting.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI(SI-RNTI): used to schedule a PDSCH in which system information is transmitted

Interruption RNTI(INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given in Table 20 below, for example.

TABLE 20

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission |
| | is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level
n_{CI}: carrier index
N_{CCE,p}: total number of CCEs existing in control resource set p

$$- {n}_{s , f}^{μ} :$$

slot index

$$- {M}_{s , max}^{( L )} :$$

number of PDCCH candidates at aggregation level L

$$- {m}_{s , {n}_{CI}} = 0 , … , {M}_{s , max}^{( L )} - 1 :$$

PDCCH candidate index at aggregation level L
i=0 . . . , L−1

$$- {Y}_{p , {n}_{s , f}^{μ}} = ( {A}_{p} \cdot {Y}_{p , {n}_{s , f}^{μ} - 1} ) mod D ,$$

Y_{p,-1}=\dot{n}_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 19), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### [Downlink: PDSCH]

### [PDSCH: Regarding Frequency Resource Allocation]

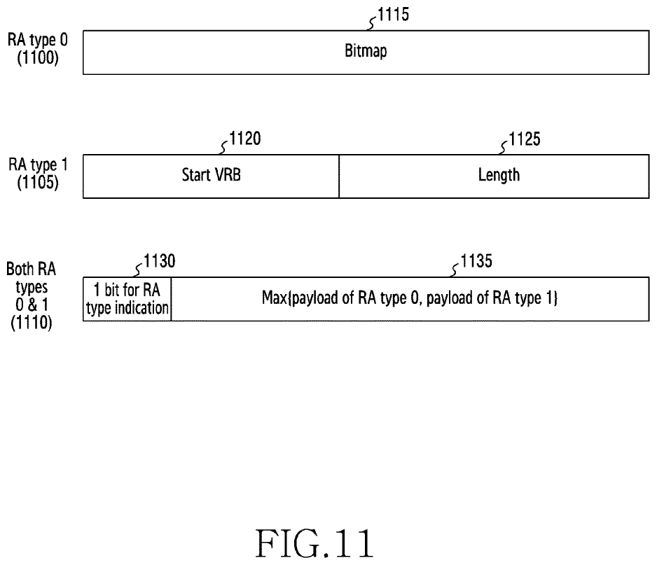

FIG. 11 illustrates an example of frequency domain resource allocation with regard to a physical downlink shared channel (PDSCH) in a wireless communication system according to an embodiment of the disclosure. More specifically, FIG. 11 illustrates three frequency domain resource allocation methods of type 0 1100, type 1 1105, and dynamic switch 1110 which can be configured through an upper layer in an NR wireless communication system.

Referring to FIG. 11, in the case in which a UE is configured to use only resource type 0 through higher layer signaling (1100), partial downlink control information (DCI) for allocating a PDSCH to the UE include a bitmap including N_{RBG} bits. The condition for this will be described in detail later. As used herein, N_{RBG} refers to the number of resource block groups (RBGs) determined according to the BWP size allocated by a BWP indicator and upper layer parameter rbg-Size, as in Table 21 below, and data is transmitted in RBGs indicated as “1” by the bitmap.

TABLE 21

| Bandwidth | | |
|---|---|---|
| Part Size | Configuration 1 | Configuration 2 |
| 1-36 | 2 | 4 |
| 37-72 | 4 | 8 |
| 73-144 | 8 | 16 |
| 145-275 | 16 | 16 |

In the case in which the UE is configured to use only resource type 1 through upper layer signaling (1105), partial DCI includes frequency domain resource allocation information including

$$[ {log}_{2} ( {N}_{RB}^{DL , BWP} ( {N}_{RB}^{DL , BWP} + 1 ) / 2 ] bits .$$

The condition for this will be described in detail later. The base station may thereby configure a starting VRB 1120 and the length 1125 of a frequency domain resource allocated continuously therefrom.

In the case in which the UE is configured to use both resource type 0 and resource type 1 through upper layer signaling (1110), partial DCI for allocating a PDSCH to the corresponding UE includes frequency domain resource allocation information including as many bits as the larger value 1135 between the payload 1115 for configuring resource type 0 and the payload 1120 and 1125 for configuring resource type 1. The condition for this will be described in detail later. One bit 1130 may be added to the foremost part (MSB) of the frequency domain resource allocation information inside the DCI, and if the bit 1130 has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a time point at which a PDCCH is received and a time point at which a PDSCH scheduled by the received PDCCH is transmitted; labeled K0), PDCCH-to-PUSCH slot timing (for example, corresponding to a slot-unit time interval between a time point at which a PDCCH is received and a time point at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 22 or Table 23 below may be transmitted from the base station to the UE.

TABLE 22
PDSCH-TimeDomainResourceAllocation List information element

| | |
|---|---|
| PDSCH-TimeDomainResourceAllocationList ::= | SEQUENCE (SIZE(1..maxNrofDL- |

Allocations)) OF PDSCH-TimeDomainResourceAllocation

| | |
|---|---|
| PDSCH-TimeDomainResourceAllocation ::= | SEQUENCE { |
| k0 | |
| INTEGER(0..32) | |
| OPTIONAL, -- Need S | |
| (PDCCH-to-PDSCH timing, slot unit) | |
| mappingType | ENUMERATED {typeA, typeB}, |
| (PDSCH mapping type) | |
| startSymbolAndLength | INTEGER (0..127) |
| (start symbol and length of PDSCH) | |
| } | |

TABLE 23
PUSCH-TimeDomainResourceAllocationList information element

| | |
|---|---|
| PUSCH-TimeDomainResourceAllocationList ::= | SEQUENCE (SIZE(1..maxNrofUL- |

Allocations)) OF PUSCH-TimeDomainResourceAllocation

| | |
|---|---|
| PUSCH-TimeDomainResource Allocation ::= | SEQUENCE { |
| k2 | INTEGER(0..32) |
| OPTIONAL, -- Need S | |
| (PDCCH-to-PUSCH timing, slot unit) | |
| mappingType | ENUMERATED {typeA, typeB}, |
| (PUSCH mapping type) | |
| startSymbolAndLength | INTEGER (0..127) |
| (start symbol and length of PUSCH) | |
| } | |

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

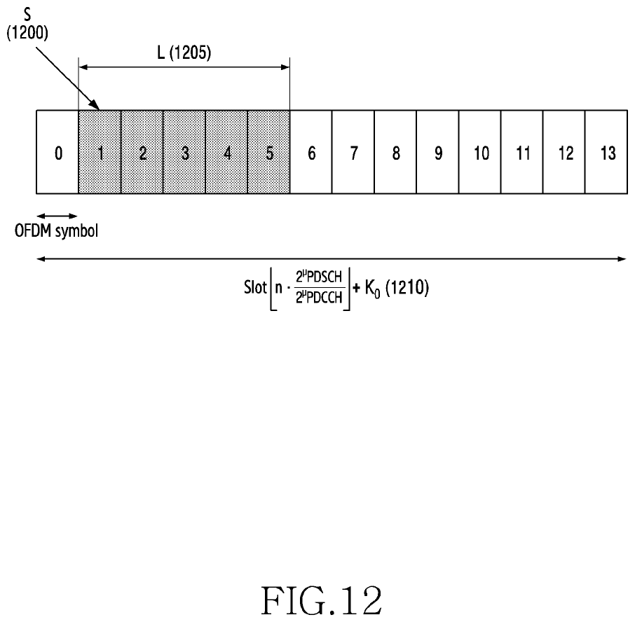

FIG. 12 illustrates an example of time domain resource allocation with regard to a PDSCH in a wireless communication system according to an embodiment of the disclosure.

Referring to FIG. 12, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K₀) value, and the OFDM symbol start location 1200 and length 1205 within one slot dynamically indicated through DCI.

### [PDSCH: TCI State Activation MAC-CE]

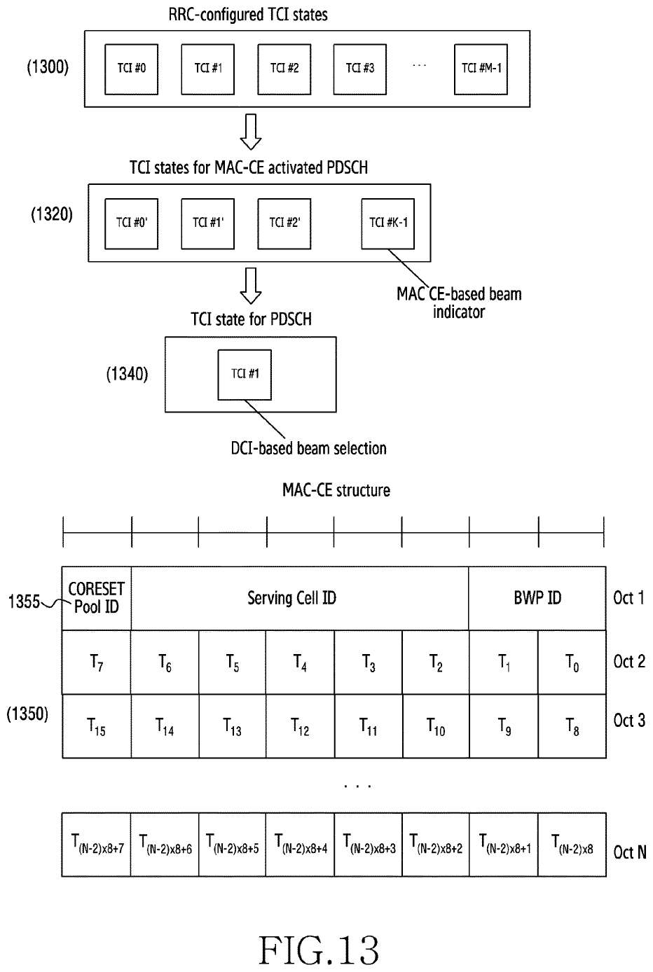

FIG. 13 illustrates an example of a process for a beam configuration and activation with regard to a PDSCH. A list of TCI states regarding a PDSCH may be indicated through a higher layer list such as RRC (1300). The list of TCI states may be indicated by tci-StatesToAddModList and/or tci-StatesToReleaseList inside a BWP-specific PDSCH-Config IE, for example. Subsequently, a part of the list of TCI states may be activated through a MAC-CE (1320). Among the TCI states activated through the MAC-CE, a TCI state for the PDSCH may be indicated by DCI (1340). The maximum number of activated TCI states may be determined by the capability reported by the UE. Referring to FIG. 13, the MAC CE structure % n including a CORESET Pool ID index 1355 illustrates an example of an MAC CE structure 1350 for the PDSCH TCI state activation/deactivation.

According to an embodiment, the meaning of respective fields inside the MAC CE and values configurable for respective fields are as follows.

Serving Cell ID [symbol] This field indicates the identity of the Serving Cell for which the MAC CE
applies. The length of the field is 5 bits. If the indicated Serving Cell is configured as part of a
simultaneousTCI-UpdateList1 or simultaneousTCI-UpdateList2 as specified in TS 38.331 [5], this MAC CE
applies to all the Serving Cells configured in the set simultaneousTCI-Update1 or simultaneousTCI-
UpdateList2, respectively:
BWP ID [symbol] This field indicates a DL BWP for which the MAC CE applies as the codepoint
of the DCI bandwidth part indicator field as specified in TS 38.212 [9]. The length of the BWP ID field is 2
bits. This field is ignored if this MAC CE applies to a set of Serving Cells:
T [symbol] If there is a TCI state with TCI-StateId [symbol] as specified in TS 38.331 [5], this field indicates
the activation/deactivation status of the TCI state with TCI-StateId [symbol] otherwise MAC entity shall ignore the [symbol]
field. The [symbol] field is set to 1 to indicate that the TCI state with TCI-StateId [symbol] shall be activated and mapped to
the codepoint of the DCI Transmission Configuration Indication field, as specified in TS 38.214 [7]. The [symbol]
field is set to 0 to indicate that the TCI state with TCI-StateId [symbol] shall be deactivated and is not mapped to the
codepoint of the DCI Transmission Configuration Indication field. The codepoint to which the TCI State is
mapped is determined by its cardinal position among all the TCI States with [symbol] field set to 1, i.e. the first TCI
State with [symbol] field set to 1 shall be mapped to the codepoint value 0, second TCI State with [symbol] field set to 1
shall be mapped to the codepoint value 1 and so on. The maximum number of activated TCI states is [symbol]
CORESET Pool ID (CORESET Pool ID [symbol] This field indicates that mapping between the activated
TCI states and the codepoint of the DCI Transmission Configuration Indication set by field [symbol] is specific to
the ControlResourceSetId configured with CORESET Pool ID as specified in TS 38.331 [5]. This field set to
1 indicates that this MAC CE shall be applied for the DL transmission scheduled by CORESET with the
CORESET pool ID equal to 1, otherwise, this MAC CE shall be applied for the DL transmission scheduled
by CORESET pool ID equal to [symbol] if the coresetPoolIndex is not configured for any CORESET, MAC entity
shall ignore the CORESET Pool ID field in this MAC CE when receiving the MAC CE. If the Serving Cell in
the MAC CE is configured in a cell list that contains more than one Serving Cell, the CORESET Pool ID field
shall be ignored when receving the MAC CE. [symbol]
indicates data missing or illegible when filed

### [Downlink: RS]

### [SS/PBCH Block]

Next, synchronization signal (SS)/PBCH blocks in 5G will be described in detail.

An SS/PBCH block may refer to a physical layer channel block including a primary synchronization signal (PSS), a secondary synchronization signal (SSS), and a PBCH. Details thereof are as follows.
PSS: A signal which becomes a reference signal for downlink time/frequency synchronization, and may provide some partial information of a cell ID.
SSS: A reference for downlink time/frequency synchronization, and may provide the remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: The SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0, assuming that the DMRS transmitted in the selected SS/PBCH block and control resource set #0 are QCLed. The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [Uplink: PUCCH]

### [PUCCH: Regarding Transmission]

In an NR system, a UE may transmit uplink control information (UCI) to a base station through a PUCCH. The control information may include at least one of a HARQ-ACK indicating whether the UE has succeeded in demodulating/decoding a transport block (TB) having been received through a PDSCH, a scheduling request (SR) through which the UE requests a PUSCH base station to allocate resources for uplink data transmission, and channel state information (CSI) that is information for reporting a channel state of the UE.

PUCCH resources may be generally classified as for a long PUCCH and a short PUCCH according to the length of allocated symbols. In an NR system, a long PUCCH has a length of 4 or more symbols in a slot, and a short PUCCH has a length of 2 or less symbols in a slot.

More specifically, the long PUCCH may be used for the purpose of enhancing uplink cell coverage. Therefore, the long PUCCH may be transmitted in a discrete Fourier transform (DFT)-spread (S)-OFDN scheme that is single carrier transmission, rather than OFDM transmission. The long PUCCH may support transmission formats, such as PUCCH format 1, PUCCH format 3, and PUCCH format 4, according to the number of supportable control information bits and whether UE multiplexing through pre-DFT OCC support at an IFFT front end is supported or not.

First, PUCCH format 1 is a DFT-S-OFDM-based long PUCCH format capable of supporting control information up to 2 bits, and may use as many frequency resources as 1 RB. The control information may be configured by a HARQ-ACK, an SR, or a combination thereof. PUCCH format 1 may have a structure in which an OFDM symbol including a demodulation reference signal (DMRS) that is a demodulation reference signal (or reference signal) and an OFDM symbol including UCI are repeated.

For example, if the number of transmission symbols of PUCCH format 1 is 8, the 8 symbols may be configured by a DMRS symbol, a UCI symbol, a DMRS symbol, a UCI symbol, a DMRS symbol, a UCI symbol, a DMRS symbol, and a UCI symbol sequentially starting from the first starting symbol. DMRS symbols may be spread using an orthogonal code (or orthogonal sequence or spreading code,) on the time axis for a sequence corresponding to the length of 1 RB on the frequency axis in one OFDM symbol, may be subject to inverse fast Fourier transform (IFFT), and then be transmitted.

With regard to UCI symbols, the UE may perform binary phase-shift keying (BPSK) modulation of 1-bit control information or quadrature phase-shift keying (QPSK) modulation of 2-bit control information to generate d(0), multiply the generated d(0) by a sequence corresponding to the length of 1 RB on the frequency axis to scramble same, spread the scrambled sequence by using an orthogonal code (or orthogonal sequence or spreading code,) on the time axis, perform IFFT of the spread sequence, and then transmit same.

The UE may generate a sequence, based on a group hopping or sequence hopping configuration and a configured ID configured by the base station through higher layer signaling, and performs a cyclic shift of the generated sequence by using an initial cyclic shift (CS) value configured through a higher signal to generate a sequence corresponding to the length of 1 RB.

wᵢ(m) may be determined as

$${w}_{i} ( m ) = {e}^{\frac{j 2 πϕ ( m )}{{N}_{SF}}}$$

if the length (NSF) of a spreading code is given and, specifically, is given as in Table below. i means the index of the spreading code itself, and m denotes the index of each element of the spreading code. Here, the numbers in the square brackets [ ] in Table 25] denote φ^{(m)}, and if the length of a spreading code is 2 and the configured index i of the spreading code is 0 (i=0), the spreading code wᵢ(m) becomes wᵢ(0)=e^{j2π·0/N}^{_{SF}}=1 and wᵢ(1)=e^{j2π·0/N}^{_{SP}}=1, and thus is equal to [1 1] (wᵢ(m)=[1 1]).

Spreading code for PUCCH formist 1 w [symbol] (m) [symbol] e

[symbol]

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

[symbol]

indicates data missing or illegible when filed

Next, PUCCH format 3 is a DFT-S-OFDM-based long PUCCH format capable of supporting control information greater than 2 bits, and the number of used RBs is configurable through a higher layer. The control information may be configured by a combination or each of a HARQ-ACK, an SR, and CSI. DMRS symbol locations in PUCCH format 3 are present in Table below according to whether there is frequency hopping in a slot, and whether an additional DMRS symbol is configured.

| | DMRS location in PUCCH format 3/4 transmission | | | |
|---|---|---|---|---|
| | Additional DMRS | | Additional DMRS | |
| | is not configured | | is configured | |
| PUCCH | frequency | | frequency | |
| format 3/4 | hopping | frequency | hopping | frequency |
| transmission | is not | hopping is | is not | hopping is |
| length | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, if the number of transmission symbols of PUCCH format 3 is 8 a DMRS is transmitted on a first symbol and a fifth symbol when the 0-th symbol is used as the first starting symbol of the 8 symbols. Table above is also applied to DMRS symbol locations of PUCCH format 4 in the same way.

Next, PUCCH format 4 is a DFT-S-OFDM-based long PUCCH format capable of supporting control information greater than 2 bits, and may use as many frequency resources as 1 RB. The control information may be configured by a combination or each of a HARQ-ACK, an SR, and CS The difference between PUCCH format 4 and PUCCH format 3 is that, in a case of PUCCH format 4, PUCCH formats 4 of several UEs are multiplexable in one RB. At an IFFT front end, it may be possible to multiplex PUCCH formats 4 of multiple UEs by applying a pre-DFT orthogonal cover code (OCC) to control information. However, the number of control information symbols transmittable by one UE may be reduced according to the number of multiplexed UEs. The number of multiplexable UEs, that is, the number of available different OCCs may be 2 or 4, and the number of OCCs and OCC indexes to be applied may be configured through a higher layer.

According to an embodiment, a short PUCCH may be transmitted on both a downlink-centric slot and an uplink-centric slot, and in general, may be transmitted on the last symbol of a slot or an OFDM symbol positioned in a back part (e.g., the last OFDM symbol, the second last OFDM symbol, or the last two OFDM symbols). Of course, it may also be possible for a short PUCCH to be transmitted on a random position in a slot. A short PUCCH may be transmitted using one OFDM symbol or two OFDM symbols. A short PUCCH may be used to shorten a delay time, compared to a long PUCCH, in a situation where uplink cell coverage is good, and may be transmitted in a CP-OFDM scheme.

A short PUCCH may support transmission formats, such as PUCCH format 0 and PUCCH format 2, according to the number of supportable control information bits. First, PUCCH format 0 is a short PUCCH format capable of supporting control information up to 2 bits, and may use as many frequency resources as 1 RB. The control information may be configured by a HARQ-ACK, an SR, or a combination thereof. PUCCH format 0 may have a structure of not transmitting a DMRS and transmitting only a sequence mapped to 12 subcarriers on the frequency axis in one OFDM symbol. The UE may generate a sequence, based on a group hopping or sequence hopping configuration and a configured ID configured by the base station through a higher signal, perform a cyclic shift (CS) of the generated sequence by using a final CS value obtained by adding, to an indicated initial CS value, a CS value varying according to an ACK or NACK, map the sequence to 12 subcarriers, and transmit the mapped sequence.

For example, in a case where a HARQ-ACK has 1 bit, the UE may generate the final CS by adding 6 to the initial CS value if the HARQ-ACK is an ACK, and may generate the final CS by adding 0 to the initial CS if the HARQ-ACK is a NACK, as given in Table below. The value of 0 that is a CS value for NACK and the value of 6 that is a CS value for ACK are defined in a specification, and the UE may generate PUCCH format 0 according to the values defined in the specification to transmit a 1-bit HARQ-ACK.

| 1-bit | | |
|---|---|---|
| HARQ-ACK | NACJK | ACK |
| final CS | (initial CS + 0) mod | (initial CS + 0) |
| | 12 = initial CS | mod 12 |

For example, in a case where a HARQ-ACK has 2 bits, as shown in Table below, the UE may add 0 to the initial CS value if the HARQ-ACK is (NACK, NACK), add 3 to the initial CS value if the HARQ-ACK is (NACK, ACK), add 6 to the initial CS value if the HARQ-ACK is (ACK, ACK), and add 9 to the initial CS value if the HARQ-ACK is (ACK, NACK). The value of 0 that is a CS value for (NACK, NACK), the value of 3 that is a CS value for (NACK, ACK), the value of 6 that is a CS value for (ACK, ACK), and the value of 9 that is a CS value for (ACK, NACK) are defined in a specification, and the UE may generate PUCCH format 0 according to the values defined in the specification to transmit a 2-bit HARQ-ACK. If the final CS value exceeds 12 due to the CS value added to the initial CS value according to an ACK or NACK, since the length of the sequence may be 12, modulo 12 may be applied to the final CS value.

| 2-bit | NACK, | NACK, | ACK, | ACK, |
|---|---|---|---|---|
| HARQ-ACK | NACK | ACK | ACK | NACK |
| final CS | (initial | (initial | (initial | (initial |
| | CS + 0) mod | CS + 3) | CS + 6) | CS + 9) |
| | 12 = initial CS | mod 12 | mod 12 | mod 12 |

Next, PUCCH format 2 is a short PUCCH format supporting control information greater than 2 bits, and the number of used RBs may be configured through a higher layer. The control information may be configured by a combination or each of a HARQ-ACK, an SR, and CSI. If the index of a first subcarrier is #0, PUCCH format 2 may be fixed to subcarriers having indexes of #1, #4, #7, and #10 as the positions of subcarriers on which a DMRS is transmitted in one OFDM symbol. The control information may undergo channel coding and then a modulation process to be mapped to the remaining subcarriers except the subcarriers on which the DMRS is positioned.

Configurable values for each PUCCH format described above and the ranges thereof may be organized as given in Table below. “N.A.” in Table below refers to a case where there is no need to configure a value.

| | | PUCCH | PUCCH | PUCCH | PUCCH | PUCCH |
|---|---|---|---|---|---|---|
| | | Format 0 | Format 1 | Format 2 | Format. 3 | Format 4 |
| Starting symbol | Configurability | [symbol] | [symbol] | [symbol] | [symbol] | [symbol] |
| | Value range | 0-13 | 0-10 | 0-13 | 0-10 | 0-10 |
| Number of | Configurability | [symbol] | [symbol] | [symbol] | [symbol] | [symbol] |
| symbols in a slot | Value range | 1, 2 | 4-14 | 1, 2 | 4-14 | 4-14 |
| Index for | Configurability | [symbol] | [symbol] | [symbol] | [symbol] | [symbol] |
| identifying | Value range | 0-274 | 0-274 | 0-274 | 0-274 | 0-274 |
| starting PRB | | | | | | |
| Number of PRBs | Configurability | N.A. | NA | [symbol] | [symbol] | N.A. |
| | Value range | N.A. | N.A. | 1-16 | 1-6, 8-10, | N.A. |
| | | (Default is 1) | (Default is 1) | | 12, 15, 16 | (Default is 1) |
| Enabling | Configurability | [symbol] | [symbol] | [symbol] | [symbol] | [symbol] |
| frequency | Value range | On/Off | On/Off | On/Off | On/Off | On/Off |
| hopping | | (only for 2 | | (only for 2 | | |
| (intra-slot) | | symbol) | | symbol) | | |
| Freq.cy resource | Configurability | [symbol] | [symbol] | [symbol] | [symbol] | [symbol] |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | [symbol] | [symbol] | N.A. | N.A. | N.A |
| cyclic shift | Value range | 0-11 | 0-11 | N.A. | N.A. | N.A. |
| Index of | Configurability | N.A. | [symbol] | N.A. | N.A. | N.A. |
| time-domain | Value range | N.A. | 0-6 | N.A. | N.A | N.A. |
| OCC | | | | | | |
| Length of | Configurability | N.A. | N.A. | N.A. | NA. | [symbol] |
| Pre-DFT OCC | Value range | NA. | N.A. | N.A. | N.A. | 2, 4 |
| Index of Pre-DFT | Configurability | N.A. | N.A. | N.A. | N.A. | [symbol] |
| OCC | Value range | N.A. | N.A. | N.A. | N.A. | 0, 1, 2, 3 |

[symbol]

indicates data missing or illegible when filed

For uplink coverage improvement, multi-slot repeated transmission may be supported for PUCCH formats 1, 3, and 4, and PUCCH repeated transmission may be configured for each PUCCH format. The UE may perform repetition transmission of a PUCCH including UCI as many times as the number of slots configured through the higher layer signaling nrofSlots. For PUCCH repetition transmission, a PUCCH transmission on each slot is performed using the same number of consecutive symbols, and the number of consecutive symbols may be configured through nrofSymbols in higher layer signaling PUCCH-format 1, PUCCH-format 3, or PUCCH-format 4. For PUCCH repetition transmission, a PUCCH transmission on each slot is performed using the same starting symbol, and the starting symbol may be configured through startingSymbolIndex in higher layer signaling PUCCH-format 1, PUCCH-format 3, or PUCCH-format 4. For PUCCH repetition transmission, single PUCCH-spatialRelationInfo may be configured for a single PUCCH resource. For PUCCH repetition transmission, if the UE is configured to perform frequency hopping between PUCCH transmissions on different slots, the UE may perform frequency hopping in units of slots. In addition, if the UE is configured to perform frequency hopping between PUCCH transmissions on different slots, the UE may start a PUCCH transmission on an even-numbered slot at a first PRB index configured through higher layer signaling startingPRB, and start a PUCCH transmission on an odd-numbered slot at a second PRB index configured through higher layer signaling secondHopPRB. Additionally, if the UE is configured to perform frequency hopping between PUCCH transmissions on different slots, the index of a slot indicated for the UE to perform the first PUCCH transmission thereon is 0, and during the configured entire PUCCH repetition transmission count, a PUCCH repetition transmission count value may be increased regardless of performing the PUCCH transmission on each slot. If the UE is configured to perform frequency hopping between PUCCH transmissions on different slots, the UE does not expect that frequency hopping in a slot at the time of PUCCH transmission is configured. If performing frequency hopping between PUCCH transmissions on different slots is not configured and frequency hopping in a slot is configured for the UE, the first and second PRB indexes may also be identically applied in the slot. If the number of uplink symbols on which PUCCH transmission is possible is smaller than a number indicated by nrofSymbols configured through higher layer signaling, the UE may not transmit a PUCCH. Even if the UE has failed to perform the PUCCH transmission on a slot for any reason during PUCCH repetition transmission, the UE may increase the PUCCH repetition transmission count.

In NR Release 17, the number of slots for repeated transmission of each PUCCH resource in PUCCH-ResourceExt that is an expansion of the higher layer signaling PUCCH-Resource for PUCCH resources may be configured through the higher layer signaling pucch-RepetitionNrofSlots-r17. If higher layer signaling pucch-RepetitionNrofSlots-r17 is configured, a corresponding PUCCH is configured, and higher layer signaling nrofSlots is also configured, the UE may determine the number of slots on which the corresponding PUCCH is repetitively transmitted through pucch-RepetitionNrofSlots-r17, and disregard higher layer signaling nrofSlots.

### [PUCCH: PUCCH Resource Configuration]

Next, a PUCCH resource configuration of a base station or a UE will be described. The base station may perform PUCCH resource configurations according to BWPs for a particular UE through a higher layer. The PUCCH resource configurations may be as given in Table 24 below.

TABLE 24

| | |
|---|---|
| PUCCH-Config ::= | SEQUENCE { |

| | |
|---|---|
| resourceSetToAddModList | SEQUENCE (SIZE (1..maxNrofPUCCH-ResourceSets)) |

OF PUCCH-ResourceSet OPTIONAL, -- Need N

| | |
|---|---|
| resourceSetToReleaseList | SEQUENCE (SIZE (1..maxNrofPUCCH-ResourceSets)) |

OF PUCCH-ResourceSetId OPTIONAL, -- Need N

| | |
|---|---|
| resourceToAddModList | SEQUENCE (SIZE (1..maxNrofPUCCH-Resources)) |

OF PUCCH-Resource OPTIONAL, -- Need N

| | |
|---|---|
| resourceToReleaseList | SEQUENCE (SIZE (1..maxNrofPUCCH-Resources)) OF |

PUCCH-ResourceId OPTIONAL, -- Need N

| | |
|---|---|
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE (1..maxNrofSR-Resources)) OF |

SchedulingRequestResourceConfig
OPTIONAL, -- Need N

| | |
|---|---|
| schedulingRequestResourceToReleaseList | SEQUENCE (SIZE (1..maxNrofSR-Resources)) OF |

SchedulingRequestResourceId
OPTIONAL, -- Need N

| | |
|---|---|
| multi-CSI-PUCCH-ResourceList | SEQUENCE (SIZE (1..2)) OF PUCCH-ResourceId |

OPTIONAL, -- Need M

| | |
|---|---|
| dl-DataToUL-ACK | SEQUENCE (SIZE (1..8)) OF INTEGER (0 .. 15) |

OPTIONAL, -- Need M

| | |
|---|---|
| spatialRelationInfo ToAddModList | SEQUENCE (SIZE (1..maxNrofSpatialRelationInfos)) OF |

PUCCH-SpatialRelationInfo
OPTIONAL, -- Need N

| | |
|---|---|
| spatialRelationInfo ToReleaseList | SEQUENCE (SIZE (1..maxNrofSpatialRelationInfos)) OF |

PUCCH-SpatialRelationInfoId
OPTIONAL, -- Need N

| | |
|---|---|
| pucch-PowerControl | PUCCH-PowerControl |

```
OPTIONAL, -- Need M
  ...,
  [[
```

| | |
|---|---|
| resourceToAddModListExt-r16 | SEQUENCE (SIZE (1..maxNrofPUCCH-Resources)) OF |

PUCCH-ResourceExt-r16 OPTIONAL, -- Need N

| | |
|---|---|
| dl-DataToUL-ACK-r16 | SetupRelease { DL-DataToUL-ACK-r16 } |

OPTIONAL, -- Need M

| | |
|---|---|
| ul-AccessConfigListDCI-1-1-r16 | SetupRelease { UL-AccessConfigListDCI-1-1-r16 } |

OPTIONAL, -- Need M

| | |
|---|---|
| subslotLengthForPUCCH-r16 | CHOICE { |

| | |
|---|---|
| normalCP-r16 | ENUMERATED {n2,n7}, |

| | |
|---|---|
| extendedCP-r16 | ENUMERATED {n2,n6} |

}
OPTIONAL, -- Need R

| | |
|---|---|
| dl-DataToUL-ACK-DCI-1-2-r16 | SetupRelease { DL-DataToUL-ACK-DCI-1-2-r16} |

OPTIONAL, -- Need M

| | |
|---|---|
| numberOfBitsForPUCCH-ResourceIndicatorDCI-1-2-r16 | INTEGER (0..3) |

OPTIONAL, -- Need R

| | |
|---|---|
| dmrs-UplinkTransformPrecodingPUCCH-r16 | ENUMERATED {enabled} OPTIONAL, -- |

Cond PI2-BPSK

| | |
|---|---|
| spatialRelationInfoToAddModListSizeExt-v1610 | SEQUENCE (SIZE |

| | |
|---|---|
| (1..maxNrofSpatialRelationInfosDiff-r16)) | OF PUCCH-SpatialRelationInfo |

OPTIONAL, -- Need N

| | |
|---|---|
| spatialRelationInfo ToReleaseListSizeExt-v1610 | SEQUENCE (SIZE |

| | |
|---|---|
| (1..maxNrofSpatialRelationInfosDiff-r16)) | OF PUCCH-SpatialRelationInfoId |

OPTIONAL, -- Need N

| | |
|---|---|
| spatialRelationInfoToAddModListExt-v1610 | SEQUENCE (SIZE (1..maxNrofSpatialRelationInfos- |

| | |
|---|---|
| r16)) OF | PUCCH-SpatialRelationInfoExt-r16 |

OPTIONAL, -- Need N

| | |
|---|---|
| spatialRelationInfoToReleaseListExt-v1610 | SEQUENCE (SIZE (1..maxNrofSpatialRelationInfos- |
| r16)) OF PUCCH-SpatialRelationInfoId-r16 | OPTIONAL, -- Need N |

| | |
|---|---|
| resourceGroupToAddModList-r16 | SEQUENCE (SIZE (1..maxNrofPUCCH- |

| | |
|---|---|
| ResourceGroups-r16)) | OF PUCCH-ResourceGroup-r16 |

OPTIONAL, -- Need N

| | |
|---|---|
| resourceGroupToReleaseList-r16 | SEQUENCE (SIZE (1..maxNrofPUCCH-ResourceGroups- |

| | |
|---|---|
| r16)) OF | PUCCH-ResourceGroupId-r16 |

OPTIONAL, -- Need N

| | |
|---|---|
| sps-PUCCH-AN-List-r16 | SetupRelease { SPS-PUCCH-AN-List-r16 } |

OPTIONAL, -- Need M

| | |
|---|---|
| schedulingRequestResourceToAddModListExt-v1610 | SEQUENCE (SIZE (1..maxNrofSR- |

| | |
|---|---|
| Resources)) OF | SchedulingRequestResourceConfigExt-v1610 |

OPTIONAL -- Need N
]]
}

According to Table 24, one or multiple PUCCH resource sets may be configured in a PUCCH resource configuration for a particular BWP, and a maximum payload value for UCI transmission may be configured for some of the PUCCH resource sets. One or multiple PUCCH resources may belong to each PUCCH resource set, and each PUCCH resource may belong to one of the PUCCH formats described above.

With regard to the PUCCH resource sets, a maximum payload value of the first PUCCH resource set may be fixed to 2 bits. Accordingly, the value may not be separately configured through a higher layer. If the other PUCCH resource sets are configured, the index of a corresponding PUCCH resource set may be configured in an ascending order according to the maximum payload value, and no maximum payload value may be configured for the last PUCCH resource set. A higher layer configuration for a PUCCH resource set may be as given in Table 25 below.

TABLE 25

| | |
|---|---|
| PUCCH-ResourceSet ::= | SEQUENCE { |

| | |
|---|---|
| pucch-ResourceSetId | PUCCH-ResourceSetId, |

| | |
|---|---|
| resourceList | SEQUENCE (SIZE (1..maxNrofPUCCH-ResourcesPerSet)) OF PUCC |

H-ResourceId,

| | |
|---|---|
| maxPayloadSize | INTEGER (4..256) |

OPTIONAL -- Need R
}

The parameter resourceList in Table 25 may include IDs of PUCCH resources belonging to a PUCCH resource set.

At the time of initial access, or if a PUCCH resource set is not configured, a PUCCH resource set, as given in Table below, configured by multiple PUCCH resources which are cell-specific in an initial BWP, may be used. A PUCCH resource to be used for initial access in the PUCCH resource set may be indicated through SIB1.

| | | | | PRB offset | Set of initial |
|---|---|---|---|---|---|
| Index | PUCCH format | First symbol | Number of symbols | ${RB}_{BWP}^{offset}$ | CS indexes |
| 0 | 0 | 12 | 2 | 0 | {0, 3} |
| 1 | 0 | 12 | 2 | 0 | (0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0. 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

According to an embodiment, a maximum payload of each of PUCCH resources included in the PUCCH resource set may be 2 bits in the case of PUCCH format 0 or 1, and may be determined based on a symbol length, the number of PRBs, and a maximum code rate in the case of the remaining formats. The symbol length and the number of PRBs may be configured for each PUCCH resource, and the maximum code rate may be configured for each PUCCH format.

Next, PUCCH resource selection for UCI transmission will be described. According to an embodiment, In the case of SR transmission, a PUCCH resource for an SR corresponding to schedulingRequestID as given in Table 26 below may be configured through a higher layer. The PUCCH resource may be a resource belonging to PUCCH format 0 or PUCCH format 1.

TABLE 26

| | |
|---|---|
| SchedulingRequestResourceConfig ::= | SEQUENCE { |

| | |
|---|---|
| schedulingRequestResourceId | SchedulingRequestResourceId, |

| | |
|---|---|
| schedulingRequestID | SchedulingRequestId, |

| | |
|---|---|
| periodicity AndOffset | CHOICE { |

| | |
|---|---|
| sym2 | NULL, |

| | |
|---|---|
| sym6or7 | NULL, |

| | | |
|---|---|---|
| s11 | NULL, | -- Recurs in |

every slot

| | |
|---|---|
| s12 | INTEGER (0..1), |
| s14 | INTEGER (0..3), |
| s15 | INTEGER (0..4), |
| s18 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

| | | |
|---|---|---|
| } | | OPTIONAL, |
| -- Need M | PUCCH-ResourceId | OPTIONAL |

resource
-- Need M
}

A transmission period and an offset of the configured PUCCH resource may be configured through the parameter periodicityAndOffset in Table 26. If there is uplink data to be transmitted by the UE at a time point corresponding to the configured period and offset, the PUCCH resource may be transmitted, and otherwise, the PUCCH resource may not be transmitted.

In the case of CSI transmission, a PUCCH resource on which a periodic CSI report or a semi-persistent CSI report through a PUCCH is to be transmitted may be configured in the parameter pucch-CSI-ResourceList as given in Table 27 below. The parameter pucch-CSI-ResourceList may include a list of PUCCH resources for each BWP for a cell or component carrier (CC) on which the CSI report is to be transmitted. The PUCCH resource may be a resource belonging to PUCCH format 2, PUCCH format 3, or PUCCH format 4. A transmission periodicity and an offset of the PUCCH resource may be configured through reportSlotConfig in Table 27.

TABLE 27

| | |
|---|---|
| CSI-ReportConfig ::= | SEQUENCE { |

| | |
|---|---|
| reportConfigId | CSI-ReportConfigId, |

| | |
|---|---|
| carrier | ServCellIndex OPTIONAL, |

-- Need S
...

| | |
|---|---|
| reportConfigType | CHOICE { |

| | |
|---|---|
| periodic | SEQUENCE { |

| | |
|---|---|
| reportSlotConfig | CSI-ReportPeriodicity AndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |

| | |
|---|---|
| reportSlotConfig | CSI-ReportPeriodicity AndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUSCH | SEQUENCE { |

| | |
|---|---|
| reportSlotConfig | ENUMERATED {sl5, sl10, sl20, sl40, sl80, |

sl160, sl320},

| | |
|---|---|
| reportSlotOffsetList | SEQUENCE (SIZE (1..maxNrofUL-Allocations)) |

OF INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) OF |

```
INTEGER(0..32)
    }
  },
  ...
}
```

In the case of HARQ-ACK transmission, a resource set of PUCCH resources to be transmitted may be first selected according to a payload of UCI including the HARQ-ACK. For example, a PUCCH resource set having a minimum payload not smaller than the payload of the UCI may be selected. Next, a PUCCH resource in the PUCCH resource set may be selected through a PUCCH resource indicator (PRI) in DCI which schedules a TB corresponding to the relevant HARQ-ACK. The PRI may be the PUCCH resource indicator enumerated in Table 16 or 17. The relationship between a PRI and a PUCCH resource selected form the PUCCH resource set may be as given in Table below.

| PUCCH | |
|---|---|
| resource | |
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of PUCCH resources in a selected PUCCH resource set is greater than 8, a PUCCH resource may be selected by Equation 2 below.

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ if {Δ}_{PRI} < {R}_{PUCCH} mod 8 \\ ⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ + {R}_{PUCCH} mod 8 if {Δ}_{PRI} \geq {R}_{PUCCH} mod 8\end{matrix} \} \qquad [ Equation 2 ]$$

In Equation 2, r_{PUCCH} denotes the index of the selected PUCCH resource in the PUCCH resource set, R_{PUCCH} denotes the number of the PUCCH resources belonging to the PUCCH resource set, Δ_{PRI} denotes a PRI value, N_{CCE,p} denotes a total number of CCEs of CORESET p to which reception DCI belongs, and n_{CCE,p} denotes the index of a first CCE for the reception DCI.

A time point at which the PUCCH resource is transmitted is a time point after K₁ slots after transmission of a TB corresponding to the HARQ-ACK. A candidate of the K₁ value is configured through a higher layer and, more specifically, may be configured in the parameter dl-DataToUL-ACK in PUCCH-Config specified in Table 24. One K₁ value among these candidates may be selected by a PDSCH-to-HARQ feedback timing indicator in DCI scheduling a TB, and the value may be a value specified in Table 15 or Table 16. The unit of the K₁ value may be a unit of a slot or a unit of a subslot. Here, a subslot is a length unit smaller than a slot, and one or multiple symbols may constitute one subslot.

Next, a case where two or more PUCCH resources are positioned in one slot will be described. A UE may transmit UCI through one or two PUCCH resources in one slot or subslot, and when UCI is transmitted through two PUCCH resources in one slot/subslot, i) each PUCCH resource may not overlap in units of symbols, and ii) at least one PUCCH resource may be a short PUCCH. The UE may not expect to transmit multiple PUCCH resources for HARQ-ACK transmission in one slot.

### [PUCCH: Regarding Transmission Beam]

Hereinafter, a configuration of an uplink transmission beam to be used for PUCCH transmission will be described in detail. If a UE does not have a UE-specific configuration (e.g., dedicated PUCCH resource configuration) for a PUCCH resource configuration, a PUCCH resource set may be provided through higher layer signaling pucch-ResourceCommon, wherein a beam configuration for PUCCH transmission may be based on a beam configuration used in PUSCH transmission scheduled through a random access response (RAR) UL grant. If the UE has a UE-specific configuration (e.g., dedicated PUCCH resource configuration) for a PUCCH resource configuration, a beam configuration for PUCCH transmission may be provided through higher signaling pucch-spatialRelationInfold included in Table 24. If one value of pucch-spatialRelationInfold is configured for the UE, a beam configuration for PUCCH transmission of the UE may be provided through the one value of pucch-spatialRelationInfold. If multiple values of pucch-spatialRelationInfoID are configured for the UE, activation of one value of pucch-spatialRelationInfoID among the multiple values may be indicated to the UE through an MAC CE. A maximum of 8 values of pucch-spatialRelationInfoID may be configured for the UE through higher signaling, and only one value of pucch-spatialRelationInfoID among them being activated may be indicated to the UE. If activation of any value of pucch-spatialRelationInfoID is indicated to the UE through an MAC CE, the UE may apply pucch-spatialRelationInfoID activation through the MAC CE starting from a slot first appearing after

$$3 {N}_{slot}^{subframe , μ}$$

slots after a slot transmitting a HARQ-ACK for a PDSCH transmitting the MAC CE containing activation information on pucch-spatialRelationInfoID. μ is a numerology applied to PUCCH transmission, and

$${N}_{slot}^{subframe , μ}$$

may refer to the number of slots per subframe at the given numerology. A higher layer configuration for pucch-spatialRelationInfo may be as given in Table 28 below.

TABLE 28

| | |
|---|---|
| PUCCH-SpatialRelationInfo ::= | SEQUENCE { |

| | |
|---|---|
| pucch-SpatialRelationInfoId | PUCCH-SpatialRelationInfoId, |

| | |
|---|---|
| servingCellId ServCellIndex | OPTIONAL, -- Need S |

| | |
|---|---|
| referenceSignal | CHOICE { |

| | |
|---|---|
| ssb-Index | SSB-Index, |

| | |
|---|---|
| csi-RS-Index | NZP-CSI-RS-ResourceId, |

| | |
|---|---|
| srs | PUCCH-SRS |

},

| | |
|---|---|
| pucch-PathlossReferenceRS-Id | PUCCH-PathlossReferenceRS-Id, |

| | |
|---|---|
| p0-PUCCH-Id | P0-PUCCH-Id, |

| | |
|---|---|
| closedLoopIndex | ENUMERATED { i0, il } |

}

| | |
|---|---|
| PUCCH-SpatialRelationInfoId ::= | INTEGER (1 .. maxNrofSpatialRelationInfos) |

According to Table 28, one referenceSignal configuration may exist in a particular pucch-spatialRelationInfo configuration, the referenceSignal may be ssb-Index indicating a particular SS/PBCH, csi-RS-Index indicating a particular CSI-RS, or srs indicating a particular SRS. If referenceSignal is configured to be ssb-Index, the UE may configure, as a beam for PUCCH transmission, a bean used to receive an SS/PBCH corresponding to the ssb-Index among SS/PBCHs in the same serving cell. If servingCellId is provided, the UE configure, as a beam for PUCCH transmission, a beam used to receive an SS/PBCH corresponding to the ssb-Index among SS/PBCHs included in a cell indicated by the servingCellId. If referenceSignal is configured to be csi-RS-Index, the UE may configure, as a beam for PUCCH transmission, a beam used to receive a CSI-RS corresponding to the csi-RS-Index among CSI-RSs in the same serving cell, or if servingCellId is provided, the UE may configure, as a beam for PUCCH transmission, a beam used to receive a CSI-RS corresponding to the csi-RS-Index among CSI-RSs in a cell indicated by the servingCellId. If referenceSignal is configured to be srs, the UE may configure, as a beam for PUCCH transmission, a transmission beam used to transmit an SRS corresponding to a resource index provided via a higher signaling resource in the same serving cell and/or in an activated uplink BWP, or if servingCellID and/or uplink BWP is provided, the UE may configure, as a beam for PUCCH transmission, a transmission beam used to transmit an SRS corresponding to a resource index provided via a higher signaling resource in a cell and/or in an uplink BWP indicated by the servingCellID and/or uplink BWP. A particular pucch-spatialRelationInfo configuration may include one pucch-PathlossReferenceRS-Id configuration. PUCCH-PathlossReferenceRS in Table 29 may be mapped to pucch-PathlossReferenceRS-Id in Table 28, and a maximum of four values may be configurable via pathlossReferenceRSs in higher signaling PUCCH-PowerControl in Table 29. If PUCCH-PathlossReferenceRS is connected to an SS/PBCH via the higher signaling referenceSignal, ssb-Index may be configured, and if PUCCH-PathlossReferenceRS is connected to a CSI-RS, csi-RS-Index may be configured.

TABLE 29

| | |
|---|---|
| PUCCH-PowerControl ::= | SEQUENCE { |

| | | |
|---|---|---|
| deltaF-PUCCH-f0 | INTEGER (−16..15) | OPTIONAL, -- |

Need R

| | | |
|---|---|---|
| deltaF-PUCCH-f1 | INTEGER (−16..15) | OPTIONAL, -- |

Need R

| | | |
|---|---|---|
| deltaF-PUCCH-f2 | INTEGER (−16..15) | OPTIONAL, -- |

Need R

| | | |
|---|---|---|
| deltaF-PUCCH-f3 | INTEGER (−16..15) | OPTIONAL, -- |

Need R

| | | |
|---|---|---|
| deltaF-PUCCH-f4 | INTEGER (−16..15) | OPTIONAL, -- |

Need R

| | |
|---|---|
| p0-Set | SEQUENCE (SIZE (1..maxNrofPUCCH-PO-PerSet)) OF PO- |

| | |
|---|---|
| PUCCH | OPTIONAL, -- Need M |

| | |
|---|---|
| pathlossReferenceRSs | SEQUENCE (SIZE (1 .. maxNrofPUCCH- |

| | |
|---|---|
| PathlossReferenceRSs)) | OF PUCCH-PathlossReferenceRS |

OPTIONAL, -- Need M

| | | |
|---|---|---|
| twoPUCCH-PC-AdjustmentStates | ENUMERATED {twoStates} | OPTIONAL, -- |

```
Need S
  ...,
  [[
```

| | | |
|---|---|---|
| pathlossReferenceRSs-v1610 | SetupRelease { PathlossReferenceRSs-v1610 } | OPTIONAL |

-- Need M
]]
}

| | |
|---|---|
| P0-PUCCH ::= | SEQUENCE { |

| | |
|---|---|
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |

| | |
|---|---|
| PathlossReferenceRSs-v1610 ::= | SEQUENCE (SIZE (1..maxNrofPUCCH- |

PathlossReferenceRSsDiff-r16)) OF PUCCH-PathlossReferenceRS-r16

| | |
|---|---|
| PUCCH-PathlossReferenceRS ::= | SEQUENCE { |

| | |
|---|---|
| pucch-PathlossReferenceRS-Id | PUCCH-PathlossReferenceRS-Id, |

| | |
|---|---|
| reference Signal | CHOICE { |

| | |
|---|---|
| ssb-Index | SSB-Index, |

| | |
|---|---|
| csi-RS-Index | NZP-CSI-RS-ResourceId |

}
}

| | |
|---|---|
| PUCCH-PathlossReferenceRS-r16 ::= | SEQUENCE { |

| | |
|---|---|
| pucch-PathlossReferenceRS-Id-r16 | PUCCH-PathlossReferenceRS-Id-v1610, |

| | |
|---|---|
| referenceSignal-r16 | CHOICE { |

| | |
|---|---|
| ssb-Index-r16 | SSB-Index, |

| | |
|---|---|
| csi-RS-Index-r16 | NZP-CSI-RS-ResourceId |

}
}

### [PUCCH: Group-Based Spatial Relation Activation]

In Rel-15, when the UE receives a configuration of multiple pucch-spatialRelationInfoIDs, the UE may determine the spatial relation of corresponding PUCCH resources by receiving a MAC CE for activating the spatial relation for each PUCCH resource. However, this method has a disadvantage of requiring much signaling overhead to activate the spatial relation of multiple PUCCH resources. Accordingly, in Rel-16, a new MAC CE for adding a PUCCH resource group and activating the spatial relation in units of PUCCH resource groups has been introduced. For the PUCCH resource groups, a maximum of 4 PUCCH resource groups may be configured through esourceGroupToAddModList in [Table 24], and for each PUCCH resource group, multiple PUCCH resource IDs within one PUCCH resource group may be configured as a list as shown in [Table 30].

TABLE 30

| | |
|---|---|
| PUCCH-ResourceGroup-r16 ::= | SEQUENCE { |

| | |
|---|---|
| pucch-ResourceGroupId-r16 | PUCCH- |

ResourceGroupId-r16,

| | |
|---|---|
| resource PerGroupList-r16 | SEQUENCE (SIZE |

(1..maxNrofPUCCH-ResourcesPerGroup-r16)) OF PUCCH-ResourceId
}

| | |
|---|---|
| PUCCH-ResourceGroupId-r16 ::= | INTEGER |

(0..maxNrofPUCCH-ResourceGroups-1-r16)

In Rel-16, the base station may configure each PUCCH resource group for the UE through resourceGroupToAddModList in [Table 24] and the higher-layer configuration in [Table 30], and configure a MAC CE for simultaneously activating spatial relations of all PUCCH resources within one PUCCH resource group.

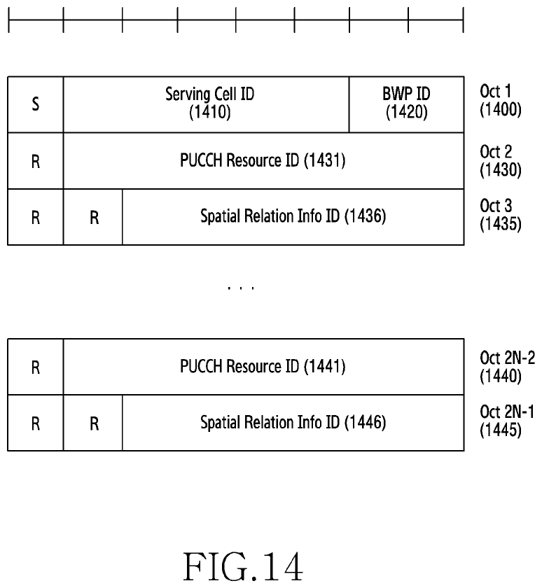

FIG. 14 illustrates an example of a medium access control (MAC) control element (CE) for activating the spatial relation based on a physical uplink control channel (PUCCH) resource group in a wireless communication system according to an embodiment of the disclosure.

Referring to FIG. 14, a serving cell ID 1410 in which a PUCCH resource to apply a MAC CE is configured and a BWP ID 1420 may be indicated by Oct. 1 1400. A PUCCH resource ID 1431 or 1441 indicated by Oct. 2 1430 (or Oct. 2N−2 1440) may indicate IDs of the PUCCH resource. When the indicated PUCCH resource is included in a PUCCH resource group according to resourceGroupToAddModList, a different PUCCH resource ID within the same PUCCH resource group may not be indicated through the same MAC CE, and all PUCCH resources within the same PUCCH resource group may be activated by the same spatial relation info ID 1436 or 1446 indicated by Oct. 3 1435 (or Oct. 2N−1 1445). In this case, the spatial relation info ID 1436 or 1446 may include a value corresponding to PUCCH- (PUCCH-SpatialRelationInfoId−1) to be applied to the PUCCH resource group in [Table 28].

### [Uplink: PUSCH]

### [PUSCH: Regarding Transmission Scheme]

Hereinafter, a PUSCH transmission scheduling scheme will be described in detail. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 31 via higher signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 31 via higher signaling. If PUSCH transmission is operated by a configured grant, parameters applied to the PUSCH transmission are applied through configuredGrantConfig (higher signaling) in Table 31 except for dataScramblingIdentityPUSCH, txConfig, codebookSubset, maxRank, and scaling of UCI-OnPUSCH, which are provided by pusch-Config (higher signaling) in Table 32. If provided with transformPrecoder inside configuredGrantConfig (higher signaling) in Table 31, the UE applies tp-pi2BPSK inside pusch-Config in Table 32 to PUSCH transmission operated by a configured grant.

TABLE 31

| | |
|---|---|
| ConfiguredGrantConfig ::= | SEQUENCE { |

| | |
|---|---|
| frequency Hopping | ENUMERATED {intraSlot, interSlot} |

OPTIONAL, -- Need S,

| | |
|---|---|
| cg-DMRS-Configuration | DMRS-UplinkConfig, |

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M
resourceAllocation ENUMERATED { resourceAllocationType0, resourceAllocationType1,
dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |

| | |
|---|---|
| p0-PUSCH-Alpha | P0-PUSCH-AlphaSetId, |

| | |
|---|---|
| transformPrecoder | ENUMERATED {enabled, disabled} |

OPTIONAL, -- Need S

| | |
|---|---|
| nrofHARQ-Processes | INTEGER(1..16), |

| | |
|---|---|
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |

sym2, sym7, sym1x14,

sym2x14, sym4x14, sym5x14, sym8x14, sym 10x14, sym16x14, sym20x14,

sym32x14, sym40x14, sym64x14, sym80x14, sym128x14, sym 160x14,

sym256x14, sym320x14, sym512x14,

sym640x14, sym1024x14, sym1280x14, sym2560x14, sym5120x14,
sym6, sym1x12, sym2x12, sym4x12, sym5x12, sym8x12, sym 10x12,

sym16x12, sym20x12, sym32x12,

sym40x12, sym64x12, sym80x12, sym128x12, sym 160x12,

sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |

| | |
|---|---|
| timeDomainOffset | INTEGER (0..5119), |

| | |
|---|---|
| timeDomainAllocation | INTEGER (0..15), |

| | |
|---|---|
| frequency DomainAllocation | BIT STRING (SIZE(18)), |

| | |
|---|---|
| antennaPort | INTEGER (0..31), |

| | |
|---|---|
| dmrs-SeqInitialization | INTEGER (0..1) |

OPTIONAL, -- Need R

| | |
|---|---|
| precoding AndNumberOfLayers | INTEGER (0..63), |

| | |
|---|---|
| srs-ResourceIndicator | INTEGER (0..15) |

```
OPTIONAL,  -- Need R
    mcsAndTBS
INTEGER (0..31),
    frequency HoppingOffset  INTEGER  (1..  maxNrofPhysicalResourceBlocks-1)
OPTIONAL,  -- Need R
    pathlossReferenceIndex  INTEGER (0..maxNrofPUSCH-PathlossReferenceRSs-1),
    ...
  }
OPTIONAL, -- Need R
  ...
}
```

Hereinafter, a PUSCH transmission method will be described in detail. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 32, which is higher signaling, is “codebook” or “nonCodebook”.

As described above, PUSCH transmission may be dynamically scheduled through DCI format 0_0 or 0_1 and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP in a serving cell. In this case, the PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 32, the UE does not expect scheduling through DCI format 0_1.

TABLE 32

| | |
|---|---|
| PUSCH-Config ::= | SEQUENCE { |

| | |
|---|---|
| dataScramblingIdentityPUSCH | INTEGER (0 .. 1023) |

OPTIONAL, -- Need S

| | |
|---|---|
| txConfig | ENUMERATED |

| | |
|---|---|
| {codebook, nonCodebook} | OPTIONAL, -- Need S |

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequency Hopping | ENUMERATED {intraSlot, |

| | |
|---|---|
| interSlot} | OPTIONAL, -- Need S |

| | |
|---|---|
| frequency HoppingOffsetLists | SEQUENCE (SIZE (1..4)) OF INTEGER |

(1.. maxNrofPhysicalResourceBlocks−1)
OPTIONAL, -- Need M

| | |
|---|---|
| resource Allocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResource AllocationList } | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, |

| | |
|---|---|
| qam64LowSE} | OPTIONAL, -- Need S |

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, |

| | |
|---|---|
| disabled} | OPTIONAL, -- Need S |

| | |
|---|---|
| codebook Subset | ENUMERATED |

{fully AndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED |

| | |
|---|---|
| { config2} | OPTIONAL, -- Need S |

| | |
|---|---|
| uci-OnPUSCH | SetupRelease { UCI- |

| | |
|---|---|
| OnPUSCH} | OPTIONAL, -- Need M |

| | |
|---|---|
| tp-pi2BPSK | ENUMERATED {enabled} |

OPTIONAL, -- Need S
...
}

Hereinafter, codebook-based PUSCH transmission will be described in detail. The codebook-based PUSCH transmission may be dynamically scheduled through DCI format 0_0 or 0_1, and may be semi-statically configured by a configured grant. If a codebook-based PUSCH is dynamically scheduled through DCI format 0_1 or configured semi-statically by a configured grant, the UE may determine a precoder for PUSCH transmission, based on an SRS resource indicator (SRI), a transmission precoding matrix indicator (TPMI), and a transmission rank (e.g., the number of PUSCH transmission layers).

The SRI may be indicated through the SRS resource indicator (a field inside DCI) or configured through srs-ResourceIndicator (higher signaling). During codebook-based PUSCH transmission, at least one SRS resource may be configured for the UE, and a maximum of up to two SRS resources may be configured for the UE. If the UE is provided with the SRI through DCI, the SRS resource indicated by the corresponding SRI refers to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (higher signaling) and TPMI. The codebookSubset inside pusch-Config (higher signaling) may be configured to be one of “fullyAndPartialAndNonCoherent”, “partialAndNonCoherent”, or “nonCoherent”, based on UE capability reported by the UE to the base station. If the UE reported “partialAndNonCoherent” as UE capability, the UE may not expect that the value of codebookSubset (higher signaling) will be configured as “fullyAndPartialAndNonCoherent”. In addition, if the UE reported “nonCoherent” as UE capability, UE may not expect that the value of codebookSubset (higher signaling) will be configured as “fullyAndPartialAndNonCoherent” or “partialAndNonCoherent”. If nrofSRS-Ports inside SRS-ResourceSet (higher signaling) indicates two SRS antenna ports, the UE may not expect that the value of codebookSubset (upper signaling) will be configured as “partialAndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Hereinafter, non-codebook-based PUSCH transmission will be described in detail. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (higher signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (higher signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI may not indicate cross carrier or cross BWP scheduling. In addition, if the value of SRS request indicates the existence of a NZP CSI-RS, the NZP CSI-RS may be located in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (higher signaling). With regard to non-codebook-based transmission, the UE may not expect that spatialRelationInfo which is higher signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (higher signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (higher signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Hereinafter, a PUSCH preparation procedure time will be described in detail. If a base station schedules a UE so as to transmit a PUSCH by using DCI format 0_0, 0_1, or 0_2, the UE may require a PUSCH preparation procedure time such that a PUSCH is transmitted by applying a transmission method (e,g,m SRS resource transmission precoding method, the number of transmission layers, spatial domain transmission filter) indicated through DCI. The PUSCH preparation procedure time is defined in an NR system in consideration thereof. The PUSCH preparation procedure time of the UE may follow Equation 2 given below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad [ Equation 3 ]$$

Each parameter in T_{proc,2} described above in Equation 3 may have the following meaning.
N₂: may refer to the number of symbols determined according to UE processing capability 1 or 2, based on the UE's capability, and numerology p. N₂ may have a value in Table 33 if UE processing capability 1 is reported according to the UE's capability report, and may have a value in Table 34 if UE processing capability 2 is reported, and if availability of UE processing capability 2 is configured through higher layer signaling.

TABLE 33

| | PUSCH preparation |
|---|---|
| μ | time N₂ [symbols] |
| 0 | 10 |
| 1 | 12 |
| 2 | 23 |
| 3 | 36 |

TABLE 34

| | PUSCH preparation |
|---|---|
| μ | time N₂ [symbols] |
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} may refer to the numerology of a downlink used to transmit a PDCCH including DCI that schedules a PUSCH, and μ_{UL} refers to the numerology of an uplink used to transmit a PUSCH.
Tₑ: may have 1/(Δfₘₐₓ·N_{f}), Δfₘₐₓ=480·10³ Hz, N_{f}=4096.
d_{2,2}: may follow a BWP switching time if DCI that schedules a PUSCH indicates BWP switching, and may have 0 otherwise.
d₂: if OFDM symbols overlap temporally between a PUSCH having a high priority index and a PUCCH having a low priority index, the d₂ value of the PUSCH having a high priority index may be used. Otherwise, d₂ may be 0.
Tₑₓₜ: if the UE uses a shared spectrum channel access scheme, the UE may calculate Tₑₓₜ and apply the same to a PUSCH preparation procedure time. Otherwise, Tₑₓₜ may be assumed to be 0.

T_{switch}: if an uplink switching spacing has been triggered, T_{switch} may be assumed to be the switching spacing time. Otherwise, T_{switch} may be assumed to be 0.

The base station and the UE may determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system may support two types of uplink data channel repetition transmission methods (e.g., PUSCH repetition type A transmission and PUSCH repetition type B transmission). One of PUSCH repetition type A transmission and PUSCH repetition type B transmission may be configured for a UE through upper layer signaling.

### 1. PUSCH Repetition Type A Transmission

As described above, the symbol length of an uplink data channel and the location of the start symbol may be determined by a time domain resource allocation method in one slot, and abase station may notify a UE of the number of repetition transmissions through higher layer signaling (e.g., RRC signaling) or L1 signaling (e.g., DCI).

Based on the number of repetition transmissions received from the base station, the UE may repetitively transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE may omit uplink data channel transmission, but may count the number of repeated transmissions of the uplink data channel.

### 2. PUSCH Repetition Type B Transmission

As described above, the symbol length of an uplink data channel and the location of the start symbol may be determined by a time domain resource allocation method in one slot, and a base station may notify a UE of the number of repetition transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts may be given by

$${K}_{s} + ⌊ \frac{S + n \cdot L}{{N}_{symb}^{slot}} ⌋ ,$$

and the symbol starting in that slot may be given by

$$mod ( S + n \cdot L , {N}_{s y m b}^{s l o t} ) .$$

The slot in which the n^{th} nominal repetition ends may be given by

$${K}_{s} + ⌊ \frac{S + ( n + 1 ) \cdot L - 1}{{N}_{symb}^{slot}} ⌋ ,$$

and the symbol ending in that slot may be given by

$$mod ( S + ( n + 1 ) \cdot L - 1 , {N}_{symb}^{slot} ) .$$

Here, n=0, . . . , numberofrepetitions−1, S may refer to the start symbol of the configured uplink data channel, and L refers to the symbol length of the configured uplink data channel. Kₛ may refer to the slot in which PUSCH transmission starts, and

$${N}_{symb}^{slot}$$

may refer to the number of symbols per slot.

The UE may determine an invalid symbol for PUSCH repetition type B transmission. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The higher layer parameter (e.g., InvalidSymbolPattern) may provide a symbol level bitmap across one or two slots, thereby configuring the invalid symbol. In the bitmap, 1 may represent the invalid symbol. Additionally, the cycle and pattern of the bitmap may be configured through the upper layer parameter (for example, InvalidSymbolPattern). If an upper layer parameter (e.g., InvalidSymbolPattern) is configured, and if parameter InvalidSymbolPatternIndicator-ForDCIFormat0_1 or InvalidSymbolPatternIndicator-ForDCIFormat0_2 indicates 1, the UE may apply an invalid symbol pattern, and if the above parameter indicates 0, the UE may not apply the invalid symbol pattern. If a higher layer parameter (e.g., InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

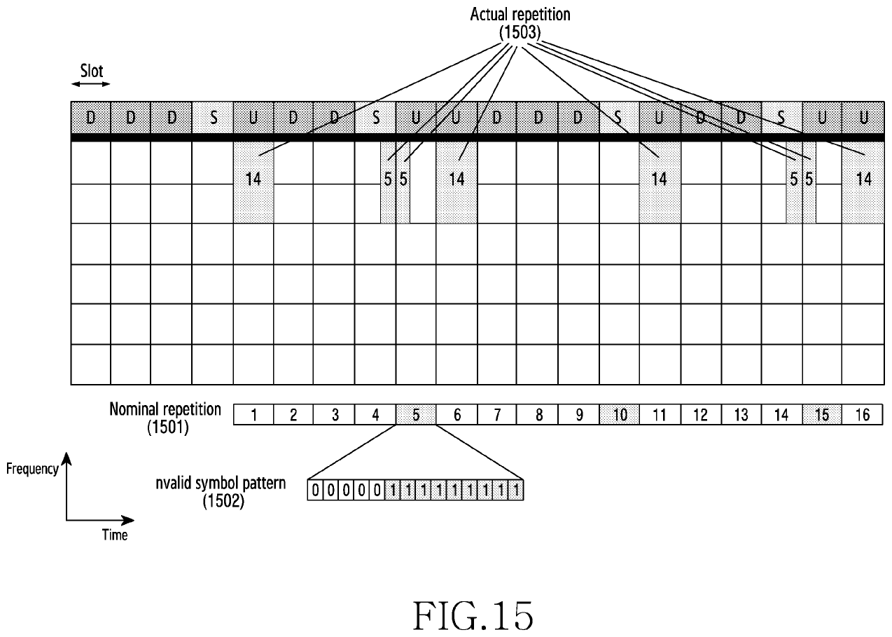

FIG. 15 illustrates an example of physical uplink shared channel (PUSCH) repetition type B transmission in a wireless communication system according to an embodiment of the disclosure.

Referring to FIG. 15, the UE may receive the following configurations: the start symbol S of an uplink data channel is 0, the length L of the uplink data channel is 14, and the number of repeated transmissions is 16. In this case, nominal repetitions may appear in 16 consecutive slots (1501). Thereafter, the UE may determine that the symbol configured as a downlink symbol in each nominal repetition 1501 is an invalid symbol. The UE may determine that symbols configured as 1 in the invalid symbol pattern 1502 are invalid symbols. If valid symbols other than invalid symbols in respective nominal repetitions constitute one or more consecutive symbols in one slot, the UE may transmit them as actual repetitions (1503).

With regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions may be scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission may occupy consecutive symbols.
Method 2 (multi-segment transmission): through one UL grant, two or more PUSCH repetition transmissions may be scheduled in consecutive slots. Transmission no. 1 may be designated for each slot, and the start point or repetition length may differ between respective transmissions. In method 2, time domain resource allocation information inside DCI may indicate the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is only a single bundle of consecutive uplink symbols in the corresponding slot, PUSCH repetition transmission may be performed once according to the method of NR Release 15.
Method 3: two or more PUSCH repetition transmissions may be scheduled in consecutive slots through two or more UL grants. Transmission no. 1 may be designated with regard to each slot, and the nth UL grant may be received before PUSCH transmission scheduled by the (n−1)^{th} UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot for each uplink period.

### [PUSCH: Frequency Hopping Process]

Hereinafter, frequency hopping of a physical uplink shared channel (PUSCH) in a 5G system will be described in detail.

A 5G system may support two kinds of PUSCH frequency hopping methods for each PUSCH repetition transmission type. First of all, in PUSCH repetition type A transmission, intra-slot frequency hopping and inter-slot frequency hopping may be supported, and in PUSCH repetition type B transmission, inter-repetition frequency hopping and inter-slot frequency hopping may be supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 4 below.

$${RB}_{s t a r t} = \{ \begin{matrix}{RB}_{start} & i = 0 \\ ( {RB}_{start} + {RB}_{offset} ) mod {N}_{BWP}^{size} & i = 1\end{matrix} \qquad [ Equation 4 ]$$

In Equation 4, i=0 and i=1 may denote the first and second hops, respectively, and RBₛₜₐᵣₜ may denote the start RB in a UL BWP and may be calculated from a frequency resource allocation method. RB_{offset} may denote a frequency offset between two hops through an higher layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ . {N}_{symb}^{PUSCH , s}$$

is the length of PUSCH transmission in one slot and may be expressed by the number of OFDM symbols.

Next, the inter-slot frequency hopping method supported in PUSCH repetition type A and type B transmissions may include a method in which the UE transmits allocated resources in the frequency domain, after changing the same by a configured frequency offset, in each slot. The start RB during slot

$${n}_{s}^{μ}$$

in connection with inter-slot frequency hopping may be expressed by Equation 5 below.

$$R {B}_{s t a r t} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 5 ]$$

In Equation 5,

$${n}_{s}^{μ}$$

may denote the current slot number during multi-slot PUSCH transmission, and RBₛₜₐᵣₜ denotes the start RB inside a UL BWP and may be calculated from a frequency resource allocation method. RB_{offset} may denote a frequency offset between two hops through an higher layer parameter.

The inter-repetition frequency hopping method supported in PUSCH repetition type B transmission may include a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the nth nominal repetition may follow Equation 6 given below.

$$R {B}_{s t a r t} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 6 ]$$

In Equation 6, n may denote the index of nominal repetition, and RB_{offset} may denote an RB offset between two hops through an higher layer parameter.

### [PUSCH: Related to Transmission Power]

Hereinafter, a method for determining transmission power of an uplink data channel in a 5G system is described in detail.

The 5G system may determine transmission power of the uplink data channel through [Equation 7] below.

$${P}_{PUSCH , b , f , c} ( i , j , q \text{?} ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{\text{?}} ( i ) + {f}_{b , f , c} ( i , l )\end{matrix} \} [ dBm ] \qquad [ Equation 7 ]$$

$$\text{?} \text{indicates text missing or illegible when filed}$$

In [Equation 7], j indicates a grant type of a PUSCH, and specifically, j=0 may indicate a PUSCH grant for a random access response, j=1 may indicate a configured grant, and jϵ{2, 3, . . . J−1} may indicate a dynamic grant. P_{CMAX,f,c}(i) may indicate maximum output power configured for the UE for carrier f of serving cell c in PUSCH transmission occasion i. P_{O_PUSCH,b,f,c}(j) may be a parameter including a sum of P_{O_NOMINAL_PUSCH,f,c}(j) configured through a higher-layer parameter and P_{O_UE_PUSCH,b,f,c}(j) that can be determined through a higher-layer configuration and an SRI (for example, in the case of a dynamic grant PUSCH).

$${M}_{RB , b , f , c}^{PUSCH} ( i )$$

may indicate a bandwidth for resource allocation expressed by the number of resource blocks for the PUSCH transmission occasion i, and Δ_{TF,b,f,c}(i) may indicate a value determined according to a modulation coding scheme (MCS) and a type of information transmitted through a PUSCH (for example, whether a UL-SCH is included or whether CSI is included). α_{b,f,c}(j) is a value for compensating pathloss, and may indicate a value that can be determined through a higher-layer configuration and an SRS resource indicator (SRI) (in the case of a dynamic grant PUSCH). PL_{b,f,c}(q_{d}) may indicate a downlink pathloss estimation value estimated by the UE through a reference signal having reference signal index q_{d}. The UE may determine the reference signal index q_{d} through the higher-layer configuration and the SRI (for example, in the case of a dynamic grant PUSCH or a configured grant PUSCH (type 2 configured grant PUSCH) based on ConfiguredGrantConfig that does not include a higher-layer configuration rrc-ConfiguredUplinkGrant) or through the higher-layer configuration. f_{b,f,c}(i,l) is a closed loop power control value, and may be supported in an accumulation type and an absolute type. When a higher-layer parameter tpc-Accumulation is not configured for the UE, the UE may determine a closed loop power control value in the accumulation type. In this case, f_{b,f,c}(i,l) is determined to be

$${f}_{b , f , c} ( i - {i}_{0} , l ) + {\sum }_{m = 0}^{\text{?}} {δ}_{PUSCH , b , f , c} ( m , l )$$

$$\text{?} \text{indicates text missing or illegible when filed}$$

that is a sum of a closed loop power control value for PUSCH transmission occasion i−i₀ and TPC command values for closed loop index 1 through DCI between symbol (KPUSCH(i−i₀)−1) for transmitting the PUSCH transmission occasion i−i₀ and symbol KPUSCH(i) for transmitting the PUSCH transmission occasion i. When the higher-layer parameter tpc-Accumulation is configured for the UE, f_{b,f,c}(i,l) is determined as a TPC command value δ_{PUSCH,b,f,c}(i,l) for closed loop index 1 received through DCI. When the higher-layer parameter twoPUSCH-PC-AdjustementStates is configured for the UE, closed loop index 1 may be configured as 0 or 1, and the value may be determined through the higher-layer configuration and the SRI (for example, in the case of dynamic grant PUSCH). The mapping relation between a TPC command field within DCI and the TPC value δ_{PUSCH,b,f,c} according to the accumulation type and the absolute type may be defined as shown in [Table 35] below.

TABLE 35

| | Accumulated | Absolute |
|---|---|---|
| TPC command | δ_{PUSCH, b, f, c} | δ_{PUSCH, b, f, c} |
| field | [dB] | [dB] |
| 0 | −1 | −4 |
| 1 | 0 | −1 |
| 2 | 1 | 1 |
| 3 | 3 | 4 |

### [Regarding PHR]

Power headroom reporting may include measuring, by a UE, the difference (e.g., this represents the available transmission power of the UE) between the nominal maximum transmission power of the UE (nominal UE maximum transmit power) and estimated power for uplink transmission, and transmitting, by the UE, the difference to a base station. Power headroom reporting may be used to support power aware packet scheduling. The estimated power for uplink transmission may include estimated power for UL-SCH (PUSCH) transmission per activated serving cell, estimated power for UL-SCH and PUCCH transmission of, in an SpCell, another MAC entity (e.g., E-UTRA MAC entity in EN-DC, NE-DC, and NGEN-DC cases in a 3GPP specification), and estimated power for SRS transmission per activated serving cell. The UE may trigger power headroom reporting if at least one of the following trigger events is satisfied.
[Trigger event 1] When higher layer parameter phr-ProhibitTimer expires and an MAC entity has an uplink resource for new transmission, a pathloss for at least one activated support cell may be changed greater than higher layer parameter phr-Tx-PowerFactorChange dB after the latest PHR transmission. Here, an activated downlink bandwidth for the at least one activated support cell may not be a dormant bandwidth. The change in the pathloss for one cell may be determined by the difference between a pathloss currently measured for a current pathloss reference and a pathloss measured at a corresponding time point for a pathloss reference at the latest PHR transmission time point.
[Trigger event 2]A case where higher layer parameter phr-PeriodicTimer expires.
[Trigger event 3]A case where, rather than a configuration or reconfiguration of not supporting power headroom reporting, a configuration or reconfiguration of a power headroom reporting function by a higher layer is performed.
[Trigger event 4]A case where an SCell for an MAC entity having an uplink for which firstActiveDownlinkBWP-Id is not configured as a dormant bandwidth part is activated. firstActiveDownlinkBWP-Id may refer to an identifier of a DL BWP to be activated at the time of RRC (re)configuration (when configured for an SpCell) or an identifier of a DL BWP to be used at the time of activation of an SCell (when configured for an SCell).
[Trigger event 5]A case where a PSCell is added (e.g., a PSCell is newly added or changed).
[Trigger event 6] When higher layer parameter phr-PrhoibitTimer expires and an MAC entity has an uplink resource for new transmission, the following items a) and b) are both satisfied for activated support cells of an MAC entity having a configured uplink:
a) There is an uplink resource allocated for transmission or a PUCCH is transmitted to a corresponding cell.
b) When a MAC entity has an uplink resource for transmission or transmits a PUCCH to a corresponding cell, a power backoff required for power management for the cell is greater than higher layer parameter phr-Tx-PowerFactorChange dB after the latest PHR transmission.
[Trigger event 7]A case where an activated bandwidth part of an SCell for a MAC entity having a configured uplink is changed from a dormant bandwidth part to a non-dormant downlink bandwidth.
[Trigger event 8]A case where, if higher layer parameter mpe-Reporting-FR2 for indicating whether to report a maximum permissible exposure maximum allowed UE output power reduction (MPE P-MPR) for satisfying an MPE in FR2 is configured for the UE and mpe-ProhibitTimer is not operating, when power headroom reporting is indicated via “MPE P-MPR reporting”, a measured P-MPR applied to satisfy an FR2 MPE requirement for at least one activated FR2 support cell is equal to or greater than the higher layer parameter mpe-Threshold after the latest power headroom reporting.

Power headroom reporting may be triggered according to trigger events and the UE may determine power headroom reporting according to the following additional conditions.
[Additional condition according to temporary required power backoff] An MAC entity may not trigger power headroom reporting when a required power backoff temporarily (e.g., for up to a few tens of milliseconds) decreases due to power management. If the required power backoff temporarily decreases and power headroom reporting is triggered by other trigger events, a resultant temporary decrease in the value of PCMAX,f,c/PH representing the ratio between the maximum power and the remaining (available) power needs to be prevented. For example, PHR may not be triggered due to a temporary power backoff. For example, the condition may be added so that, if PHR is triggered by other PHR trigger events (e.g., expiration of periodictimer), PH reflecting temporary power reduction caused by a required power backoff is not reported and PH excluding the effect of the required power backoff is reported.
[Condition for power headroom reporting according to UE implementation] If a single HARQ process is configured by cg-RetransmissionTimer and a power headroom report is already included in an MAC PDU for transmission by the HARQ process, but not yet transmitted through a lower layer, a method of processing the contents of PHR is determined according to UE implementation.

If one or more events among the above-described trigger events occur and thus power headroom reporting is triggered, and an uplink transmission resource allocated through downlink control information is able to accommodate an MAC entity for power headroom reporting and a subheader therefor, the UE may perform power headroom reporting through the uplink resource. The corresponding uplink resource may refer to a resource for uplink transmission scheduled by the first uplink grant or the first downlink control information format (first DCI format) scheduling the initial transmission of a transport block (TB) after power headroom triggering. For example, after a power headroom trigger occurs, the UE may perform power headroom reporting through an uplink transmission scheduled by the first uplink grant or the first downlink control information format among uplink resources which are able to accommodate an MAC entity for a power headroom and a subheader therefor. Alternatively, after a power headroom trigger occurs, the UE may perform power headroom reporting through a configured grant PUSCH transmission which are able to accommodate an MAC entity for a power headroom and a subheader therefor.

The UE may, at the time of power headroom reporting for a particular cell, select, calculate, and report one of two types of power headroom information. The first type is an actual PHR which may include power headroom information calculated based on the transmission power of an actually transmitted uplink signal (e.g., PUSCH). The second type is a virtual PHR (or reference format) which may include power headroom information calculated based on a transmission power parameter configured in a higher layer although there is no uplink signal (e.g., PUSCH) actually transmitted. After power headroom reporting is triggered, as described above, the UE may, calculate an actual PHR, based on higher layer information for periodic/semi-persistent SRS transmission and configured grant transmission and downlink control information received until a time point including a PDCCH monitoring interval in which the first DCI format scheduling a PUSCH, through which a MAC CE including a power headroom report is to be transmitted, is received. If the UE receives downlink control information after a PDCCH monitoring interval in which the first DCI format is received, or determines a periodic/semi-persistent SRS transmission or configured grant transmission, the UE may calculate a virtual PHR for a corresponding cell. Alternatively, after power headroom reporting is triggered, the UE may calculate an actual PHR, based on higher layer information for periodic/semi-persistent SRS transmission and configured grant transmission and downlink control information received until a time point before T′proc,2=Tproc,2 corresponding to a PUSCH preparation process time described above with respect to the first uplink symbol of a configured grant PUSCH through which transmission of corresponding power headroom information is possible. If the UE receives downlink control information after a time point before T′proc,2 with respect to the first uplink symbol of a configured grant PUSCH, or determines a periodic/semi-persistent SRS transmission or configured grant transmission, the UE may calculate a virtual PHR for a corresponding cell.

If the UE calculates an actual PHR with respect to actual PUSCH transmission, power headroom reporting information for support cell c, carrier f, bandwidth part b, and PUSCH transmission time point i may be expressed as shown in [Equation 8] below.

$${PH}_{type \text{?} b , f , c} ( i , j , {q}_{d} , l ) = {P}_{CMAX , f , c} ( i ) - \{ {P}_{O\_PUSCH b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( il ) \} [ dB ] \qquad [ Equation 8 ]$$

$$\text{?} \text{indicates text missing or illegible when filed}$$

As another example, if the UE calculates a virtual PHR, based on a transmission power parameter configured in a higher layer, power headroom reporting information for support cell c, carrier f, bandwidth part b, and PUSCH transmission time point i may be expressed as given in Equation 9 below.

$${PH}_{type \text{?} b , f , c} ( i , j , {q}_{d} , l ) = {\tilde{P}}_{CMAX , f , c} ( i ) - \{ {P}_{O\_PUSCH , b , f , c} ( j ) + {α}_{b , f , c} ( j ) \cdot {PL}_{b , f , c} ( {q}_{d} ) + {f}_{b , f , c} ( i , l ) \} [ dB ] \qquad [ Equation 9 ]$$

$$\text{?} \text{indicates text missing or illegible when filed}$$

According to Equation 8 above, the UE may calculate power headroom information by using the difference between transmission power for PUSCH transmission occasion i and maximum output power. According to Equation 9, power headroom information may be calculated using the difference between \tilde{P}_{CMAX,f,c}(i), which is maximum output power when it is assumed that a maximum power reduction (MPR)-related parameter (e.g., MPR, A-MPR (additional MPR), P-MPR (power management MPR), etc.) and Tc are 0, and reference PUSCH transmission power using a default transmission power parameter (e.g., P_{O_NOMINAL_PUSCH,fc}(O), p0 and alpha of P0-PUSCH-AlpahSet having p0-PUSCH-AlphaSetId=0, PL_{b,f,c}(q_{d}) corresponding to pusch-PathlossReferenceRS-Id=0, and a closed loop power adjustment value having closed loop index l=0). Description of each variable in Equation 8 and Equation 9 above may be referenced to the description of the variables in Equation 7. An-MPR may be MPR which satisfies an additional emission requirement indicated by a base station via higher layer signaling (e.g., a network signaling label may be identified by a combination of NR fre. band and additionalSpectrumEmission indicated via RRC (Table 6.2.3.1-1A in TS 38.101-1), and an A-MPR value according thereto is defined by Table 6.2.3.1-1 in TS 38.101-1). P-MPR may be MPR which is a maximum allowed UE output power reduction for serving cell c and has a purpose of satisfying applicable electromagnetic energy absorption requirements. A-MPR and P-MPR may be referenced to the 3GPP specification TS 38.101-1 section 6.2. First type power headroom information in a communication system to which the disclosure is applicable may refer to power headroom information for PUSCH transmission power, second type power headroom information may refer to power headroom information for PUCCH transmission power, and third type power headroom information may refer to power headroom information for SRS transmission power. However, according to various embodiments of the disclosure, the disclosure is not limited thereto.

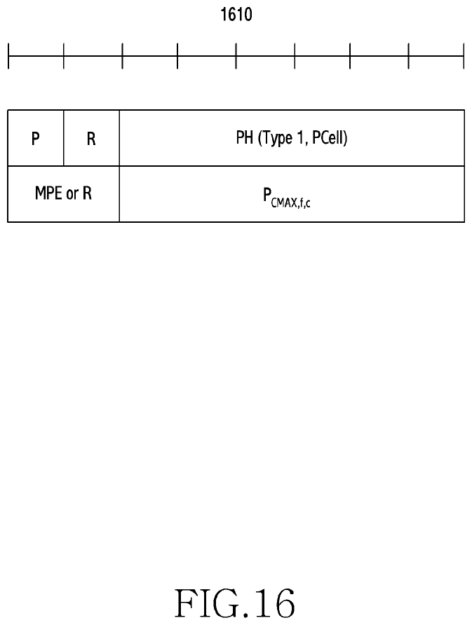

FIG. 16 illustrates a MAC CE format including single PHR information according to an embodiment of the disclosure. When MR-DC or UL-CA is not supported, the base station may configure higher-layer parameter “multiplePHR” for the corresponding UE as “false.” This may indicate that the UE supports the power headroom report on the PCell through a MAC CE having a single entry, such as a MAC CE 1610 in FIG. 16. Each field in FIG. 16 may be defined as shown in [Table 36] below. Meanwhile, the dentition is only an example, and the disclosure is not limited thereto.

TABLE 36
P: When mpe-Reporting-FR2 is configured and the serving cell operates
in FR2, P of 1 bit is set to 0 if P-MPR applied according to TS38.133 is smaller than
P-MPR_00, or otherwise, set to 1. When mpe-Reporting-FR2 is not configured or the
serving cell operates in FR1, P indicates whether power backoff is applied to control
transmission power. When power backoff is not applied due to power management
and thus corresponding P_{cmax, c} field has a different value, the corresponding P area is
set to 1.
P_{CMAX, f, c}: This field indicates a maximum transmission power value used
for calculating a power headroom when the power headroom is reported. One of 64
nominal UE transmit power levels may be selected with 6-bit information.
MPE: When mpe-Reporting-FR2 is configured, the serving cell operates
in FR2, and the P field is set to 1, the MPE area indicates a power backoff value
applied to satisfy maximum permissible exposure (MPE) requirements. A 2-bit field
indicates one of a total of 4 measured P-MPR values. When mpe-Reporting-FR2 is
not configured, the serving operates in FR1, or the P field is set to 0, a reserved bit
such as R may exist.
R: is a reserved bit and is set to 0.
PH: This field indicates a power headroom level, includes 6 bits, and may
select one of a total of 64 power headroom levels.

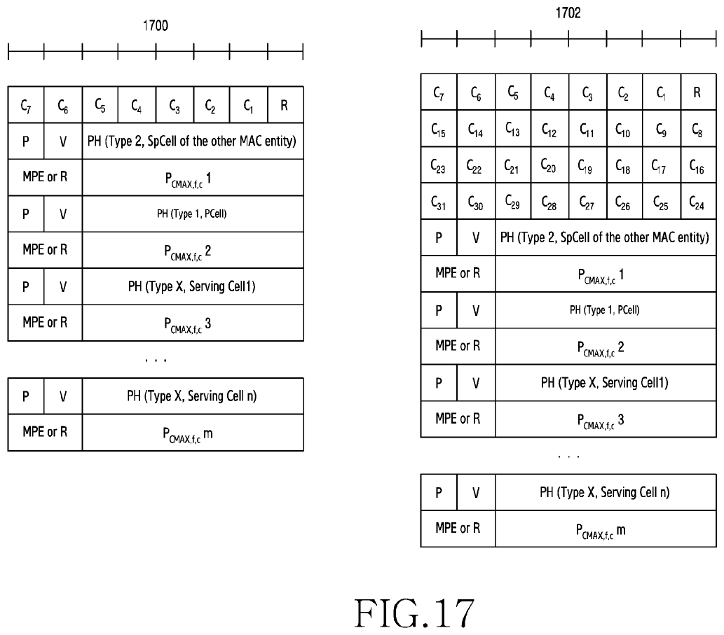

FIG. 17 illustrates a MAC CE structure including multiple pieces of PHR information according to an embodiment of the disclosure. When the UE supports multi-RAT dual connectivity (MR-DC) or uplink carrier aggregation (UL-CA), the base station may configure higher-layer parameter “multiplePHR” for the corresponding UE as “true” in order to transmit a power headroom report for each serving cell. This means that the power headroom report for multiple serving cells is supported through a MAC CE having multiple entries, such as a first format 1700 or a second format 1702 illustrated in FIG. 17. The first format 1700 of FIG. 17 may receive a configuration of multiple serving cells, and include a PHR MAC CE format that can be used when the largest index of the corresponding serving cells is smaller than 8. The second format 1702 of FIG. 17 may receive a configuration of multiple serving cells, and include a PHR MAC CE format that can be used when the largest index of the corresponding serving cells is larger than or equal to 8.

According to an embodiment, the first format 1700 or the second format 1702 illustrated in FIG. 17 may have a variable size according to a set or the number of configured serving cells unlike the PHR MAC CE format illustrated in FIG. 16. The corresponding information may include the second type PH information for a special cell (SpCell) of another MAC entity (for example, LTE) and the first type PH information for the PCell. When the largest index of the corresponding serving cells is smaller than 8, a field informing of serving cell information may include one octet. When the largest index of the corresponding serving cells is larger than or equal to 8, a field informing of serving cell information may include four octets. The PHR MAC CE may include power headroom information according to the order of serving cell indices. When the power headroom report is triggered, the MAC entity may transmit the PHR MAC CE including power headroom information through a transmittable PUSCH. In this case, whether the power headroom information is calculated based on actual transmission (for example, actual PHR) or calculated based on the transmission power parameter configured by the higher layer (for example, virtual PHR) may be determined based on the higher-layer signal and downlink control information received up to a specific time point (a time point including a PDCCH monitoring occasion in which the first DCI format is detected or a time point before T′proc,2 from the first symbol of the initial PUSCH). Meanwhile, the fields of the PHR MAC CE format illustrated in FIG. 17 may have the same meaning (definition) as most fields in the PHR MAC CE format illustrated in FIG. 16, and Cᵢ and V may have the meaning described in [Table 37] below.

TABLE 37
Cᵢ: This case indicates whether there is a power headroom area for a
serving cell having ServCellIndex i. When a power headroom for serving cell i is
reported, the corresponding area Cᵢ is set to 1. When the power headroom for the
serving cell I is not reported, the corresponding area Cᵢ is set to 0.
V: This area indicates whether a power headroom value is calculated based
on actual transmission or a reference format. For first type power headroom
information, V is set to 0 when a PUSCH is actually transmitted, and set to 1 when
the reference format for the PUSCH is used. For second type PH information, V is set
to 0 when the PUCCH is actually transmitted, and set to 1 when the reference format
for the PUCCH is used. For third type PH information, V is set to 0 when an SRS is
actually transmitted, and set to 1 when the reference format for the SRS is used.
Furthermore, P_{cmax, f, c} and the MPE field may exist when the V value is 0 for the first
type, second type, and third type power headroom information, and P_{cmax, f, c} and the
MPE field may be omitted when the V value is 1.

### [Uplink: RS]

### [Regarding SRS]

Hereinafter, an uplink channel estimation method using sounding reference signal (SRS) transmission of a UE will be described in detail. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: An SRS resource set index
srs-ResourceldList: A set of SRS resource indices referred to by SRS resource sets
resourceType: A time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: A configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: may provide a parameter configuration for adjusting the transmission power of SRS resources referred to by SRS resource sets.

The UE may assume that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. In addition, the individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the SRS resource may follow resource mapping information configured for the SRS resource, and slot mapping, including the transmission cycle and slot offset, may follow periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the SRS resource may follow resource mapping information configured for the SRS resource, and slot mapping, including the transmission cycle and slot offset, may follow periodicityAndOffset configured for the SRS resource. In addition, the spatial domain transmission filter applied to the SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through higher layer signaling.

For example, the base station may trigger aperiodic SRS transmission by the UE through DCI. The base station may indicate one of aperiodic SRS triggers (aperiodic SRS-ResourceTrigger) through the SRS request field of DCI. The UE may assume that the SRS resource set including the aperiodic SRS resource trigger indicated through DCI in the aperiodic SRS resource trigger list, among configuration information of the SRS resource set, has been triggered. UE may transmit the SRS resource referred to by the triggered SRS resource set. Intra-slot time-frequency domain resource mapping of the SRS resource may follow resource mapping information configured for the SRS resource. In addition, slot mapping of the SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. In addition, the minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 38

| | |
|---|---|
| SRS-Resource ::= | SEQUENCE { |

| | |
|---|---|
| srs-ResourceId | SRS-ResourceId, |

| | |
|---|---|
| nrofSRS-Ports | ENUMERATED {port1, ports2, ports4}, |

| | |
|---|---|
| ptrs-PortIndex | ENUMERATED {n0, n1 } |

OPTIONAL, -- Need R

| | |
|---|---|
| transmissionComb | CHOICE { |

| | |
|---|---|
| n2 | SEQUENCE { |

| | |
|---|---|
| combOffset-n2 | INTEGER (0..1), |

| | |
|---|---|
| cyclicShift-n2 | INTEGER (0..7) |

},

| | |
|---|---|
| n4 | SEQUENCE { |

| | |
|---|---|
| combOffset-n4 | INTEGER (0 .. 3), |

| | |
|---|---|
| cyclicShift-n4 | INTEGER (0 .. 11) |

```
      }
  },
```

| | |
|---|---|
| resourceMapping | SEQUENCE { |

| | |
|---|---|
| startPosition | INTEGER (0 .. 5), |

| | |
|---|---|
| nrofSymbols | ENUMERATED {n1, n2, n4}, |

| | |
|---|---|
| repetitionFactor | ENUMERATED {n1, n2, n4} |

},

| | |
|---|---|
| freqDomainPosition | INTEGER (0..67), |

| | |
|---|---|
| freqDomain Shift | INTEGER (0..268), |

| | |
|---|---|
| freqHopping | SEQUENCE { |

| | |
|---|---|
| c-SRS | INTEGER (0..63), |
| b-SRS | INTEGER (0..3), |

| | |
|---|---|
| b-hop | INTEGER (0..3) |

},

| | |
|---|---|
| groupOrSequenceHopping | ENUMERATED { neither, groupHopping, |

sequenceHopping },

| | |
|---|---|
| resource Type | CHOICE { |

| | |
|---|---|
| aperiodic | SEQUENCE { |

```
        ...
      },
```

| | |
|---|---|
| semi-persistent | SEQUENCE { |

| | |
|---|---|
| periodicity AndOffset-sp | SRS-Periodicity AndOffset, |

```
        ...
      },
```

| | |
|---|---|
| periodic | SEQUENCE { |

| | |
|---|---|
| periodicity AndOffset-p | SRS-Periodicity AndOffset, |

```
        ...
      }
  },
```

| | |
|---|---|
| sequenceId | INTEGER (0..1023), |

| | |
|---|---|
| spatialRelationInfo | SRS-SpatialRelationInfo |

OPTIONAL, -- Need R
...
}

Configuration information spatialRelationInfo in Table 38 above may be applied, with reference to one reference signal, to a beam used for SRS transmission corresponding to beam information of the corresponding reference signal. For example, configuration of spatial RelationInfo may include information as in Table 39 below.

TABLE 39

| | |
|---|---|
| SRS-SpatialRelationInfo ::= | SEQUENCE { |
| servingCellId | ServCellIndex OPTIONAL, -- Need S |

| | |
|---|---|
| reference Signal | CHOICE { |

| | |
|---|---|
| ssb-Index | SSB-Index, |

| | |
|---|---|
| csi-RS-Index | NZP-CSI-RS-ResourceId, |

| | |
|---|---|
| srs | SEQUENCE { |

| | |
|---|---|
| resourceId | SRS-ResourceId, |

| | |
|---|---|
| uplinkBWP | BWP-Id |

```
    }
  }
}
```

Referring to the spatialRelationInfo configuration, at least one of an SS/PBCH block index, CSI-RS index, or SRS index may be configured as the index of a reference signal to be referred to in order to use beam information of a specific reference signal. Higher signaling referenceSignal corresponds to configuration information indicating which reference signal's beam information is to be referred to for corresponding SRS transmission, ssb-Index may refer to the index of an SS/PBCH block, csi-RS-Index may refer to the index of a CSI-RS, and srs may refer to the index of an SRS. If higher signaling referenceSignal has a configured value of “ssb-Index”, the UE may apply the reception beam which was used to receive the SS/PBCH block corresponding to ssb-Index as the transmission beam for the corresponding SRS transmission. If higher signaling referenceSignal has a configured value of “csi-RS-Index”, the UE may apply the reception beam which was used to receive the CSI-RS corresponding to csi-RS-Index as the transmission beam for the corresponding SRS transmission. If higher signaling referenceSignal has a configured value of “srs”, the UE may apply the reception beam which was used to transmit the SRS corresponding to srs as the transmission beam for the corresponding SRS transmission.

### [Related to Uplink PTRS]

The UE may receive a configuration of a higher-layer parameter phaseTrackingRS for a PTRS in a higher-layer parameter DMRS-UplinkConfig. When transmitting a PUSCH to the base station, the UE may transmit a phase tracking reference signal (PTRS) for tracking a phase for an uplink channel. A procedure in which the UE transmits a UL PTRS may be determined according to whether transform precoding is performed during PUSCH transmission. When the transform precoding is performed and a transformPrecoderEnabled area is configured within higher-layer parameter PTRS-UplinkConfig, sampleDensity within the transformPrecoderEnabled area may indicate a sample density threshold expressed as N_{RB0} to N_{RB4} in [Table 40] below. When the transform precoding is performed and the transformPrecoderEnabled area is configured within a higher-layer parameter PTRS-UplinkConfig, the UE may determine a PT-RS group pattern for scheduled resources N_{RB} according to [Table 40]. In addition, when a transform precoder is applied to PUSCH transmission, the number of bits of a PTRS-DMRS association area for indicating the correlation between the PTRS and the DMRS within DCI format 0_1 or 0_2 may be 0.

TABLE 40

| | Number of PT-RS | Number of samples |
|---|---|---|
| Scheduled bandwidth | groups | per PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When the transform precoding is not applied to PUSCH transmission and a higher-layer parameterphaseTrackingRS is configured, frequecyDensity within a transformiPrecoderDisabled area in the higher-layer parameter PTRS-UplinkConfig may indicate N_{RB0} or N_{RB1}, and timeDensity may indicate ptrs-MCS₁ to ptrs-MCS₃. The UE may determine PT-RS density in the time domain (LPT-RS) and PT-RS density (KPT-RS) in the frequency domain according to MCS (IMCS) and RB (N_{RB}) of the scheduled PUSCH as shown in [Table 41] and [Table 42]. In [Table 41], ptrs-MCS₄ is not indicated as a higher-layer parameter, but the base station and the UE may know that the ptrs-MCS₄ is 29 or 28 according to the configured MCS table.

TABLE 41

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 42

| Scheduled bandwidth | Frequency density (K_{PT-RS}) |
|---|---|
| N_{RB} < N_{RB0} | PT-RS is not present |
| N_{RB0} ≤ NRB < N_{RB1} | 2 |
| N_{RB1} ≤ NRB | 4 |

When the transform precoder is not applied to PUSCH transmission and PTRS-UplinkConfig is configured, the base station may indicate a “PTRS-DMRS association” area of 2 bits to the UE in order to indicate the correlation between the PTRS and the DMRS within DCI format 0_1 or 0_2. The indicated PTRS-DMRS association area of 2 bits may be applied to [Table 43] or [Table 44] below according to the maximum number of ports of the PTRS, configured as maxNrofPorts within the higher-layer parameter PTRS-UplinkConfig. When the maximum number of PTRS ports is 1, the UE may determine the correlation between the PTRS and the DMRS by [Table 43] and 2 bits indicated as the PTRS-DMRS association area, and transmit the PTRS according to the determined correlation. When the maximum number of PTRS ports is 2, the UE may determine the correlation between the PTRS and the DMRS by [Table 44] and 2 bits indicated as the PTRS-DMRS association area, and transmit the PTRS according to the determined correlation.

TABLE 43

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 44

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

The DMRS ports in [Table 43] and [Table 44] may be determined through a table that is determined by the “Antenna ports” area indicated by DCI which is the same as the DCI indicating PTRS-DMRS association and the higher-layer parameter configuration. When the transform precoder is not configured through a higher configuration of the PUSCH, dmrs-Type is configured as 1, maxLength is configured as 2 for the DMRS, and a rank of the PUSCH is 2, the UE may determine a DMRS port through a bit indicated by the table for “Antenna port(s)” as in [Table 45] and the antenna port area.

When a noncodebook-based PUS CH is supported, the UE may determine a value of the rank with reference to an SRI area indicated by DCI which is the same as the DCI including the “Antenna ports” area (for example, the rank may be considered as 1 when there is no SRI area). When a codebook-based PUSCH is supported, the UE may determine a value of the rank with reference to a TPMI area indicated by DCI which is the same as the DCI including the “Antenna ports” area. [Table 45] is an example of the Antenna port table that is referenced during the PUSCH configuration, and when the PUSCH is configured as another parameter, the DMRS port may be determined according to the Antenna port table according to the configuration and the bit of the Antenna port area indicated by the DCI.

TABLE 45

| | Number of DMRS CDM | | Number of front-load |
|---|---|---|---|
| Value | group(s) without data | DMRS port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

A 1^{st} scheduled DMRS to a 4^{th} scheduled DMRS in [Table 43] may be defined as values to which DMRS ports indicated by bits of the Antenna port area of DCI and the antenna port table according to the higher-layer configuration are sequentially mapped. For example, when bits of the Antenna ports of DCI are 0001 and the DMRS ports are determined with reference to [Table 45] above, the scheduled DMRS ports may be 0 and 1, DMRS port 0 may be defined as the 1^{st} scheduled DMRS, and DMRS port 1 may be defined as the 2^{nd} scheduled DMRS. The DMRS port determined by bits of other Antenna port areas and other higher-layer configurations may also be applied in the similar way. The UE may determine one DMRS port with which the PTRS port is associated with reference to bits indicated by PTRS-DMRS association within DCI among DMRS ports defined as described above, and transmit the PTRS according to the determined DMRS port.

In [Table 44], a DMRS port that shares PTRS port 0 and a DMRS port that shares PTRS port 1 may be defined according to codebook-based PUSCH transmission or non-codebook-based PUSCH transmission. When the UE transmits a PUSCH based on a partial-coherent or non-coherent codebook, an uplink layer transmitted by PUSCH antenna ports 1000 and 1002 may have the correlation with PTRS port 0, and an uplink layer transmitted by PUSCH antenna ports 1001 and 1003 may have the correlation with PTRS port 1. In a more detailed example, when “layer 3: TPMI=2” is selected for codebook-based PUSCH transmission, a first layer is transmitted by PUSCH antenna ports 1000 and 1002 and thus has the correlation with PTRS port 0, and a second layer is transmitted by PUSCH antenna port 1001 and a third layer is transmitted by PUSCH antenna port 1002, and thus the second and third layers may have the correlation with PTRS port 1. Each of the three layers means a DMRS port, and a DMRS port for the first layer corresponds to “1^{st} DMRS port which shares PTRS port 0” in [Table 44], a DMRS port for the second layer corresponds to “1^{st} DMRS port which shares PTRS port 1” in [Table 44], and a DMRS port for the third layer corresponds to “2^{nd} DMRS port which shares PTRS port 1” in [Table 44]. Similarly, the DMRS port correlated to PTRS port 0 and the DMRS port correlated to PTRS port 1 may be determined according to the number of different layers and the TPMI. When the UE transmits a PUSCH based on non-codebook, a DMRS port correlated to PTRS port 0 and a DMRS port correlated to PTRS port 1 may be identified according to the SRI indicated by DCI and Antenna ports. More specifically, it may be configured whether an SRS resource included in an SRS resource set, the usage of which is “nonCodebook”, is correlated to PTRS port 0 or PTRS port 1 through a higher-layer parameter ptrs-PortIndex. The base station indicates the SRS resource for transmitting the non-codebook-based PUSCH through the SRI. In this case, a port of each of the indicated SRS Resources is mapped to a PUSCH DMRS port in one-to-one correspondence. The correlation between the PUSCH DMRS port and the PTRS port is determined according to a higher-layer parameter ptrs-PortIndex of the SRS resource mapped to the DMRS port.

According to an embodiment, more specifically, it may be assumed that ptrs-PortIndex is configured as n0, n0, n1, and n1 in SRS resources 1 to 4 included in the SRS resource set, the usage of which is nonCodebook. Furthermore, it may be assumed that PUSCH transmission is indicated through SRS resources 1, 2, and 4 using the SRI and DMRS ports 0, 1, and 2 are indicated by Antenna port areas. Ports of SRS resources 1, 2, and 4 are mapped to DMRS ports 0, 1, and 2, respectively. According to ptrs-PortIndex within the SRS resources, DMRS ports 0 and 1 have the correlation with PTSR port 0 and DMRS port 2 has the correlation with PTRS port 1. Accordingly, in [Table 44], DMRS port 0 may correspond to “1st DMRS port which shares PTRS port 0,” DMRS port 1 may correspond to “2nd DMRS port which shares PTRS port 0,” and DMRS port 2 may correspond to “1st DMRS port which shares PTRS port 1.”

Similar to this, the DMRS port correlated to PTRS port 0 and the DMRS port correlated to PTRS port 1 may be determined according to different patterns of ptrs-PortIndex configuration method within SRS resources, for example, different SRI values. The UE may determine the correlation between the DMRS port and the PTRS port for two PTRS ports as described above. Thereafter, among multiple DMRS ports having the correlation for each PTRS port, the UE may determine a DMRS port to be correlated to PTRS port 0 with reference to the MSB of PTRS-DMRS association, and determine a DMRS port to be correlated to PTRS port 1 with reference to the LSB, so as to transmit the PTRS.

### {PUSCH DMRS]

Hereinafter, indication of antenna port fields within DCI formats 0_1 and 0_2 will be described in detail. The antenna port fields within DCI formats 0_1 and 0_2 may be represented by 4, 5, or 6 bits, and may be indicated by Table 46 to Table 61 below.

TABLE 46

| | Number of DMRS CDM group(s) | DMRS |
|---|---|---|
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Antenna port(s), transform precoder is disabled, dmrs-Type=1, maxLength=1, rank=1

TABLE 47

| | Number of DMRS CDM group(s) | DMRS |
|---|---|---|
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

Antenna port(s), transform precoder is disabled, dmrs-Type=1, maxLength=1, rank=2

TABLE 48

| | Number of DMRS CDM group(s) | DMRS |
|---|---|---|
| Value | without data | port(s) |
| 0 | 2 | 0-2 |
| 1-7 | Reserved | Reserved |

Antenna port(s), transform precoder is disabled, dmrs-Type=1, maxLength=1, rank=3

TABLE 49

| | Number of DMRS CDM group(s) | DMRS |
|---|---|---|
| Value | without data | port(s) |
| 0 | 2 | 0-3 |
| 1-7 | Reserved | Reserved |

Antenna port(s), transform precoder is disabled, dmrs-Type=1, maxLength=1, rank=4

TABLE 50

| | Number of DMRS CDM group(s) | DMRS | Number of front- |
|---|---|---|---|
| Value | without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Antenna port(s), transform precoder is disabled, dmrs-Type=1, maxLength=2, rank=1

TABLE 51

| | Number of DMRS CDM group(s) | DMRS | Number of front- |
|---|---|---|---|
| Value | without data | port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Antenna port(s), transform precoder is disabled, dmrs-Type=1, maxLength=2, rank=2

TABLE 52

| | Number of DMRS CDM group(s) | DMRS | Number of front- |
|---|---|---|---|
| Value | without data | port(s) | load symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Antenna port(s), transform precoder is disabled, dmrs-Type=1, maxLength=2, rank=3

TABLE 53

| | Number of DMRS CDM group(s) | DMRS | Number of front- |
|---|---|---|---|
| Value | without data | port(s) | load symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Antenna port(s), transform precoder is disabled, dmrs-Type=1, maxLength=2, rank=4

TABLE 54

| | Number of DMRS CDM group(s) | DMRS |
|---|---|---|
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Antenna port(s), transform precoder is disabled, dmrs-Type=2, maxLength=1, rank=1

TABLE 55

| | Number of DMRS CDM group(s) | DMRS |
|---|---|---|
| Value | without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Antenna port(s), transform precoder is disabled, dmrs-Type=2, maxLength=1, rank=2

TABLE 56

| | Number of DMRS CDM group(s) | DMRS |
|---|---|---|
| Value | without data | port(s) |
| 0 | 2 | 0-2 |
| 1 | 3 | 0-2 |
| 2 | 3 | 3-5 |
| 3-15 | Reserved | Reserved |

Antenna port(s), transform precoder is disabled, dmrs-Type=2, maxLength=1, rank=3

TABLE 57

| | Number of DMRS CDM group(s) | DMRS |
|---|---|---|
| Value | without data | port(s) |
| 0 | 2 | 0-3 |
| 1 | 3 | 0-3 |
| 2-15 | Reserved | Reserved |

Antenna port(s), transform precoder is disabled, dmrs-Type=2, maxLength=1, rank=4

TABLE 58

| | Number of DMRS CDM group(s) | DMRS | Number of front- |
|---|---|---|---|
| Value | without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Antenna port(s), transform precoder is disabled, dmrs-Type=2, maxLength=2, rank=1

TABLE 59

| | Number of DMRS CDM group(s) | DMRS | Number of front- |
|---|---|---|---|
| Value | without data | port(s) | load symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Antenna port(s), transform precoder is disabled, dmrs-Type=2, maxLength=2, rank=2

TABLE 60

| | Number of DMRS CDM group(s) | DMRS | Number of front- |
|---|---|---|---|
| Value | without data | port(s) | load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

Antenna port(s), transform precoder is disabled, dmrs-Type=2, maxLength=2, rank=3

TABLE 61

| | Number of DMRS CDM group(s) | DMRS | Number of front- |
|---|---|---|---|
| Value | without data | port(s) | load symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Antenna port(s), transform precoder is disabled, dmrs-Type=2, maxLength=2, rank=4

Table 46 to Table 49 may indicate DMRS ports used in the case where dmrs-type is indicated as 1 and maxLength is indicated as 1, Table 50 to Table 53 may indicate DMRS ports used in the case where dmrs-Type=1 and maxLength=2, Table 54 to Table 57 may indicate DMRS ports used in the case where dmrs-type=2 and maxLength=1, and Table 58 to Table 61 may indicate DMRS ports used in the case where drms-type is 2 and maxLength is 2.

For DCI format 0_1, if higher layer signaling dmrs-UplinkForPUSCH-MappingTypeA and dmrs-UplinkForPUSCH-MappingTypeB are both configured for the UE, the bit length of the antenna port field in DCI format 0_1 may be determined as max{x_{A}, x_{B}}, where x_{A} and x_{B} may denote the bit lengths of the antenna port fields determined via dmrs-UplinkForPUSCH-MappingTypeA and dmrs-UplinkForPUSCH-MappingTypeB, respectively. If a PUSCH mapping type corresponding to the smaller one of x_{A} and x_{B} is scheduled, as many MSB bits as |x_{A}−x_{B}| may be allocated as 0 bit and transmitted.

For DCI format 0_2, if higher layer signaling antennaPortsFieldPresenceDCI-0-2 is not configured to the UE, the corresponding DCI format 0_2 may not have an antenna port field. In this case, for example, the length of the antenna port field may be 0 bit, and the UE may determine a DMRS port assuming the 0th entry of Table 46 to Table 61 above. If higher layer signaling antennaPortsFieldPresenceDCI-0-2 is configured for the UE, the bit length of the antenna port field in DCI format 0_2 may be determined similarly to the case of DCI format 0_1 described above. If higher layer signaling dmrs-UplinkForPUSCH-MappingTypeA-DCI-0-2 and dmrs-UplinkForPUSCH-MappingTypeB-DCI-0-2 are both configured for the UE, the bit length of the antenna port field in DCI format 0_2 may be determined as max{x_{A}, x_{B}}, where x_{A} and x_{B} may denote the bit lengths of the antenna port fields determined via dmrs-UplinkForPUSCH-MappingTypeA-DCI-0-2 and dmrs-UplinkForPUSCH-MappingTypeB-DCI-0-2, respectively. If a PDSCH mapping type corresponding to the smaller one of x_{A} and x_{B} is scheduled, as many MSB bits as |x_{A}−x_{B}| may be allocated as 0 bit and transmitted.

In Table 46 to Table 61, the numbers 1, 2, and 3 indicated by Number of DMRS CDM group(s) without data may refer to CDMR groups {0}, {0, 1}, and {0, 1, 2}, respectively. A DMRS port(s) may include the indexes of used ports in sequence. An antenna port may be indicated by DMRS port+1000. A DMRS CDM group may be connected with a GMRS sequence generation method and an antenna port as in Table 62 and Table 63 below. Table 62 may enumerate parameters in the case of using dmrs-type=1, and Table 63 may enumerate parameters in the case of using dmrs-type=2.

TABLE 62

| | CDM | | w_{f}(k′) | | wₜ(l′) | |
|---|---|---|---|---|---|---|
| \tilde{p} | group ^{λ} | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| d2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

Parameters for PUSCH DM-RS dmrs-type=1

TABLE 63

| | CDM | | w_{f}(k′) | | wₜ(l′) | |
|---|---|---|---|---|---|---|
| \tilde{p} | group ^{λ} | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

Parameters for PUSCH DM-RS dmrs-type=2

A DMRS sequence according to each parameter is determined by [Equation 10] below. In [Equation 10], \tilde{p} denotes a DMRS port, k denotes a subcarrier index, l denotes an OFDM symbol index, μ denotes subcarrier spacing, wf(k′) and wt(l′) denote frequency domain orthogonal cover code (FD-OCC) and time domain orthogonal cover code (TD-OCC) coefficients according to a value of k′ and a value of l′, and Δ denotes an interval between CDM groups through the numbers of subcarrier. In [Equation 10],

$${β}_{PUSCH}^{DMRS}$$

is a scaling factor that means a ratio between an energy per RE (EPRE) of a PUSCH and an EPRE of a DMRS, and may be calculated as

$${β}_{PUSCH}^{DMRS} = 10 - \frac{{β}_{DMRS}}{20} ,$$

and a value of β_{DMRS} may be 0 dB, −3 dB, or −4.77 dB as the number of CDM groups is 1, 2, or 3.

$${a}_{k , l}^{( {p}_{j} , μ )} = {w}_{f} ( {k}^{′} ) {w}_{t} ( {l}^{′} ) r ( 2 n + {k}^{′} ) \qquad [ Equation 10 ]$$

$$k = \{ \begin{matrix}4 n + 2 {k}^{′} + Δ & Configuration type 1 \\ 6 n + {k}^{′} + Δ & Configuration type 1\end{matrix}$$

$${k}^{′} = 0 , 1$$

$$l = \overline{l} + {l}^{′}$$

$$n = 0 , 1 , …$$

$$j = 0 , 1 , … , v - 1$$

$$[ \begin{matrix}\begin{matrix}{a}_{k , l}^{( {p}_{0} , μ )} \\ ⋮\end{matrix} \\ {a}_{k , l}^{( {p}_{ρ - 1} , μ )}\end{matrix} ] = {β}_{PUSCH}^{DMRS} W [ \begin{matrix}\begin{matrix}{\tilde{a}}_{k , l}^{( {p}_{0} , μ )} \\ ⋮\end{matrix} \\ {\tilde{a}}_{k , l}^{( {p}_{v - 1} , μ )}\end{matrix} ]$$

When frequency hopping is not used, the UE may assume that higher-layer signaling dmrs-AdditionalPosition is configured as “pos2,” and a maximum of 2 additional DMRS symbols may be used for PUSCH transmission. When frequency hopping is used, the UE may assume that higher-layer signaling dmrs-AdditionalPosition is configured as “pos1,” and a maximum of 1 additional DMRS symbol may be used for PUSCH transmission.

In the case of a PUSCH scheduled in DCI formats 0_1 and 0_2, the UE may assume that CDM groups indicated through a sequence of “Number of DMRS CDM group(s) without data” may include DMRS ports allocated to another UE that can be co-scheduled through a multi-user MIMO scheme in [Table 46] to [Table 61] and may not be used for the purpose of data transmission of the corresponding UE. Furthermore, the UE may understand that when the values indicated through the sequence of “Number of DMRS CDM group(s) without data” are 1, 2, and 3 in [Table 46] to [Table 61], it means that indices of a CDM group corresponding to the values correspond to CDM groups 0, {0,1}, and {0,1,2}, respectively.

### [UE Capability]

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state so as to request a capability report. The message transmitted by the UE may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In wireless mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station in the above step, the UE may configure UE capability according to band information and RAT type requested by the base station. An example in which the UE configures UE capability in an NR system is summarized below.

If the UE receives a list regarding LTE and/or NR bands from the base station at a UE capability request, the UE may configure band combinations (BCs) regarding EN-DC and NR standalone (SA). For example, the UE may configure a candidate list of BCs regarding EN-DC and NR SA, based on bands received from the base station at a request through FreqBandList. In addition, bands may have priority in the order described in FreqBandList.

If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step may be applied in MR-DC as well, that is, LTE bands may also be applied. BCs remaining after the above step may constitute the final “candidate BC list”.

The UE may select BCs appropriate for the requested RAT type from the final “candidate BC list” and select BCs to report. In this step, the UE may configure supportedBandCombinationList in a determined order. For example, the UE may configure BCs and UE capability to report according to a preconfigured rat-Type order (nr→eutra-nr→eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be obtained from feature set combinations of containers of UE-NR-Capabilities and UE-MRDC-Capabilities.

Furthermore, if the requested RAT type is eutra-nr and has an influence, featureSetCombinations may be included in both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station performs scheduling and transmission/reception management appropriate for the UE, based on the UE capability received from the UE.

### [Beam Failure Recovery]

[mTRP]

### [Regarding NC-JT]

According to various embodiment of the disclosure, in order to receive a PDSCH from a plurality of TRPs, the UE may use non-coherent joint transmission (NC-JT).

Unlike the conventional system, the 5G wireless communication system may support not only a service requiring a high transmission rate, but also a service having a very short transmission delay and a service requiring a high connection density. In a wireless communication network including multiple cells, transmission and reception points (TRPs), or beams, cooperative communication (coordinated transmission) between the respective cells, TRPs, or/and beams may satisfy various service requirements by enhancing the strength of a signal received by a UE or efficiently performing interference control between the respective cells, TRPs, or/and beams.

Joint transmission (JT) is a representative transmission technology for the aforementioned cooperative communication, and may include a technology for increasing the strength or throughput of a signal received by a UE, by transmitting the signal to one UE via multiple different cells, TRPs, and/or beams. Here, a channel between respective cells, TRPs, and/or beam and the UE may have different characteristics. Particularly, non-coherent joint transmission (NC-JT) supporting non-coherent precoding between respective cells, TRPs, and/or beams may need individual precoding, MCS, resource allocation, and TCI indication according to the channel characteristics for each link between respective cells, TRPs, and/or beam and the UE.

The above-described NC-JT transmission may be applied to at least one of a downlink data channel (PDSCH), a downlink control channel (PDCCH), an uplink data channel (PUSCH), and an uplink control channel (PUCCH). During PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

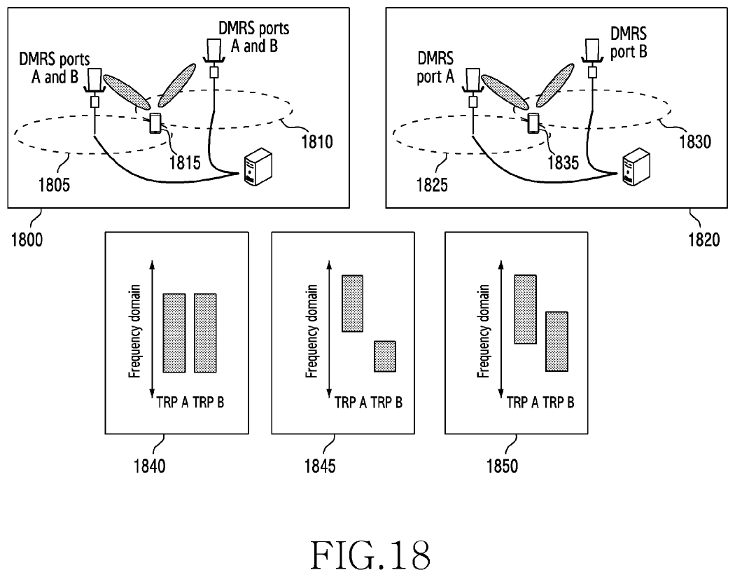

FIG. 18 illustrates an example of an antenna port configuration and resource allocation for cooperative communication in a wireless communication system according to an embodiment of the disclosure.

Referring to FIG. 18, an example for PDSCH transmission is described for each scheme of joint transmission (JT), and examples for allocating radio resources for each TRP are illustrated.

Referring to FIG. 18, an example 1800 of coherent joint transmission (C-JT) supporting coherent precoding between respective cells, TRPs, and/or beams is illustrated.

In the case of C-JT, a TRP A 1805 and a TRP B 1810 may transmit single data (PDSCH) to a UE 1815, and multiple TRPs may perform joint precoding. This may indicate that DMRSs are transmitted through identical DMRS ports in order for TRP A 1805 and TRP B 1810 to transmit the same PDSCH. For example, TRP A 1805 and TRP B 1810 may transmit DRMSs to the UE through DMRS port A and DMRS port B, respectively. In this case, the UE may receive one piece of DCI information for receiving one PDSCH demodulated based on the DMRSs transmitted through the DMRS port A and the DMRS port B.

Referring to FIG. 18, an example 1820 of non-coherent joint transmission (NC-JT) supporting non-coherent precoding between respective cells, TRPs, and/or beams for PDSCH transmission is illustrated.

In the case of NC-JT, the PDSCH may be transmitted to a UE 1835 per cell, per TPR, and/or per beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Furthermore, the respective cells, TRPs, and/or beams may repeatedly transmit the same PDSCH to the UE, thereby improving reliability as compared to single cell, TRP, and/or beam transmission. For the sake of descriptive convenience, a cell, a TRP, and/or a beam may be collectively referred to as a TRP.

In this case, various radio resource allocations may be considered, such as a case N040 where frequency and time resources used in multiple TRPs for PDSCH transmission are all identical, a case N045 where frequency and time resources used in multiple TRPs do not overlap at all, and a case N050 where some of frequency and time resources used in multiple TRPs overlap.

According to various embodiments of the disclosure, in order to support NC-JT, DCI of various types, structures, and relations may be considered to assign multiple PDSCHs simultaneously to a single UE.

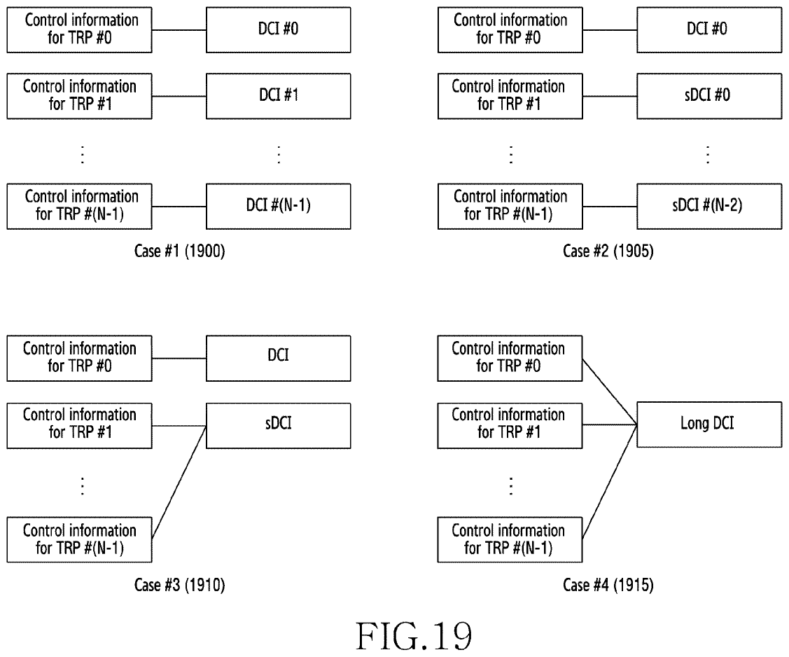

FIG. 19 illustrates an example of a downlink control information (DCI) configuration for cooperative communication in a wireless communication system according to an embodiment of the disclosure. More specifically, FIG. 19 illustrates examples of a configuration of downlink control information (DCI) for NC-JT in which respective TRPs transmit different PDSCHs or different PDSCH layers to a UE in the wireless communication system according to an embodiment of the disclosure.

Referring to FIG. 19, case #1 1900 is an example in which, in a situation where different N−1 PDSCHs are transmitted from N−1 additional TRPs (TRP #1 to TRP #N−1) in addition to a serving TRP (TRP #0) used during single PDSCH transmission, control information for PDSCHs transmitted in the additional N−1 TRPs is transmitted independently of control information for a PDSCH transmitted in the serving TRP. For example, the UE may acquire control information for PDSCHs transmitted from different TRPs (TRP #0 to TRP #N−1) via independent pieces of DCI (DCI #0 to DCI #N−1). Formats between the independent pieces of DCI may be the same or different from each other, and payloads between the pieces of DCI may also be the same or different from each other. In case #1, a degree of freedom of PDSCH control or allocation may be completely guaranteed, but if respective pieces of the DCI are transmitted by different TRPs, a difference between DCI coverages may be generated and reception performance may deteriorate.

Case #2 1905 illustrates an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission. For example, DCI #0, which is control information for the PDSCH transmitted from the serving TRP (TRP #0), includes all information elements of DCI format 1_0, DCI format 1_1, and DCI format 1_2, but shortened DCI (hereinafter, sDCI) (sDCI #0 to sDCI #N−2), which is control information for the PDSCHs transmitted from the cooperative TRPs (TRP #1 to TRP #N−1), may include only some of the information elements of DCI format 1_0, DCI format 1_1, and DCI format 1_2. Accordingly, in the case of sDCI for transmission of the control information for the PDSCHs transmitted from the cooperative TRPs, a payload is small compared to normal DCI (nDCI) for transmission of the control information related to the PDSCH transmitted from the serving TRP, so that reserved bits may be included in comparison with nDCI. In case #2, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 1910 illustrates an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission. For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information, such as frequency domain resource assignment, time domain resource assignment, and MCS of cooperative TRPs. In addition, information that is not included in the sDCI such as a bandwidth part (BWP) indicator and a carrier indicator may follow the DCI (DCI #0, normal DCI, or nDCI) of the serving TRP. In case #3 1910, each PDSCH control or allocation freedom may be restricted according to content of the information element included in the sDCI, but sDCI reception performance may be adjustable, and complexity of DCI blind decoding of the UE may be reduced compared to case #1 1900 or case #2 1905.

Case #4 1915 illustrates an example in which, in a situation where N−1 different PDSCHs are transmitted from N−1 additional TRPs (TRP #1 to TRP #N−1) in addition to a serving TRP (TRP #0) used during single PDSCH transmission, control information for PDSCHs transmitted from the N−1 additional TRPs is transmitted in the same DCI (long DCI) as that for the control information for the PDSCH transmitted from the serving TRP. For example, the UE may acquire the control information for the PDSCHs transmitted from different TRPs (TRP #0 to TRP #N−1) via a single piece of DCI. In case #4 1915, complexity of DCI blind decoding of the UE may not increase, but a PDSCH control or allocation freedom may be low, such that the number of cooperative TRPs is limited according to long DCI payload restrictions.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following descriptions and embodiments, aforementioned cases #1 1900, case #2 1905, and case #3 1910, in which one or more pieces of DCI are used for NC-JT support, may be classified as multiple-PDCCH-based NC-JT, and aforementioned case #4 1915, in which a single piece of DCI (PDCCH) is used for NC-JT support, may be classified as single-PDCCH-based NC-JT. In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Furthermore, in single PDCCH-based NC-JT, single DCI schedules a single PDSCH having multiple layers instead of scheduling multiple PDSCHs, and the multiple layers may be transmitted from multiple TRPs. In this case, association between a layer and a TRP transmitting the corresponding layer may be indicated through a transmission configuration indicator (TCI) indication for the layer.

In embodiments of the disclosure, “cooperative TRP” may be replaced with various terms, such as “cooperative panel” or “cooperative beam” when actually applied.

According to embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more transmission configuration indicator (TCI) indications in one BWP”, and “the case in which the PDSCHs received by the UE are associated with one or more DMRS port groups” according to circumstances, but is used by means of one expression for the sake of descriptive convenience.

In the disclosure, a radio protocol structure for NC-JT may be used in various ways according to a TRP deployment scenario. For example, if there is a small backhaul delay or no backhaul delay between cooperative TRPs, a method (CA-like method) using a structure based on MAC layer multiplexing is possible in a similar manner to reference numeral “410” of FIG. 4. Contrarily, if a backhaul delay between cooperative TRPs is so large that the backhaul delay cannot be ignored (e.g., when a time of 2 ms or longer is required for exchange of information, such as CSI, scheduling, and HARQ-ACK, between the cooperative TRPs), a method (DC-like method) of securing characteristics robust to a delay by using an independent structure for each TRP starting from the RLC layer is possible in a similar manner to reference numeral “420” of FIG. 4.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter (e.g., tci-StatePDSCH). Here, the UE capability parameter (e.g., tci-StatePDSCH) may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCI statesPerCC within the parameter tci-StatePDSCH which is included in capability signaling of the UE. In this way, a series of configuration procedures from the higher-layer configuration to the MAC CE configuration may be applied to a beamforming change command or a beamforming indication for at least one PDSCH in one TRP.

### [Multi-DCI-Based Multi-TRP]

As an embodiment of the disclosure, a multi-DCI-based multi-TRP transmission method will be described in detail. In the multi-DCI-based multi-TRP transmission method, a downlink control channel for NC-JT may be configured based on multi-PDCCHs.

In NC-JT based on multiple PDCCHs, there may be a CORESET or a search space separated for each TRP when the DCI for scheduling the PDSCH of each TRP is transmitted. The CORESET or the search space for each TRP can be configured according to at least one of the following configuration cases.

Configuration of a higher-layer index for each CORESET: CORESET configuration information configured by a higher layer may include an index value, and a TRP for transmitting a PDCCH in the corresponding CORESET may be distinguished by the configured index value for each CORESET. For example, in a set of CORESETs having the same higher-layer index value, it may be considered that the same TRP transmits the PDCCH or that the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. For a CORESET for which no CORESETPoolIndex value has been configured, it may be considered that a default value has been configured for CORESETPoolIndex, and the default value may be 0.

** In the disclosure, if the number of types of CORESETPoolIndex of each of multiple CORESETs included in higher-layer signaling PDCCH-Config is larger than 1, for example, if respective CORESETs have different CORESETPoolIndexes, the UE may consider that the base station can use a multi-DCI-based multi-TRP transmission method.

** Unlike this, in the disclosure, if the number of types of CORESETPoolIndex of each of a plurality of CORESETs included in higher-layer signaling PDCCH-Config is 1, for example, if all CORESETs have the same CORESETPoolIndex of 0 or 1, the UE may consider that the base station performs transmission using a single-TRP instead of using the multi-DCI-based multi-TRP transmission method.

Configuration of multiple PDCCH-Configs: Multiple PDCCH-Configs may be configured in one BWP, and each PDCCH-Config may include a PDCCH configuration for each TRP. For example, a list of CORESETs for each TRP and/or a list of search spaces for each TRP may be included in one PDCCH-Config, and it may be considered that one or more CORESETs and one or more search spaces included in one PDCCH-Config correspond to a specific TRP.

CORESET beam/beam group configuration: A TRP corresponding to a corresponding CORESET may be distinguished via a beam or beam group configured for each CORESET. For example, if the same TCI state is configured for multiple CORESETs, it may be considered that the CORESETs are transmitted via the same TRP, or that a PDCCH for scheduling of a PDSCH of the same TRP is transmitted in the corresponding CORESET.

Search space beam/beam group configuration: A beam or beam group may be configured for each search space, and a TRP for each search space may be distinguished based on the configured beam or beam group. For example, if the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by distinguishing the CORESETs or search spaces according to TRPs, it may be possible to classify PDSCH and HARQ-ACK information for each TRP, and based on this, it may be possible to independently generate an HARQ-ACK codebook and independently use a PUCCH resource for each TRP.

The above-described configuration may be independent for each cell or each BWP. For example, while two different CORESETPoolIndex values are configured for a PCell, a CORESETPoolIndex value may not be configured for a specific SCell. In this case, it may be considered that, while NC-JT is configured in the PCell, NC-JT is not configured in the SCell in which no CORESETPoolIndex value is configured.

A PDSCH TCI state activation/deactivation MAC-CE applicable to the multi-DCI-based multi-TRP transmission method may follow FIG. 13. If the UE does not receive a configuration of CORESETPoolIndex for each of all CORESETs within higher-layer signaling PDCCH-Config, the UE may ignore a CORESET Pool ID field 1355 within a corresponding MAC-CE 1350. If the UE can support the multi-DCI-based multi-TRP transmission method (e.g., if respective CORESETs within higher-layer signaling PDCCH-Config have different CORESETPoolIndexes), the UE may activate a TCI state within the DCI included in PDCCHs transmitted in CORESETs having a CORESETPoolIndex value which is the same as a value of a CORESET Pool ID field 1355 within the corresponding MAC-CE 1350. For example, if the CORESET Pool ID field 1355 within the corresponding MAC-CE 1350 has a value of 0, a TCI state within the DCI included in PDCCHs transmitted by the CORESETs having CORSETPoolIndex of 0 may follow activation information of the corresponding MAC-CE.

If the UE receives, from the base station, a configuration such that the multi-DCI-based multi-TRP transmission method can be used, (e.g., if the number of types of CORESETPoolIndex of multiple CORESETs included in higher-layer signaling PDCCH-Config is larger than 1 or respective CORESETs have different CORESETPoolIndexes), the UE may know that there are the following restrictions on PDSCHs scheduled by PDCCHs within respective CORESETs having different two CORESETPoolIndex.

If PDSCH indicated by PDCCHs within respective CORESETs having different two CORESETPoolIndexes completely or partially overlap, the UE may apply TCI states indicated by the respective PDCCHs to different CDM groups. For example, two or more TCI states may not be applied to one CDM group

If PDSCH indicated by PDCCHs within respective CORESETs having different two CORESETPoolIndexes completely or partially overlap, the UE may expect that the numbers of actual front loaded DMRS symbols of respective PDSCHs, the numbers of actual additional DMRS symbols, locations of actual DMRS symbols, and DMRS types are not different.

The UE may expect that bandwidth parts indicated by PDCCHs within respective CORESETs having different two CORESETPoolIndexes are the same and subcarrier spacings are also the same.

The UE may expect that information on PDSCH scheduled by PDCCHs within respective CORESETs having different two CORESETPoolIndex are completely included in respective PDCCHs.

### [Single-DCI-Based Multi-TRP]

As an embodiment of the disclosure, a single-DCI-based multi-TRP transmission method will be described in detail. In the single-DCI-based multi-TRP transmission method, a downlink control channel for NC-JT transmission may be configured based on a single-PDCCH.

In the single-DCI-based multi-TRP transmission method, PDSCHs transmitted by multiple TRPs may be scheduled via one piece of DCI. Here, as a method for indicating the number of TRPs transmitting the corresponding PDSCHs, the number of TCI states may be used. That is, if the number of TCI states indicated in DCI for scheduling of a PDSCH is two, single-PDCCH-based NC-JT transmission may be considered, and if the number of TCI states is one, single-TRP transmission may be considered. The TCI states indicated by the DCI may correspond to one or two TCI states among TCI states activated by the MAC CE. If the TCI states of the DCI correspond to two TCI states activated by the MAC CE, a correspondence relationship between a TCI codepoint indicated by the DCI and the TCI states activated by the MAC CE may be established, and the number of TCI states activated by the MAC CE, corresponding to the TCI codepoint, may be 2.

As another example, if at least one of all codepoints of the TCI state field within the DCI indicate two TCI states, the UE may consider that the base station can perform transmission based on the single-DCI-based multi-TRP method. In this case, at least one codepoint indicating two TCI states within the TCI state field may be activated through an enhanced PDSCH TCI state activation/deactivation MAC-CE.

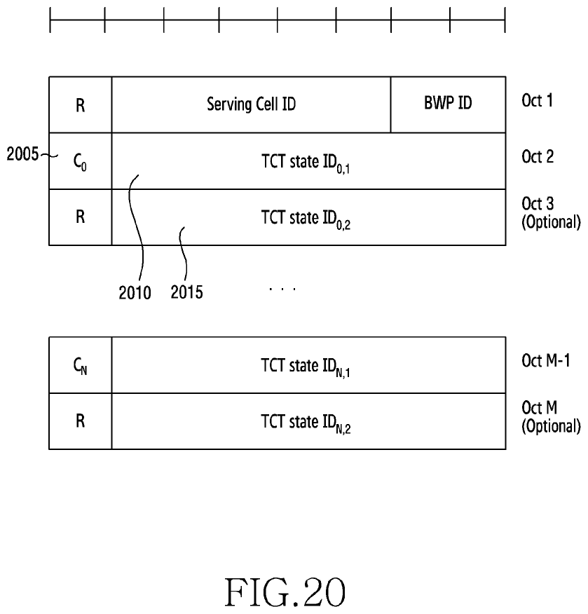

FIG. 20 illustrates an enhanced PDSCH TCI state activation/deactivation MAC-CE structure. The meaning of each field within the MAC CE and a value configurable in each field are as given in Table 64 below.

TABLE 64
Serving Cell ID: This field indicates the identity of the Serving Cell for which the MAC CE
applies. The length of the field is 5 bits. If the indicated Serving Cell is configured as part of a
simultaneousTCI-UpdateList1 or simultaneousTCI-UpdateList2 as specified in TS 38.331 [5], this MAC
CE applies to all the Serving Cells configured in the set simultaneousTCI-UpdateList1 or
simultaneousTCI-UpdateList2, respectively;
BWP ID: This field indicates a DL BWP for which the MAC CE applies as the codepoint of
the DCI bandwidth part indicator field as specified in TS 38.212 [9]. The length of the BWP ID field is
2 bits;
Cᵢ: This field indicates whether the octet containing TCI state ID_{i, 2} is present. If this field is
set to “1”, the octet containing TCI state ID_{i, 2} is present. If this field is set to “0”, the octet containing
TCI state ID_{i, 2} is not present;
TCI state ID_{i, j}: This field indicates the TCI state identified by TCI-StateId as specified in TS
38.331 [5], where i is the index of the codepoint of the DCI Transmission configuration indication field
as specified in TS 38.212 [9] and TCI state ID_{i, j} denotes the j-th TCI state indicated for the i-th codepoint
in the DCI Transmission Configuration Indication field. The TCI codepoint to which the TCI States are
mapped is determined by its ordinal position among all the TCI codepoints with sets of TCI state ID_{i, j}
fields, i.e. the first TCI codepoint with TCI state ID_{0, 1} and TCI state ID_{0, 2} shall be mapped to the
codepoint value 0, the second TCI codepoint with TCI state ID_{1, 1} and TCI state ID_{1, 2} shall be mapped to
the codepoint value 1 and so on. The TCI state ID_{i, 2} is optional based on the indication of the Ci field.
The maximum number of activated TCI codepoint is 8 and the maximum number of TCI states mapped
to a TCI codepoint is 2.
R: Reserved bit, set to “0”.

In FIG. 20, if a C0 field 2005 has a value of 1, the corresponding MAC-CE may include a TCI state ID0,2 field 2015 in addition to a TCI state ID0,1 field 2010. This may mean that, for a 0th codepoint in a TCI state filed included within DCI, TCI state ID0.1 and TCI state ID0.2 are activated. If the base station indicates the corresponding codepoint to the UE, two TCI states may be indicated to the UE. If the C0 field 2005 has a value of 0, the corresponding MAC-CE is unable to include the TC state ID0,2 field 2015, and this may mean that, for the 0th codepoint of the TCI state field included within the DCI, one TCI state corresponding to the TCI state ID0, 1 is activated.

The above-described configuration may be independent for each cell or each BWP. For example, while a maximum of two activated TCI states may correspond to one TC codepoint in the PCell, a maximum of one activated TCI states may correspond to one TCI codepoint in a specific SCell. In this case, it may be considered that, while NC-JT is configured in the PCell, NC-JT is not configured in the SCell described above.

### [Method of Distinguishing Between Single-DCI-Based Multi-TRP PDSCH Repetition Transmission Schemes (TDM/FDM/SDM)]

Next, a method of distinguishing between single-DCI-based multi-TRP PDSCH repetition transmission schemes will be described in detail. The UE may receive an indication of different single-DCI-based multi-TRP PDSCH repetition transmission schemes (e.g., TDM, FDM, and SDM) from the base station according to a value indicated by a DCI field and a higher-layer signaling configuration. Table 65 below shows a method of distinguishing between single or multi-TRP-based schemes indicated to a UE according to a specific DCI field value and a higher-layer signaling configuration.

TABLE 65

| | | Number | repetitionNumber | | |
|---|---|---|---|---|---|
| | Number. | of | configuration and | | Transmission |
| | of TCI | CDM | indication | In relation to | scheme indicated |
| Combination | states | groups | condition | repetitionScheme | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP TDM |
| | | | | not configured | scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP TDM |
| | | | | | scheme B |

Each column in Table 65 above may be described as follows.

Number of TCI states (second column): may refer to the number of TCI states indicated by a TCI state field within the DCI, and may be 1 or 2.

Number of CDM groups (third column): may refer to the number of different CDM groups of DRMS ports indicated by an antenna port field within the DCI, and may be 1, 2, or 3.

RepetitionNumber configuration and indication condition (fourth column): may have three conditions according to whether repetitionNumber for all TDRA entries which can be indicated by a time domain resource allocation field within the DCI is configured and whether an actually indicated TDRA entry has a repetitionNumber configuration.

Condition 1: A case where at least one of all TDRA entries which can be indicated by the time domain resource allocation field includes the configuration for repetitionNumber and the TDRA entry indicated by the time domain resource allocation field within the DCI includes the configuration of repetitionNumber larger than 1.

Condition 2: A case where at least one of all TDRA entries which can be indicated by the time domain resource allocation field includes the configuration for repetitionNumber and the TDRA entry indicated by the time domain resource allocation field within the DCI does not include the configuration for repetitionNumber.

Condition 3: A case where all TDRA entries which can be indicated by the time domain resource allocation field do not include the configuration for repetitionNumber.

In relation to repetitionScheme configuration (fifth column): may refer to whether higher layer signaling repetitionScheme is configured, and higher layer signaling repetitionScheme may be configured as one of “tdmSchemeA”, “fdmSchemeA”, or “fdmSchemeB”.

Transmission scheme indicated to UE (sixth column): may refer to single or multiple-TRP schemes indicated according to each combination (first column) expressed by Table 65 above.

Single-TRP: may refer to single-TRP-based PDSCH transmission. If the UE receives a configuration of pdsch-AggegationFactor within higher-layer signaling PDSCH-config, as many single TRP-based PDSCH repetition transmissions as a configured number of repetitions may be scheduled for the UE. Otherwise, the UE may receive scheduling of single TRP-based PDSCH single transmission.

Single-TRP TDM scheme B: may refer to time resource division-based PDSCH repetition transmission between single TRP-based slots. According to the above-described condition 1 related to repetitionNumber, the UE repetitively transmits a PDSCH on as many time resources as a number of slots corresponding to repetitionNumber larger than 1 configured in the TDRA entry indicated by the time domain resource allocation field. In this case, a start symbol and a symbol length of the PDSCH indicated by the TDRA entry may be equally applied to each of the slots corresponding to repetitionNumber, and the same TCI state may be applied to each of the PDSCH repetition transmissions. The corresponding scheme is similar to the slot aggregation scheme in that inter-slot PDSCH repetition transmissions are performed on time resources but is different from the slot aggregation in that whether repetition transmission is indicated can be dynamically determined based on the time domain resource allocation field within the DCI.

Multi-TRP SDM: may refer to a multi-TRP-based space resource division PDSCH transmission scheme. This is a method of receiving a PDSCH from each TRP through divided layers, and although not a repetition transmission scheme, may increase the reliability of PDSCH transmission in that transmission can be performed at a lowered coding rate by increasing the number of layers. The UE may receive a PDSCH by applying each of two TCI states indicated through the TCI state field within the DCI to each of two CDM groups indicated from the base station.

Multi-TRP FDM scheme A: may refer to a multi-TRP-based frequency resource division PDSCH transmission scheme, and is a scheme which has one PDSCH transmission occasion and thus, although not a repetition transmission scheme, may transmit a PDSCH with high reliability by increasing the amount of frequency resources to lower a coding rate, as in multi-TRP SDM. Multi-TRP FDM scheme A may apply each of two TCI states indicated through the TCI state field within the DCI to frequency resources not overlapping each other. If the PRB bundling size is determined as “wideband” and the number of RBs indicated by the frequency domain resource assignment field is N, the UE may receive a PDSCH by applying the first TCI state to first ceil (N/2) RBs and applying the second TCI state to the other floor(N/2) RBs. Here, ceil(.) and floor(.) are operators for rounding up and rounding off the first decimal place. If the PRB bundling size is determined as 2 or 4, a PDSCH may be received by applying the first TCI state to even-numbered PRGs and applying the second TCI state to odd-numbered PRGs.

Multi-TRP FDM scheme B: may refer to a multi-TRP-based frequency resource division PDSCH repetition transmission scheme, and may have two PDSCH transmission occasions and thus a PDSCH may be repetitively transmitted on each occasion. In the same manner as multi-TRP FDM scheme A, multi-TRP FDM scheme B may also apply each of two TCI states indicated through the TCI state field within the DCI to frequency resources not overlapping each other. If the PRB bundling size is determined as “wideband” and the number of RBs indicated by the frequency domain resource assignment field is N, the UE may receive a PDSCH by applying the first TCI state to first ceil (N/2) RBs and applying the second TCI state to the other floor(N/2) RBs. Here, ceil(.) and floor(.) are operators for rounding up and rounding off the first decimal place. If the PRB bundling size is determined as 2 or 4, a PDSCH may be received by applying the first TCI state to even-numbered PRGs and applying the second TCI state to odd-numbered PRGs.

Multi-TRP TDM scheme A: may refer to a PDSCH repetition transmission scheme within a multi-TRP-based time resource division slot. The UE may have two PDSCH transmission occasions within one slot, and the first reception occasion may be determined based on a start symbol and a symbol length of a PDSCH indicated through the time domain resource allocation field within the DCI. A start symbol of the second reception occasion of the PDSCH may be a location obtained by applying a symbol offset corresponding to higher-layer signaling StartingSymbolOffsetK from the last symbol of the first transmission occasion, and the transmission occasion may be determined to have the indicated symbol length from the start symbol. If higher-layer signaling StartingSymbolOffsetK is not configured, the symbol offset may be considered as 0.

Multi-TRP TDM scheme B: may refer to a PDSCH repetition transmission scheme between multi-TRP-based time resource division slots. The UE may have one PDSCH transmission occasion within one slot, and may receive PDSCH repetition transmission, based on the same start symbol and symbol length of the PDSCH during as many slots as repetitionNumber indicated through the time domain resource allocation field within the DCI. If repetitionNumber is 2, the UE may receive PDSCH repetition transmission in the first and second slots by applying the first and second TCI states, respectively. If repetitionNumber is larger than 2, the UE may use different TCI state application schemes according to the configured value of higher-layer signaling tciMapping. If tciMapping is configured as “cyclicMapping”, the first and second TCI states may be applied to the first and second PDSCH transmission occasions, respectively, and the same TCI state application scheme may be equally applied to the other PDSCH transmission occasions. If tciMapping is configured as “sequenticalMapping”, the first TCI state may be applied to the first and second PDSCH transmission occasions, the second TCI state may be applied to the third and fourth PDSCH transmission occasions, and the same TCI state application scheme may be equally applied to the other PDSCH transmission occasions.

### [Additional Multi-TCI State Indication and Activation Method Based on Unified TCI Scheme]

As embodiment of the disclosure, an additional multi-TCI state indication and activation method based on a unified TCI scheme is described. The UE may receive, from the base station, scheduling of a PDSCH including MAC-CEs which can be configured by a combination of at least one of the following various MAC-CE structures, and understand, based on information within the MAC-CEs received from the base station, each codepoint in a TCI state field within DCI format 1_1 or 1_2 after three slots for transmitting HARQ-ACK for the corresponding PDSCH to the base station. For example, the UE may activate each entry of the MAC-CE received from the base station in each codepoint in the TCI state field within DCI format 1_1 or 1_2.

For example, when the UE receives the configuration of two different CORESETPoolIndex through higher-layer signaling and receives the configuration of higher-layer signaling UL-TCIState or UL-TCIState, the base station and the UE may expect that an R field 830 existing in the first octet is understood as a field indicating a CORESET Pool ID in FIG. 8, which is one of the MAC-CE formats indicating unified TCI state activation. When the corresponding CORESET Pool ID is configured as 0, the UE may consider that the corresponding MAC-CE can be applied to each codepoint in the TCI state field within the PDCCH transmitted in the CORESET corresponding to CORESETPoolIndex 0. When the corresponding CORESET Pool ID is configured as 1, the UE may consider that the corresponding MAC-CE can be applied to each codepoint in the TCI state field within the PDCCH transmitted in the CORESET corresponding to CORESETPoolIndex 1.

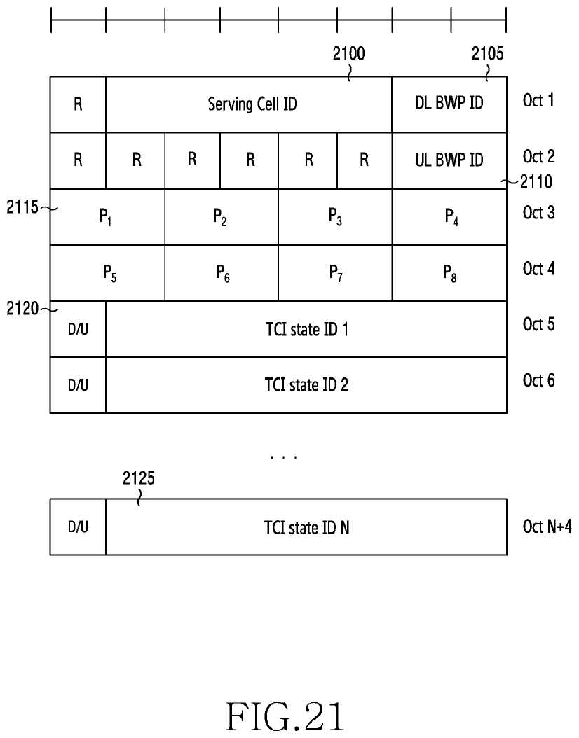

FIG. 21 illustrates another MAC-CE structure for activating and indicating multiple joint TCI states or separate DL or UL TCI states in a wireless communication system according to an embodiment of the disclosure. The meaning of each field within the corresponding MAC-CE format may be as follows.
Serving cell ID 2100: This field may indicate a service cell to which the corresponding MAC-CE is to be applied. The length of this field may be 5 bits. When the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2105: This field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 2110: This field may indicate a UL BWP to which the corresponding MAC-CE is to be applied, and the meaning of each codepoint in this field may correspond to each codepoint of a bandwidth part indicator within DCI. The length of this field may be 2 bits.
Pᵢ 2115: This field may indicate whether each codepoint in the TCI state field within DCI format 1_1 or 1_2 has multiple TCI states or one TCI state. When unifiedTCI-StateType-r17 in MIMOparam-r17 within higher-layer signaling ServingCellConfig can be configured as one of joint and separate states, the UE may understand this field as follows regardless of either configuration information.
1) When the value of Pᵢ is “00,” it means that the corresponding i^{th} codepoint has a single TCI state, which may imply that the corresponding codepoint includes the joint TCI state or one of the separate DCI TCI state and the separate UL TCI state.
2) When the value of Pᵢ is “01,” it means that the corresponding i^{th} codepoint has two TCI states, which may imply that the corresponding codepoint includes two joint TCI states, one separate DL TCI state and one separate UL TCI state, two separate DL TCI states, or two separate UL TCI states.
3) When the value of Pᵢ is “10,” it means that the corresponding i^{th} codepoint has three TCI states, which may imply that the corresponding codepoint includes one separate DL TCI state and two separate UL TCI state, or two separate DL TCI states and one separate UL TCI state.
4) When the value of Pᵢ is “11,” it means that the corresponding i^{th} codepoint has four TCI states, which may imply that the corresponding codepoint includes two separate DL TCI states and two separate UL TCI states.
5) When the UE can configure unifiedTCI-StateType-r17 in MIMOparam-r17 within ServingCellConfig corresponding to higher-layer signaling for one of joint, separate, and mixed modes, the UE may understand this field as follows regardless of a configured value among available configuration values. The mixed mode may be expressed as one configuration value having the meaning that the general mixed mode of the joint TCI state and the separate DL or UL TCI state is possible, or may be expressed as multiple configuration values such as “1joint+1DL” and “1joint+1UL,” and thus may be configured to indicate a specific combination of a specific number of joint TCI states and a specific number of separate DL or UL TCI states.
6) When the value of Pᵢ is “00,” it means that the corresponding i^{th} codepoint has a single TCI state, which may imply that the corresponding codepoint includes the joint TCI state or one of the separate DCI TCI state and the separate UL TCI state.
7) When the value of Pᵢ is “01,” it means that the corresponding i^{th} codepoint has two TCI states, which may imply that the corresponding codepoint includes two joint TCI states, one joint TCI state and one separate DL TCI state, one joint TCI state and one separate UL TCI state, one separate DL TCI state and one separate UL TCI state, two separate DL TCI states, or two separate UL TCI states. When the UE receives a configuration of a value indicating that the general mixed mode of the joint TCI state and the separate DL or UL TCI state is possible for unified TCI-StateType-r17 within MIMOparam-r17 in higher-layer signaling ServingCellConfig like the mixed mode, two cases of one joint TCI state and one separate DL TCI state and one joint TCI state and one separate UL TCI state may be all possible. When the UE receives a configuration of one of “1joint+1DL” and “1joint+1UL” through unifiedTCI-State Type-r17 in MIMOparam-r17 within ServingCellConfig corresponding to higher-layer signaling, only the case corresponding to a configuration value of unifiedTCI-StateType-r17 may be possible between one joint TCI state and one separate DL TCI state, and one joint TCI state and one separate UL TCI state.
8) When the value of Pᵢ is “10,” it means that the corresponding i^{th} codepoint has three TCI states, which may imply that the corresponding codepoint includes one separate DL TCI state and two separate UL TCI states, or two separate DL TCI states and one separate UL TCI state.
9) When the value of Pᵢ is “11,” it may mean that the corresponding i^{th} codepoint has four TCI states, which may imply that the corresponding codepoint includes two separate DL TCI states and two separate UL TCI states.
10) The corresponding field may be 2 bits.
D/U 2120: This field may indicate whether a TCI state ID field within the same octet is a joint TCI state, a separate DL TCI state, or a separate UL TCI state. When this field is 1, the TCI state ID field within the same octet may be the joint TCI state or the separate DL TCI state, and when this field is 0, the TCI state ID within the same octet may be the separate UL TCI state.
TCI state ID 2125: This field may indicate a TCI state that can be detected by a TCI-StateId corresponding to higher-layer signaling. When the D/U field is configured as 1, this field may be used to express the TCI-StateId that can be expressed by 7 bits. When the D/U field is configured as 0, a most significant bit (MSB) of this field may be considered as a reserved bit, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: means a reserved bit, and may be configured as 0.

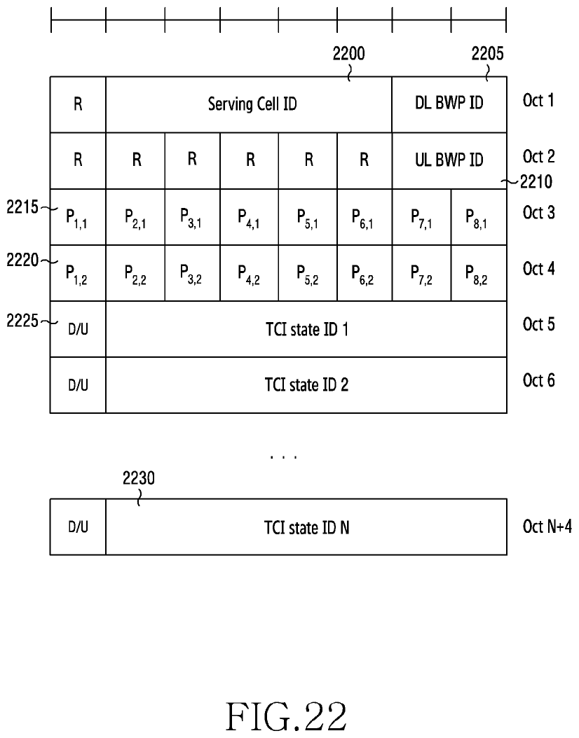

FIG. 22 illustrates another MAC-CE structure for activating and indicating multiple joint TCI states or separate DL or UL TCI states in a wireless communication system according to an embodiment of the disclosure. The meaning of each field within the corresponding MAC-CE structure may be as follows.
Serving cell ID 2200: This field may indicate a service cell to which the corresponding MAC-CE is to be applied. The length of this field may be 5 bits. When the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2205: This field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 2210: This field may indicate a UL BWP to which the corresponding MAC-CE is to be applied, and the meaning of each codepoint in this field may correspond to each codepoint of a bandwidth part indicator within DCI. The length of this field may be 2 bits.
P_{i,1} 2215 and P_{i,2} 2220: These two fields may indicate whether each codepoint in the TCI state field within DCI format 1_1 or 1_2 has multiple TCI states or one TCI state.
(1) In a case where unifiedTCI-StateType-r17 in MIMOparam-r17 within higher-layer signaling ServingCellConfig can be configured as one of joint and separate states or configured as joint, separate, and mixed modes, when the UE receives a configuration of higher-layer signaling unifiedTCI-StateType-r17 as a joint state, the UE may omit the fourth octet including the P_{i,2}, P_{2,2}, . . . P_{8,2} fields in FIG. 22, and make interpretation only for Pi,1 as follows. The mixed mode may be expressed as one configuration value having the meaning that the general mixed mode of the joint TCI state and the separate DL or UL TCI state is possible, or expressed as multiple configuration values such as “1joint+1DL” and “1joint+1UL,” and thus may be configured to indicate a specific combination of a specific number of joint TCI states and a specific number of separate DL or UL TCI states.
1) When a value of P_{i,1} is “0,” it may mean that the corresponding i^{th} codepoint has one TCI state, which may imply that the corresponding codepoint includes one joint TCI state.
2) When a value of P_{i,1} is “1,” it may mean that the corresponding i^{th} codepoint has two TCI states, which may imply that the corresponding codepoint includes two joint TCI states.
(2) For a case where unifiedTCI-StateType-r17 in MIMOparam-r17 within ServingCellConfig corresponding to higher-layer signaling can be configured for one of joint and separate states or configured for one of joint, separate, and mixed modes, if the UE receives a configuration of unifiedTCI-StateType-r17 corresponding to higher-layer signaling as a separate state, the UE may consider P_{i,1} of the third octet and P_{i,2} of the fourth octet as one field of 2 bits and make interpretation as follows. The mixed mode may be expressed as one configuration value having the meaning that the general mixed mode of the joint TCI state and the separate DL or UL TCI state is possible, or expressed as multiple configuration values such as “1joint+1DL” and “joint+1UL,” and thus may be configured to indicate a specific combination of a specific number of joint TCI states and a specific number of separate DL or UL TCI states.
1) When the value of P_{i,1} and the value of P_{i,2} are “0” and “0,” it may mean that the corresponding i^{th} codepoint has a single TCI state, which may imply that the corresponding codepoint includes the one of the separate DL TCI state and the separate UL TCI state.
2) When the value of P_{i,1} and the value of P_{i,2} are “0” and “1,” respectively, it may mean that the corresponding i^{th} codepoint has two TCI states, which may imply that the corresponding codepoint includes one separate DL TCI state and one separate UL TCI state, two separate DL TCI states, or two separate UL TCI states.
3) When the value of P_{i,1} and the value of P_{i,2} are “1” and “0,” respectively, it may mean that the corresponding i^{th} codepoint has three TCI states, which may imply that the corresponding codepoint includes one separate DL TCI state and two separate UL TCI states, or two separate DL TCI states and one separate UL TCI state.
4) When the value of P_{i,1} and the value of P_{i,2} are “1” and “1,” it may mean that the corresponding i^{th} codepoint has four TCI states, which may imply that the corresponding codepoint includes two separate DL TCI states and two separate UL TCI states.
(3) In a case where unifiedTCI-StateType-r17 in MIMOparam-r17 within higher-layer signaling ServingCellConfig can be configured for one of joint, separate, and mixed modes, when higher-layer signaling unifiedTCI-StateType-r17 is configured as the mixed mode, the UE may interpret P_{i,1} of the third octet as follows and may not transmit the fourth octet. The mixed mode may be expressed as one configuration value having a meaning that the general mixed mode of the joint TCI state and the separate DL or UL TCI state is possible.
1) When a value of P_{i,1} is “0,” it may mean that the corresponding i^{th} codepoint includes one joint TCI state and one separate DL TCI state.
2) When a value of P_{i,1} is “1,” it may mean that the corresponding i^{th} codepoint includes one joint TCI state and one separate UL TCI state.
(4) In a case where unifiedTCI-StateType-r17 in MIMOparam-r17 within higher-layer signaling ServingCellConfig can be configured for one of joint, separate, and mixed modes, when higher-layer signaling unifiedTCI-StateType-r17 is configured as the mixed mode, the UE may interpret P_{i,1} of the third octet and P_{i,2} of the fourth octet as follows. The mixed mode may be expressed as one configuration value having a meaning that the general mixed mode of the joint TCI state and the separate DL or UL TCI state is possible.
1) When the value of P_{i,1} is “0,” it may mean that the corresponding i^{th} codepoint includes only one joint TCI state. That is, since the mixed mode is not used, the value of P_{i,2} may be ignored.
2) When the value of P_{i,1} is “1,” it may mean that the corresponding i^{th} codepoint includes one of one separate UL TCI state and one separate DL TCI state, in addition to one joint TCI state. That is, the mixed mode can be used for the corresponding codepoint, one separate UL TCI state may be additionally used when the value of P_{i,2} is “0,” and one separate UL TCI state may be additionally used when the value of P_{i,2} is “1.”
D/U 2225: This field may indicate whether a TCI state ID field within the same octet is a joint TCI state, a separate DL TCI state, or a separate UL TCI state. When this field is 1, the TCI state ID field within the same octet may be the joint TCI state or the separate DL TCI state, and when this field is 0, the TCI state ID within the same octet may be the separate UL TCI state.
TCI state ID 2230: This field may indicate a TCI state that can be detected by a TCI-StateId corresponding to higher-layer signaling. When the D/U field is configured as 1, this field may be used to express the TCI-StateId that can be expressed by 7 bits. When the D/U field is configured as 0, a most significant bit (MSB) of this field may be considered as a reserved bit, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: means a reserved bit, and may be configured as 0.

According to various embodiments of the disclosure, the above-described parameters are only examples and not limited thereto, and unifiedTCI-StateType-r17 in MIMOparam-r17 within higher-layer signaling ServingCellConfig may be defined as a new parameter like unifiedTCI-StateType-r18 within higher-layer signaling MIMOparam-r18 in ServingCellConfig, or the existing parameter may be reused.

### [Group-Based Beam Reporting]

Hereinafter, when the UE is able to simultaneously receive multiple (e.g., two) reference signals (e.g., CSI-RS or SSB resources, etc.) that can be simultaneously received, the UE may report channel state information (CSI) for the reference signals that can be simultaneously received to the base station through group-based beam reporting. The group-based beam reporting may be largely divided into two methods. In the first method of group-based beam reporting, the UE may report indices (e.g., CSI RS resource indicators (CRIs) or SSB resource indicators (SSBRIs)) of two different reference signals that can be simultaneously received to the base station at a single reporting instance. In the second method of group-based beam reporting, the UE may report one or more groups to the base station at a single CSI report instance. The following detailed description may include the content of the second method of group-based beam reporting.

When the second method of group-based beam reporting is performed, a group may include indices (e.g., CRIs or SSBRIs) of two reference signals that can be simultaneously received by the UE, and the base station may configure the number of groups that the UE can report for the UE with reference to UE capability reporting made by the UE through a higher-layer parameter such as “nrofReportedGroups.” The higher-layer parameter “nrofReportedGroups” may be configured as one of 1 to 4 for the UE by the base station. Two reference signals which can be detected through reference signal indices included in one group and can be simultaneously received by the UE may be selected as CSI-RSs or SSBs from respective two resource sets for CSI report setting (for example, may be defined as two CSI resource sets according to the content specified in TS 38.214 or defined as channel measurement resource sets according to the content specified in TS 38.212). For example, an index of a first reference signal in one group reported to the base station by the UE may be determined by selecting one reference signal (for example, a reference signal having the largest measured RSRP among reference signals within the corresponding CSI resource set) from one resource set of the two CSI resource sets (for example, a CSI resource set including the reference signal having the largest measured RSRP may be selected among the two CSI resource sets, and the UE may report an Indicator of the corresponding resource set to the base station as a “resource set indicator” to report CSI). As described above, the index of the first reference signal in the first group may be the reference signal having the largest RSPR among all reference signals within two resource sets, and based on this, the UE may select a CSI resource set within the group from which the index of the first reference signal is selected among the two CSI resource sets, and may report the resource set indicator therefor to the base station as CSI information. After selecting the index of the first reference signal within the first group, the UE may select an index of a second reference signal within the first group. The UE may select the index of the second reference signal within the first group as an index of one of reference signals within the other resource sets of the two resource sets (for example, a reference signal having the largest measured RSRP among multiple reference signals that can be simultaneously received with the first reference signal within the first group) rather than the resource set from which the first reference signal within the first group is selected. The UE may report RSRP of a reference signal indicated by the index of the first reference signal within the first group. For a reference signal indicated by an index of other reference signal (for example, the index of the second reference signal within the first group, etc.), the UE may report differential RSRP indicating a difference value from the measured RSRP of the reference signal indicated by the index of the first reference signal within the first group. For example, when the measured RSRP of the reference signal indicated by the index of the first reference signal within the first group is defined as RSRP1 and the measured RSRP of the reference signal indicated by the index of the second reference signal within the first group is defined as RSRP2, the UE may determine the differential RSRP reported together with the index of the index of the second reference signal within the first group as a value indicating a value of (RSRP1−RSRP2) through as interval of 2 dB. In order to make the second method of group-based beam reporting, two CSI resource sets need to be defined as described above. When resourceType within a higher-layer signaling parameter CSI-ResourceConfig is configured as “periodic” or “semiPersistent” and “groupBasedBeamReporting-v1710” is configured for two CSI resource sets, the base station may configure two NZP CSI-RS resource sets (for example, two NZP-CSI-RS-ResourceSetIDs may be configured in nzp-CSI-RS-ResourceSetList), two CSI SSB resource sets (for example, two CSI-SSB-ResourceSetIds may be configured in csi-SSB-ResourceSetList), or one NZP CSI-RS resource set and one CSI SSB resource set (for example, one NZP-CSI-RS-ResourceSetId may be configured in nzp-CSI-RS-ResourceSetList and one CSI-SSB-ResourceSetId may be configured in csi-SSB-ResourceSetList). For example, when one NZP CSI-RS resource set and one CSI SSB resource set are configured and the UE performs the second method of group-based beam to the base station, the UE may configure the resource set indicator as “1” and report that the reference signal indicated by the index of the first reference signal within the first group is included in one CSI SSB resource set to the base station. When one NZP CSI-RS resource set and one CSI SSB resource set are configured and the UE performs the second method of group-based beam reporting to the base station, the UE may configure the resource set indicator as “0” and report that the reference signal indicated by the index of the first reference signal within the first group is included in one NZP CSI resource set to the base station. When two NZP CSI-RS resource sets are configured and the UE performs the second method of the group-based beam reporting to the base station, the UE may configure the resource set indicator as “0” and report that the reference signal indicated by the index of the first reference signal within the first group is included in the first NZP CSI resource set to the base station or configure the resource set indicator as “1” and report that the reference signal indicated by the index of the first reference signal within the first group is included in the second NZP CSI resource set to the base station. When two CSI SSB resource sets are configured and the UE performs the second method of group-based beam reporting to the base station, the UE may configure the resource set indicator as “0” and report that the reference signal indicated by the index of the first reference signal within the first group is included in the first CSI SSB resource set to the base station, or may configure the resource set indicator as “1” and report that the reference signal indicated by the index of the first reference signal within the first group is included in the second CSI SSB resource set to the base station.

When the higher-layer parameter groupBasedBeamResporting-v1710 (or groupBasedBeamReporting-r17) is configured for the UE, the UE does not need to update measurement for more than 64 CSI-RS and/or SSB resources. Furthermore, the UE may report a nrofReportedGroups (if configured) number of groups to the base station at a single reporting instance, and select one CSI-RS or SSB from each CSI resource set of the two CSI resource sets according to the reporting setting to select two CRIs or SSBRIs as one group as described above. CSI-RS and/or SSB resources in each group are selected from among resources that can be simultaneously received by the UE.

[Table 66] below describes a method of configuring a CSI field (area) for an n^{th} CSI report when the UE performs the second method of group-based beam reporting to the base station. As described above, the UE may configure a resource set indicator to be indicated through selection of one of the two CSI resource sets (or channel measurement resource sets), two reference indices included in a maximum of 4 resource groups, and RSRP or differential RSRP therefor as CSI fields, and report the same to the base station.

TABLE 66

| CSI report number | CSI fields |
|---|---|
| CSI report #n | Resource set indicator |
| | CRI or SSBRI #1 of 1st resource group |
| | CRI or SSBRI #2 of 1st resource group |
| | CRI or SSBRI #1 of 2nd resource group |
| | CRI or SSBRI #2 of 2nd resource group |
| | CRI or SSBRI #1 of 3rd resource group |
| | CRI or SSBRI #2 of 3rd resource group |
| | CRI or SSBRI #1 of 4th resource group |
| | CRI or SSBRI #2 of 4th resource group |
| | RSRP of CRI or SSBRI #1 of 1st resource group |
| | Differential RSRP of CRI or SSBRI #2 of 1st resource group |
| | Differential RSRP of CRI or SSBRI #1 of 2nd resource group |
| | Differential RSRP of CRI or SSBRI #2 of 2nd resource group |
| | Differential RSRP of CRI or SSBRI #1 of 3rd resource group |
| | Differential RSRP of CRI or SSBRI #2 of 3rd resource group |
| | Differential RSRP of CRI or SSBRI #1 of 4th resource group |
| | Differential RSRP of CRI or SSBRI #2 of 4th resource group |

Here, each elements included in the CSI field may be determined as shown in [Table 67]. Here,

$${K}_{s}^{CSI - RS}$$

is the number of CSI-RS resources configured in the corresponding CSI resource set, and

$${K}_{s}^{SSB}$$

is the number of SS/PBCH blocks configured in the corresponding CSI resource set.

TABLE 67

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| RSRP | 7 |
| Differential RSRP | 4 |
| Capability Index | 2 |

Hereinafter, various embodiments of the disclosure will be described in detail in conjunction with the accompanying drawings. The contents of the disclosure may be applied to FDD and TDD systems. As used herein, higher signaling (or higher layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

As used herein, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which may be distinguished through a higher layer/L1 parameter such as a TCI state or spatial relation information, or an indicator such as a cell ID, a TRP ID, or a panel ID may be referred to as a transmission reception point (TRP) (e.g., transmission point), a beam, or a TCI state. Therefore, when actually applied, a TRP, a beam, or a TCI state may be appropriately replaced with one of the above terms.

Hereinafter, embodiments of the disclosure will be described in detail in conjunction with the accompanying drawings. In the following description, a base station is an entity that allocates resources to terminals, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, the 5G system will be described by way of example, but the embodiments of the disclosure may be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

As used herein, the term “slot” may generally refer to a specific time unit corresponding to a transmit time interval (TTI), may specifically refer to a slot used in a 5G NR system, or may refer to a slot or a subframe used in a 4G LTE system. Furthermore, it will be apparent that a panel (or beam) according to various embodiments is used to transmit a signal and this term may be replaced with the term “resource for RS, CSI-RS, or SSB”, and the expression “at least one” may include one or more of items enumerated and the expression “multiple” may include two or more of items enumerated.

### First Embodiment: UE Beam Reporting Method and Base Station Uplink Beam Indication Method for Supporting Multi-Panel Simultaneous Transmission

The first embodiment describes a detailed method for reporting a combination of beams which can be simultaneously transmitted across multiple panels to the base station by the UE when the UE supports multi-panel simultaneous transmission.

The UE may simultaneously receive multiple (e.g., two) specific reference signals from the base station by using multiple panels. One or more specific reference signals that can be received by the UE by using multiple panels may include a combination of some reference signals among multiple reference signals supported for the corresponding UE by the base station. In order to identify the multiple reference signals that can be simultaneously received by the UE through the multiple panels, the base station may request (trigger) CSI reporting from (to) the UE. The UE may inform, through beam reporting included in specific CSI reporting, the base station of a combination or a group of reference signals that can be received through multiple panels. Specifically, the UE may inform, through group-based beam reporting, that the UE can simultaneously receive one or more reference signals or multiple (e.g., two) reference signals included in one group.

The UE may simultaneously transmit one or more uplink signals (e.g., control channels, data channels, etc. (hereinafter, referred to as “data channels” for convenience of description)) or multiple (e.g., two (hereinafter, described as “at least one” or “one or more” for convenience of description)) uplink signals by using the multiple panels. In order to schedule one or more uplink data channels that can be simultaneously transmitted by the UE, the base station may indicate an uplink beam (e.g., an uplink resource (including a CSI-RS index or an SSB index) in which the UE can perform simultaneous transmission based on multiple panels. For example, in order for the base station to schedule two uplink data channels (e.g., PUSCHs) to the UE through two panels, the base station may indicate, to the UE, two uplink transmission beams (e.g., beams indicated through a joint TCI state, a UL TCI state, etc.) in which the UE can transmit uplink data channels, respectively. In order for the base station to schedule one or more uplink data channels simultaneously transmitted based on multiple panels to the UE, the base station needs to identify a combination of uplink beams in which the multi-panel-based simultaneous transmission can be performed. The base station may use the following method to identify such uplink beam combination.

### [Method 1: Using Group-Based Beam Reporting]

When the UE supports the method for simultaneously transmitting uplink data channels by using multiple panels, the UE may report to the base station that the simultaneous transmission across multiple panels is available (e.g., UE capability report). In this case, the UE may include, as one of UE capability elements, capability of not only simultaneous reception of downlink reference signals but also uplink simultaneous transmission with reference to the corresponding downlink reference signals through the group-based beam reporting method, and perform UE capability reporting to the base station.

When the UE may support the uplink simultaneous transmission method based on the multiple panels and use the group-based beam reporting method for the purpose of beam indication for uplink simultaneous transmission, the base station may activate and/or indicate a TCI state to the UE with reference to the group-based beam reporting made by the UE. For example, the base station may activate a codepoint for indication of one or multiple TCI states to the UE by using a MAC CE. When the base station configures the higher-layer parameter unifiedTCI-StateType-r17 as “joint” for the UE so that QCL information can be indicated for both the downlink and the uplink based on the TCI state, one or multiple TCI states may be included in each codepoint for the TCI state indication activated using the MAC CE.

In order for the base station to schedule the multi-panel-based uplink simultaneous transmission to the UE, the base station needs to indicate a codepoint including multiple (e.g., two) TCI states, and the multiple TCI states indicated to the UE by the base station may be a value selected based on the group-based beam reporting made by the UE. For example, reference signals for a QCL type D of multiple (e.g., two) TCI states indicated to the UE by the base station may be multiple (e.g., two) reference signals included in one group of the group-based beam information reported by the UE. More specifically, the first TCI state among the multiple (e.g., two) TCI states indicated to the UE by the base station may be one of TCI states in which the reference signal for the QCL type D is configured as the first reference signal within the n^{th} (e.g., n is one of 1 to 4) group of the group-based beam information reported to the base station by the UE. The second TCI state among the multiple (e.g., two) TCI states indicated to the UE by the base station may be one of TCI states in which the reference signal for the QCL type D is configured as the second reference signal within the n^{th} group of the group-based beam information reported to the base station by the UE. Accordingly, when the UE reports, to the base station through the group-based beam reporting, a combination of beams in which multi-panel-based uplink simultaneous transmission to the base station is available and the base station indicates a TCI state to the UE, based on the reporting, the base station may schedule uplink data channels simultaneously transmitted through multiple panels to the UE.

### [Method 2: New Beam Reporting Method for Multi-Panel Simultaneous Transmission]

When the UE supports the method for simultaneously transmitting uplink data channels by using multiple panels, the UE may report to the base station that the simultaneous transmission across multiple panels is available (e.g., UE capability report). In this case, the UE may include, as one of UE capability elements, capability of beam reporting for multi-panel simultaneous transmission, and perform UE capability reporting to the base station.

When the UE performs CSI reporting to the base station through an available new beam reporting method, the UE may add specific information for a reported beam and report the same together. The addition information to be reported together with the reported beam may include an indicator for indicating a correlation between reported beams. For example, when the UE may simultaneously transmit uplink channels across multiple panels by using uplink beams referring to K (e.g., K is one of values greater than 1, and for example, 2) different CSI-RSs (or SSBs), CSI information of the corresponding K different CSI-RSs together with one new indicator may be included in CSI information of each CSI-RS. The UE may configure, with the same value, all new indicators included in CSI information for K CSI-RSs that can be referred to when uplink simultaneous transmission is performed, and report the same to the base station. For example, when the UE may perform multi-panel uplink simultaneous transmission with reference to a CSI-RS having a CSI-RS resource indicator (CRI) of 1 and a CSI-RS having a CRI of 2, the UE may configure, with “1”, a new indicator in CSI information for the CSI-RS having the CRI of 1, and may also configure, with “1”, the new indicator in CSI information for the CSI-RS having the CRI of 2, and report the CSI information to the base station.

According to an embodiment, when the UE may perform multi-panel uplink simultaneous transmission with reference to another CSI-RS combination, the UE may perform CSI reporting to the base station by additionally considering the same. For example, when the UE may perform multi-panel uplink simultaneous transmission with reference to a CSI-RS having a CRI of 5 and a CSI-RS having a CRI of 7, the UE may configure a new indicator in CSI information for the CSI-RS having the CRI of 5 with “2” (or a value remaining after excluding a value (“1” in the example above) of a new indicator previously used for other beam combination in which simultaneous transmission is available and a specific value (e.g., “0”) of a new indicator for indicating a beam in which multi-panel simultaneous transmission is unavailable), and may configure a new indicator in CSI information for the CSI-RS having the CRI of 7 with “2”, and report the CSI information to the base station. For other beam combinations in which multi-panel simultaneous transmission can be performed, the UE may also configure the same new indicator in the CSI information for each beam and report the same to the base station.

The example above is described for the CSI-RS, but the disclosure is not limited thereto, and the example can be also similarly applied to the SSB. For example, the UE may distinguish a beam combination in which simultaneous transmission is available, based on an SSBRI rather than a CRI, and report the same to the base station.

When an uplink beam determined based on a specific reference signal cannot support multi-panel-based simultaneous transmission, the UE may report a new indicator included in CSI reporting for the corresponding reference signal with another specific value and report the same to the base station. According to an embodiment, a value of a new indicator included in the CSI reporting for the reference signal for which multi-panel simultaneous transmission cannot be supported may be configured with “0”. Alternatively, when the base station configures, for the UE, a value obtained by adding 1 to a maximum number of beam combinations that can be reported by the UE, as “X” through the higher-layer parameter, “X” may be defined by the base station and the UE as a value of the new indicator included in the CSI reporting for the reference signal for which multi-panel simultaneous transmission cannot be supported.

According to an embodiment, as an example of another additional information reported together with the beam information, the UE may consider an operation of reporting CSI information to the base station by adding a specific indicator. When the UE may simultaneously transmit uplink channels across multiple panels by using uplink beams referring to K (e.g., K is one of values greater than 1, and for example, 2) different CSI-RSs (or SSBs), the UE may include a new indicator configured with a specific value X (e.g., 0) for CSI reporting for some reference signals of all reference signals, and may include a new indicator configured with a specific value Y (e.g., 1) for CSI reporting for some reference signals of all reference signals. When the UE configures a new indicator for reference signal 1 with “X” to report CSI information to the base station and configures a new indicator for reference signal 2 with “Y” to report CSI information to the base station, it may be defined that the UE may perform multi-panel-based simultaneous transmission with reference to reference signal 1 and reference signal 2. The base station may refer to CSI information to which the new indicator reported by the UE in order to indicate multi-panel-based simultaneous transmission to the UE, and may configure two TCI states based on the same.

According to an embodiment, the base station may identify a reference signal which can be referred to when the UE determines an uplink beam combination in which simultaneous transmission is available through one or a combination of various CSI reporting methods that can be performed by the UE as described above. The base station may activate a codepoint for indicating a TCI state by using the identified reference signal combination (for example, may activate up to 8 codepoints or up to as many codepoints as a value (e.g., 16) greater than 8 for MAC-CE-based TCI states, wherein each codepoint may indicate one TCI state or two TCI states in the case of the joint TCI state, and may indicate one TCI state or two TCI states and/or one TCI-UL-state or two TCI-UL-states in the case of the separate TCI state), and may indicate one of multiple codepoints through DCI (when two or more codepoints are activated through the MAC-CE). In this case, two TCI states (joint TCI states are assumed) may be indicated from a codepoint indicated to the UE through the DCI by the base station, and a combination of reference signals of a QCL type D of two TCI states may include a combination of reference signals CSI-reported to the base station by the UE through the above-described method (a single method or a combination of multiple methods). Such combination of reference signals indicate reference signals which can be referred to when the UE determines an uplink beam for simultaneously transmitting uplink signals across multiple panels, and thus the UE may perform multi-panel simultaneous transmission by using the TCI state indicated by the corresponding codepoint.

### Second Embodiment: Method for Transmitting Uplink Signals by UE According to Indicated TCI State when UE can Support Multi-Panel-Based Configured Grant (CG) PUSCH Simultaneous Transmission

The second embodiment describes a detailed method for transmitting, by the UE, two scheduled configured grant (CG) PUSCHs according to a TCI state indicated to the UE by the base station when two CG PUSCHs which can be simultaneously transmitted based on multiple panels are scheduled.

According to an embodiment, the UE may notify the base station through UE capability reporting that multi-panel-based uplink simultaneous transmission is available. The UE capability reporting to be made to report that multi-panel-based uplink simultaneous transmission is available may be to the base station by the UE through a parameter for new UE capability reporting, and may include multiple elements for the corresponding UE capability reporting. For example, the UE may report, to the base station through a parameter for separate UE capability reporting, whether single DCI-based multi-panel uplink simultaneous transmission is available or whether multi-DCI-based multi-panel uplink simultaneous transmission is available. When the UE may perform multi-DCI-based multi-panel uplink simultaneous transmission and transmits UE capability reporting for the same to the base station, the UE may include, in the corresponding UE capability reporting, a combination of PUSCHs scheduled in different schemes (or the same scheme), which can be simultaneously transmitted across multiple panels, and report the same to the base station. For example, when the UE can support multi-panel simultaneous transmission between a DCI-based dynamic grant (DG) PUSCH and a DG PUSCH, the UE may configure a value of a parameter for UE capability reporting with “DG+DG” and report to the base station that the UE can simultaneously transmit two different DG PUSCHs through multiple panels. Similarly, when the UE can support multi-panel simultaneous transmission between a DG PUSCH and a configured grant (CG) PUSCH, the UE may configure a value of a parameter for UE capability reporting with “DG+CG” and report to the base station that the UE can simultaneously transmit the DG PUSCH and the CG PUSCH which are different from each other through multiple panels.

According to an embodiment, CG PUSCHs may be scheduled in different schemes such as type 1 and type 2, and thus information on the types of the CG PUSCHs may be additionally reported. For example, the UE may configure the value for the parameter for the UE capability reporting with “DG+type1_CG” or “DG+type2_CG” and perform the UE capability reporting to the base station.

According to an embodiment, in another example, when the UE can support multi-panel simultaneous transmission between a CG PUSCH and a CG PUSCH, the UE may configure a value for a parameter for UE capability reporting with “CG+CG” and report to the base station that different CG PUSCHs can be simultaneously transmitted across panels, or may configure a scheduling type of a specifically supportable CG PUSCH, in addition to the value for the parameter for the UE capability reporting, configure the parameter value with “type1_CG+type1_CG,” “type1_CG+type2_CG,” type2_CG+type1_CG,” or “type2_CG+type2_CG,” and perform UE capability reporting to the base station.

According to an embodiment, when the UE can support multi-panel simultaneous transmissions between two different PUSCHs including a CG PUSCH and repots UE capability thereof to the base station, the base station may configure, for the UE, a higher-layer parameter for the CG PUSCHs which can be simultaneously transmitted based on multiple panels. The base station may configure, for the UE, a higher-layer parameter for multiple CG PUSCHs, and the UE may configure, in addition to the higher-layer configuration for CG PUSCHs for supporting multi-panel simultaneous transmission, an index for an SRS resource set associated with the corresponding CG PUSCHs. In addition, when the UE can support multi-panel uplink simultaneous transmission, the base station may configure up to two SRS resource sets, the usage of which is “codebook” or “nonCodebook”, for the UE. When a multi-DC (mDCI)-based multi-panel uplink simultaneous transmission method is supported, the base station and the UE may define that the first SRS resource set is associated with coresetPoolIndex value 0 and the second SRS resource set is associated with coresetPoolIndex value 1. Here, the first SRS resource set may indicate an SRS resource set having a lower SRS resource set ID among two SRS resource sets, the usage of which is “codebook” or “nonCodebook”, and the second SRS resource set may indicate an SRS resource set having a higher SRS resource set ID.

According to an embodiment, the UE may receive a higher-layer configuration for a type 1 CG PUSCH for multi-panel simultaneous transmission from the base station. The UE may understand that higher-layer parameters srs-ResourceIndicator and precodingAndNumberOfLayers for an SRI and a TPMI, included in the higher-layer configuration for the type 1 CG PUSCH for multi-panel simultaneous transmission, are associated with SRS resource sets indicated by indices for the SRS resource sets and used. Two different type 1 CG PUSCHs which can be simultaneously transmitted across multiple panels may be associated with SRS resource sets of different SRS resource set indices. The UE may not expect that two different two type 1 CG PUSCHs for which the same SRS resource set index is configured do not overlap in the time domain.

According to an embodiment, the UE may receive a higher-layer configuration for a type 2 CG PUSCH for multi-panel simultaneous transmission from the base station. Thereafter, the base station may activate the type 2 CG PUSCH by transmitting DCI to the UE. The activated type 2 CG PUSCH may be associated with coresetPoolIndex corresponding to a CORESET with which a PDCCH including DCI for activation is associated. When a type 2 CG PUSCH is activated by a PDCCH received through a CORESET having coresetPoolIndex value 0, the UE may identify that the corresponding type 2 CG PUSCH is associated with the coresetPoolIndex value 0 and the first SRS resource set associated with the coresetPoolIndex value 0 is associated with the activated type 2 CG PUSCH. For example, the UE may understand that an SRI and a TPMI (when a codebook-based PUSCH is supported) indicated by DCI for activating a type 2 CG PUSCH are associated with the first SRS resource set with which the corresponding type 2 CG PUSCH is associated, and used. Similarly, when a type 2 CG PUSCH is activated by a PDCCH received through a CORESET having coresetPoolIndex value 1, the UE may identify that the corresponding type 2 CG PUSCH is associated with the coresetPoolIndex value 1 and the second SRS resource set associated with the coresetPoolIndex value 1 and the activated type 2 CG PUSCH are associated. According to an embodiment, the UE may understand that an SRI and a TPMI (when a codebook-based PUSCH is supported) indicated by DCI for activating a type 2 CG PUSCH are associated with the second SRS resource set with which the corresponding type 2 CG PUSCH is associated, and used. Two different type 2 CG PUSCHs which can be simultaneously transmitted across multiple panels may be associated with different coresetPoolIndex values. The UE may not expect that two different type 2 CG PUSCHs associated with the same coresetPoolIndex overlap in the time domain.

According to an embodiment, a DG PUSCH may be associated with a coresetPoolIndex value with which a CORESET receiving DCI scheduling the corresponding PUSCH is associated, and an SRS resource set associated with the corresponding coresetPoolIndex value and the scheduled DG PUSCH may be associated with each other. For example, when a DG PUSCH is scheduled using a PDCCH received through a CORESET having coresetPoolIndex value 0, the UE may understand that for the corresponding DG PUSCH, an SRI and a TPMI (when a codebook-based PUSCH is supported) indicated to the UE through scheduling DCI by the base station are associated with the first SRS resource set and used. When a DG PUSCH is scheduled using a PDCCH received through a CORESET having coresetPoolIndex value 1, the UE may understand that for the corresponding DG PUSCH, an SRI and a TPMI (when a codebook-based PUSCH is supported) indicated to the UE through scheduling DCI by the base station are associated with the second SRS resource set and used. Two different DG PUSCHs which can be simultaneously transmitted across multiple panels may be associated with different coresetPoolIndex values. The UE may not expect that two different DG PUSCHs associated with the same coresetPoolIndex overlap in the time domain.

According to an embodiment, when a CG PUSCH and a DG PUSCH are scheduled to be simultaneously transmitted across multiple panels, the CG PUSCH and the DG PUSCH may be associated with different coresetPoolIndexs or different SRS resource sets, respectively. The UE may not expect that a CG PUSCH and a DG PUSCH, which are different from each other and associated with the same coresetPoolIndex or the same SRS resource set, overlap in the time domain. Here, the CG PUSCHs may include both a type 1 CG PUSCH and a type 2 CG PUSCH.

According to an embodiment, when a type 1 CG PUSCH and type 2 CG PUSCH are scheduled to be simultaneously transmitted across multiple panels, the type 1 CG PUSCH and the type 2 CG PUSCH may be associated with different coresetPoolIndexs or different SRS resource sets, respectively. The UE may not expect that a type 1 CG PUSCH and a type 2 CG PUSCH associated with the same coresetPoolIndex or the same SRS resource set overlap in the time domain.

According to an embodiment, the base station may indicate multiple TCI states to indicate uplink simultaneous transmission based on multiple panels to the UE. The multiple TCI states may be applied to different PUSCH transmissions, respectively. For example, the base station may indicate two TCI states to the UE. The UE may transmit the uplink and receive the downlink according to a TCI state indicated from the first slot after a beam application time (BAT) according to a unified TCI framework scheme. The UE may apply two indicated TCI states to two PUSCHs simultaneously transmitted via uplink based on multiple panels, which are scheduled after the BAT, and may transmit two PUSCHs by using the panels, respectively. In this case, two indicated TCI states may include a beam combination for which beam reporting that simultaneous transmission through multiple panels is available is performed to the base station. The UE may report, to the base station, CSI information for a beam combination in which simultaneous transmission can be performed based on multiple panels through one or multiple combinations among the various methods described in the first embodiment.

According to an embodiment, the base station may indicate, to the UE, two TCI states based on two different reference signals, rather than a reference signal corresponding to a beam combination in which the UE can perform multi-panel simultaneous transmission. This is because the base station may determine that it is advantage from the perspective of throughput or reliability to indicate transmission or reception of the UE based on two different TCI states, instead of indicating transmission or reception of the UE based on two TCI states for multi-panel transmission, in consideration of CSI information reported by the UE, a channel state identified by the base station, etc.

According to an embodiment, when the base station simultaneously support multiple UEs and schedules multi-panel-based simultaneous transmission, the UE transmits uplink channels to two TRPs, and thus the operation complexity of the base station can be increased from the perspective of traffic management of the multiple UEs. In consideration of the same, the base station may select and indicate uplink transmission method based on panel selection rather than multi-panel simultaneous transmission at a specific time point.

According to an embodiment, in addition, the base station may indicate, to the UE, two TCI states associated with two reference signals for which the UE cannot perform multi-panel simultaneous transmission (for which a QCL type D is configured as corresponding reference signals) in consideration of the various transmission or reception scheduling methods. Accordingly, when the base station indicates, to the UE, two TCI states in which multi-panel simultaneous transmission cannot be performed, the base station may schedule uplink transmission to the UE in consideration of the TCI states. For example, when a TCI state in which multi-panel simultaneous transmission is available is indicated, the base station may schedule a PUSCH for multi-panel simultaneous transmission to the UE. When a TCI state in which multi-panel simultaneous transmission is unavailable is indicated, the base station may not schedule a PUSCH for multi-panel simultaneous transmission to the UE. DG PUSCHs scheduled based on a DCI grant may be scheduled as PUSCHs simultaneously transmitted according to the implementation of the base station (for example, when the indicated TCI state indicates beams in which the UE can perform multi-panel simultaneous transmission), or may be scheduled as PUSCHs transmitted across panels not overlapping in the time domain, respectively (for example, when the indicated TCI state indicates beams in which the UE cannot perform multi-panel simultaneous transmission).

According to an embodiment, it may be difficult for the base station to schedule a CG PUSCH (specifically, type 1 CG PUSCH) scheduled based on a higher-layer configuration to be appropriately transmitted according to the TCI state. For example, when the base station indicates a TCI state in which the UE can perform multi-panel simultaneous transmission during a specific time interval and two different configured type 1 CG PUSCHs overlap in the time domain, the UE may simultaneously transmit two different type 1 CG PUSCHs through multiple panels. However, when the base station indicates a TCI state in which the UE cannot perform multi-panel simultaneous transmission during a subsequent time interval and two different configured type 1 CG PUSCHs overlap in the time domain, the UE cannot simultaneously transmit two different type 1 CG PUSCHs through multiple panels due to the indicated TCI state. For example, due to the indicated TCI state and the scheduling of the CG PUSCHs configured to be simultaneously transmitted across multiple panels, ambiguity in the operation of the UE may occur. Accordingly, in order to solve the problem that the ambiguity in the operation of the UE occurs due to the indicated TCI state and the CG PUSCH scheduling, a method for reconfiguring a higher-layer parameter may be first considered. However, more time is required for the base station to reconfigure a higher-layer parameter and for the UE to apply the reconfigured higher-layer parameter, and thus it may be substantially difficult to use the solution method based on the higher-layer parameter reconfiguration. Instead, when the ambiguity in the operation of the UE occurs due to the indicated TCI state and the CG PUSCH scheduling, the problem caused by the ambiguity in the operation of the UE can be solved by newly defining the operation between the UE and the base station.

Hereinafter, a (2-1)^{th} embodiment to a (2-3)^{th} embodiment describe a detailed method for solving the ambiguity problem of the UE operation, caused when the base station indicates, to the UE, two TCI states in which multi-panel simultaneous transmission cannot be performed.

### (2-1)^{th} Embodiment: Method for Applying Priority Rule to Multiple CG PUSCHs and Transmitting One CG PUSCH Based Thereon when UE Receives Indication of TCI States in which Multi-Panel-Based CG PUSCH Simultaneous Transmission is Unavailable

The (2-1)^{th} embodiment describes a detailed method in which one PUSCH to be transmitted by the UE is selected from among multiple CG PUSCHs overlapping in the time domain and the UE transmits the same when the base station configures, for the UE, a higher-layer parameter for a CG PUSCH for multi-panel-based simultaneous transmission and indicates, to the UE, two TCI states in which the UE cannot perform multi-panel simultaneous transmission.

As described above, according to the TCI states indicated to the UE by the base station, the UE may fail to simultaneously transmit two configured CG PUSCHs through multiple panels. The two CG PUSCHs overlapping in the time domain are configured, through the higher-layer parameter, to be simultaneously transmitted through multiple panels, and thus ambiguity in the UE operation may occur. In order to solve the ambiguity in the UE operation, a default operation between the base station and the UE may be defined in advance so that one CG PUSCH is selected for the corresponding case and the UE transmits the selected CG PUSCH to the base station. In this case, the two CG PUSCHs overlapping in the time domain may be assumed to satisfy all timeline conditions to be satisfied for the UE to apply an overlapping rule to uplink channels (e.g., a PUSCH and a PUCCH) overlapping in the time domain. A timeline may refer to a time point earlier than a preparation time required for the UE to transmit a scheduled PUSCH, and two TCI states applied to the corresponding timeline may be assumed to indicate a combination of uplink beams in which the UE cannot perform multi-panel simultaneous transmission.

According to an embodiment, when two CG PUSCHs (specifically two type 1 CG PUSCHs) which can support multi-panel simultaneous transmission and satisfy the above-described timeline condition overlap in the time domain and the UE cannot perform multi-panel simultaneous transmission with reference to two TCI states indicated by the base station, the UE may select one of the two PUSCHs and transmit the same in consideration of one or a combination of the following detailed methods.

[Detailed method 1] The UE may transmit the first CG PUSCH and may not transmit the second CG PUSCH among two CG PUSCHs. Here, the first CG PUSCH may be defined by the base station and the UE as follows.
1) The first CG PUSCH is a PUSCH that is associated with the first TCI state among two TCI states and transmitted. Here, the first TCI state may indicate the first indicated TCI state on a codepoint among two indicated TCI states. Similarly, the second TCI state may indicate a TCI state indicated later on the codepoint among the two indicated TCI states.
2) The first CG PUSCH is a PUSCH that is associated with the first SRS resource set among two SRS resource sets and transmitted. Here, the first SRS resource set may indicate an SRS resource set configured with a lower SRS resource Id among two SRS resource sets having the usage configured as “codebook” or “nonCodebook.” Similarly, the second SRS resource set may indicate an SRS resource set configured with a higher SRS resource set Id among the two SRS resource set having the usage configured as “codebook” or “nonCodebook.”
3) The first CG PUSCH is a PUSCH that is associated with a PDCCH received through a CORESET, the coresetPoolIndex value of which is configured as 0 or for which any value is not configured, and transmitted.

According to an embodiment, the UE may transmit the first CG PUSCH and may not transmit the first CG PUSCH among two CG PUSCHs. Here, the second CG PUSCH may be defined by combining one or multiple definitions among a PUSCH associated with the second TCI state and transmitted, a PUSCH associated with the second SRS resource set and transmitted, or a PUSCH associated with a PDCCG received through a CORESET, the coresetPoolIndex value of which is 1, and transmitted.

[Detailed method 2] The UE may transmit a CG PUSCH scheduled first in the time domain and may not transmit a CG PUSCH scheduled later among two CG PUSCHs. Here, the CG PUSCH scheduled first in the time domain may be defined by the base station and the UE as follows.
1) Compared to the first scheduling symbol of each PUSCH, the earliest scheduled PUSCH is defined as the CG PUSCH scheduled first in the time domain.
2) Compared to the last scheduling symbol of each PUSCH, the earliest terminating PUSCH is defined as the CG PUSCH scheduled first in the time domain.

According to an embodiment, when the PUSCH in which the first scheduled symbol is scheduled earlier is determined as the CG PUSCH scheduled first in the time domain and the first scheduling symbols of two CG PUSCHs are scheduled in the same symbol, one CG PUSCH to be transmitted by the UE may be determined according to one (e.g., detailed method 1, etc.) of the methods other than detailed method 2. When the PUSCH in which the last scheduling symbol is scheduled earlier is determined as the CG PUSCH scheduled first in the time domain and last scheduling symbols of two CG PUSCHs are scheduled in the same symbol, one CG PUSCH to be transmitted by the UE may be determined according to one (e.g., detailed method 1, etc.) of the methods other than detailed method 2.

[Detailed method 3] The UE may transmit a CG PUSCH scheduled first in the time domain and may not transmit a part of a later scheduled CG PUSCH, which is overlapping in the time domain. The UE may transmit a remaining resource of the CG PUSCH scheduled secondly in the time domain, which is not overlapping in the time domain later. Here, the same definition as that in detailed method 2 may be used for the CG PUSCH scheduled first in the time domain. When the CG PUSCH scheduled secondly in the time domain and the CG PUSCH scheduled first in the time domain completely overlap, the UE may not transmit the CG PUSCH scheduled secondly in the time domain. Likewise, when first scheduling symbols of two CG PUSCHs are scheduled in the same symbol or last scheduling symbols of the two CG PUSCHs are scheduled in the same symbol, one CG PUSCH to be transmitted by the UE may be determined according to one (e.g., detailed method 1, etc.) of the methods other than detailed method 3.

[Detailed method 4] The UE may transmit a resource in which a CG PUSCH scheduled first in the time domain and a CG PUSCH scheduled secondly in the time domain among two CG PUSCHs do not overlap in the time domain. For a resource overlapping in the time domain later and a resource in which the CG PUSCH scheduled secondly in the time domain and the CG PUSCH scheduled first in the time domain do not overlap, the UE may transmit the CG PUSCH scheduled secondly in the time domain. Here, the same definition as that in detailed method 2 may be used for the CG PUSCH scheduled first in the time domain. When the CG PUSCH scheduled first in the time domain and the CG PUSCH scheduled secondly in the time domain completely overlap in the time domain, the UE may not transmit the CG PUSCH scheduled first in the time domain. Likewise, when first scheduling symbols of two CG PUSCHs are scheduled in the same symbol or last scheduling symbols of the two CG PUSCHs are scheduled in the same symbol, one CG PUSCH to be transmitted by the UE may be determined according to one (e.g., detailed method 1, etc.) of the methods other than detailed method 4.

[Detailed 5] The UE may transmit a CG PUSCH scheduled first in the frequency domain and may not transmit a CG PUSCH scheduled later among two CG PUSCHs. Here, the CG PUSCH scheduled first in the frequency domain is a CG PUSCH having the lowest index of the first scheduled RB, and may be defined by the base station and the UE. Alternatively, the UE may transmit a CG PUSCH scheduled secondly in the frequency domain and a CG PUSCH scheduled first in the frequency domain among two CG PUSCHs. When the indices of the first scheduled RBs of two CG PUSCHs are identical, one CG PUSCH to be transmitted by the UE may be determined according to one (e.g., detailed method 1, etc.) of the methods other than detailed method 5.

[Detailed method 6] The UE may transmit a CG PUSCH scheduled using a higher modulation and coding scheme (MCS) among two CG PUSCHs and may not transmit the other CG PUSCH. Here, the UE may identify an MCS through a higher-layer parameter (e.g., mcsAndTBS) for a type 1 CG PUSCH, and may identify an MCS through a field (e.g., a modulation and coding scheme) indicated through DCI for activation for a type 2 CG PUSCH. Alternatively, the UE may transmit a CG PUSCH scheduled using a lower MCS among two CG PUSCHs and may not transmit the other CG PUSCH. When MCSs of two CG PUSCHs are identical, one CG PUSCH to be transmitted by the UE may be determined according to one (e.g., detailed method 1, etc.) of the methods other than detailed method 6.

[Detailed method 7] The UE may transmit a CG PUSCH scheduled using a larger transport block size (TBS) among two CG PUSCHs and may not transmit the other CG PUSCH. Here, the UE may identify a TBS through a higher-layer parameter for a type 1 CG PUSCH, and may identify the TBS with reference to a field indicated through DCI for activation and a higher-layer parameter for a type 2 CG PUSCH. Alternatively, the UE may transmit a CG PUSCH scheduled using a lower smaller TBS among two CG PUSCHs and may not transmit the other CG PUSCH. When TBSs of two CG PUSCHs are identical, one CG PUSCH to be transmitted by the UE may be determined according to one (e.g., detailed method 1, etc.) of the methods other than detailed method 7.

[Detailed method 8] The UE may transmit a CG PUSCH to which UCI is multiplexed and a CG PUSCH to which no UCI is multiplexed among two CG PUSCHs. When UCI is multiplexed to each of the two CG PUSCHs, one CG PUSCH to be transmitted by the UE may be determined according to one (e.g., detailed method 1, etc.) of the methods other than detailed method 8, and the UE may conditionally multiplex the UCI multiplexed to the PUSCH not to be transmitted to the PUSCH to be transmitted. In this case, the condition may include conditions for UCI types. For example, when reported UCI is CSI, a priority may be determined according to a time-domain behavior (aperiodic, semi-persistent, etc.) of reported CSI. Alternatively, the UE may transmit a CG PUSCH including an HARQ as UCI and may not transmit a CG PUSCH not including an HARQ as UCI. Similarly, when both CG PUSCHs include HARQs, one CG PUSCH to be transmitted by the UE may be determined according to one (e.g., detailed method 1, etc.) of the other methods, and the UE may multiplex all HARQs and transmit. Alternatively, the UE may drop all UCI multiplexed to the CG PUSCH not to be transmitted.

[Detailed method 9] The UE may transmit a CG PUSCH having a longer (or shorter) periodicity among two CG PUSCHs and may not transmit the other CG PUSCH. In this case, the periodicity of the CG PUSCH may be identified through a higher-layer parameter periodicity by the UE. When the periodicities of two CG PUSCHs are identical, one CG PUSCH to be transmitted by the UE may be determined according to one (e.g., detailed method 1, etc.) of the methods other than detailed method 9.

[Detailed method 10] The UE may transmit a CG PUSCH for which a larger priority index (e.g., phy-PriorityIndex) is configured as a higher-layer parameter, and may not transmit the other CG PUSCH. When the same priority index is configured for two PUSCHs, one CG PUSCH to be transmitted by the UE may be determined according to one (e.g., detailed method 1, etc.) of the methods other than detailed method 10.

[Detailed method 11] The UE may transmit a CG PUSCH for which a new higher-layer parameter for determining a priority is configured among two CG PUSCHs, and may not transmit the other CG PUSCH. When new higher-layer parameters for determining priorities are configured for either both or none of the CG PUSCHs, one CG PUSCH to be transmitted by the UE may be determined according to one (e.g., detailed method 1, etc.) of the methods other than detailed method 11.

[Detailed 12] The UE may configure a specific time domain that is periodically changes, transmit the first CG PUSCH and may not transmit the second CG PUCH in specific time domain A. In other time domain B, the UE may transmit the second CG PUSCH and may not transmit the first CG PUSCH. The information on the specific time domain may be configured for the UE by the base station, the configuration of the higher-layer parameter may be required to indicate the information, and the base station may additionally indicate DCI for indicating the time domain.

[Detailed method 13] The UE may transmit a CG PUSCH having a lower (or higher) index (e.g., configuredGrantConfigIndex) for a configured grant configuration among two CG PUSCHs, and may not transmit the other CG PUSCH. For example, the base station configures, for the UE, a higher-layer parameter for type 1 CG PUSCHs for which multi-panel simultaneous transmission can be performed, in this case, configuredGrantConfigIndex corresponding to the index for the configured grant configuration made for the first type 1 CG PUSCH may be configured to be 2, and configuredGrantConfigIndex corresponding to the index for the configured grant configuration made for the second type 1 CG PUSCH may be configured to be 4. When two type 1 CG PUSCHs are scheduled to be overlapped in the time domain and transmitted later and the base station indicates, to the UE, two TCI states in which simultaneous transmission through multiple panels cannot be performed, the UE may transmit the first type 1 CG PUSCH for which configuredGrantConfigIndex is configured to be 2 and may not transmit the second type 1 CG PUSCH for which configuredGrantConfigIndex is configured to be 4.

[Detailed method 14] The UE may calculate transmission power of each CG PUSCH among two CG PUSCHs, transmit a CG PUSCH transmitted at higher (lower) transmission power, and may not transmit the other PUSCH.

Through a combination of one or multiple methods among the above-described detailed methods 1 to 14, the UE may select one CG PUSCH (or the number of CG PUSCHs that can be simultaneously transmitted by the UE) among multiple CG PUSCHs (in the disclosure, two CG PUSCHs are assumed for convenience of description, detailed method can be extended and applied also to a case where more than two CG PUSCHs overlap) and transmit the same, and may not transmit the other CG PUSCHs.

### (2-2)^{th} Embodiment: Method for Solving Problem of Multiple Overlapping CG PUSCHs, Based on Base Station Scheduling when UE Receives Indication of TCI States in which Multi-Panel-Based CG PUSCH Simultaneous Transmission is Unavailable

The (2-2)^{th} embodiment describes, in detail, a method in which the base station solves, based on scheduling, a problem that the UE cannot perform multi-panel simultaneous transmission when the base station configures, for the UE, a higher-layer parameter for a CG PUSCH for multi-panel-based simultaneous transmission and indicates, to the UE, two TCI state in which the UE cannot perform multi-panel simultaneous transmission.

According to an embodiment, the base station may configure, for the UE, a higher-layer parameter for a CG PUSCH to support the CG PUSCH. In this case, the base station may identify a time/frequency resource in which the UE transmits the CG PUSCH. When there is uplink data to be transmitted exists, the UE may not use the allocated time/frequency resource for CG PUSCH transmission, but when there is uplink data to be transmitted, the base station may identify and manage the time/frequency resource for CG PUSCH transmission to be used by the UE. In addition, the base station may configure the same periodicity, offset, etc. or different periodicities, offsets, etc. in the time domain through higher-layer configuration for different CG PUSCHs for multi-panel simultaneous transmission. When the base station configures different periodicities and different offset values for different CG PUSCHs, the UE may transmit two different CG PUSCHs overlapping in a specific time domain through multiple panels, and the UE may transmit only one CG PUSCH in another time domain through a single panel. Accordingly, when two different CG PUSCHs which can be simultaneously transmitted through multiple panels overlap in the time domain, the base station may indicate, to the UE, two TCI states in which multi-panel simultaneous transmission is available so that the two CG PUSCHs overlapping in the time domain can be simultaneously transmitted through multiple panels. The UE may perform multi-panel simultaneous transmission by applying the two indicated TCI states to transmissions of the two different CG PUSCHs overlapping in the time domain. When two different CG PUSCHS which can be simultaneously transmitted through multiple panels do not overlap in the time domain, the base station may indicate, to the UE, two TCI states in which multi-panel simultaneous transmission is unavailable. The UE may transmit, based on the indicated TCI states, one PUSCH not overlapping in the time domain by using a single panel (alternatively, the UE may configure multiple panels as one by using one TCI state only according to a specific implementation, and transmit the same).

According to the operation described in the (2-2)^{th} embodiment, when different CG PUSCHs (e.g., type 1 CG PUSCHs) associated with different SRS resource set IDs overlap in the time domain and the UE may simultaneously transmit, based on two different SRS resource sets, the different overlapping CG PUSCHs, the base station may indicate TCI states in which the UE may transmit simultaneously transmit two different CG PUSCHs. For example, when different CG PUSCHs (e.g., type 1 CG PUSCHs) associated with different SRS resource set IDs overlap in the time domain and the different overlapping CG PUSCHs based on two different SRS resource sets are scheduled for the UE, two TCI states in which simultaneous transmission is unavailable may be indicated (by the base station), the UE may not expect that the two indicated TCI states are applied to the CG PUSCH scheduled in the first slot after the BAT and the CG PUSCH is transmitted.

According to an embodiment, in order to solve the problem that the UE cannot perform multi-panel simultaneous transmission, the base station may schedule a DCI-based DG PUSCH and an overlapping CG PUSCH on the same resource. The UE may identify that the DG PUSCH transmission has a higher priority than the CG PUSCH transmission, cancel the scheduled CG PUSCH, and transmit only the DG PUSCH based on the scheduling DCI. Through this method, the base station may identify a resource allocated to the corresponding UE, and this method can be used when the UE can process that the DG PUSCH transmission has a higher priority than the CG PUSCHs transmission. In this case, the UE may transmit the scheduled DG PUSCH by using one transmission method (e.g., single TRP-based transmission) other than the multi-panel simultaneous transmission, based on two TCI states in which multi-panel simultaneous transmission cannot be performed by the UE.

### (2-3)^{th} Embodiment: Additional Method for Solving Problem of Multiple Overlapping CG PUSCHs, Based on UE Operation when UE Receives Indication of TCI States in which Multi-Panel-Based CG PUSCH Simultaneous Transmission is Unavailable

The (2-3)^{th} embodiment describes, in detail, additional methods in which the UE solves ambiguity in the UE operation by performing a specific operation according to a determined rule when the base station configures, for the UE, a higher-layer parameter for CG PUSCHs for multi-panel simultaneous transmission and indicates, to the UE, two TCI states in which the UE cannot perform multi-panel simultaneous transmission.

The (2-1)^{th} embodiment describes a method in which the UE selects and transmits one CG PUSCH in consideration of priorities of two overlapping CG PUSCHs when two CG PUSCHs overlapping in the time domain cannot be simultaneously transmitted based on multiple panels. According to the method described in the (2-1)^{th} embodiment, the UE may not transmit the other CG PUSCH which is not selected due to having a lower priority, or may transmit only some resources not overlapping with other CG PUSCH. The (2-3)^{th} embodiment describes another method in which the UE determines transmission of one CG PUSCH, based on a priority, and processes a PUSCH other than the one determined CG PUSCH. Alternatively, when two CG PUSCH overlapping in the time domain cannot be simultaneously transmitted based on multiple panels, the UE may additionally consider a method in which the UE operates according to a default rule determined by the base station and the UE, rather than the method in which the UE selects one CG PUSCH according to a priority and transmits the same.

[Additional method 1] When the UE cannot simultaneously transmit, based on multiple panels, two CG PUSCHs overlapping in the time domain, the UE may calculate one PUSCH resource for the two CG PUSCHs and transmit both data and UCI (if UCI is multiplexed) transmitted to the two CG PUSCHs. The UE may refer to the configuration of the time and frequency resources allocated to the respective CG PUSCH and the MCS configuration to calculate one PUSCH resource in consideration of the two overlapping CG PUSCHs. Thereafter, as described in the (2-1)^{th} embodiment, the UE may select a TCI state for transmitting the determined CG PUSCH among the indicated TCI states through the method of determining one CG PUCH. The UE may apply the same to transmit the calculated PUSCH in consideration of two overlapping CG PUSCHs by using the TCI state selected through the corresponding method. Alternatively, the UE may apply the same to transmit the calculated PUSCH in consideration of two overlapping CG PUSCHs by using the TCI state determined according to a rule determined by the base station and the UE. According to an embodiment, the UE may multiplex both data and UCI transmitted to two CG PUSCHs to newly calculated PUSCH resources. Alternatively, according to an embodiment, the UE may multiplex all data transmitted to two CG PUSCHs to newly calculated PUSCH resources. For the UCI, the UE may multiplex only UCI included in a CG PUSCH (e.g., the first CG PUSCH) determined according to the (2-1)^{th} embodiment or the default operation from among two CG PUSCHs. Alternatively, according to an embodiment, the UE may multiplex all UCI transmitted to two CG PUSCHs to newly calculated PUSCH resources. For the data, the UE may multiplex only data included in a CG PUSCH (e.g., the first CG PUSCH) determined according to the (2-1)^{th} embodiment or the default operation from among two CG PUSCHs. Alternatively, according to an embodiment, the UE may multiplex all data (or UCI) only transmitted to two CG PUSCHs to newly calculated PUSCH resources. Alternatively, according to an embodiment, the UE may multiplex all data transmitted to two CG PUSCHs to newly calculated PUSCH resources, and for the UCI, the UE may multiplex UCI included a CG PUSCH (e.g., the first CG PUSCH) determined according to the (2-1)^{th} embodiment or the default operation from among two CG PUSCHs, and may determine whether to multiplex the UCI included in the other CG PUSCH in consideration of the type of the multiplexed UCI and the type of the UCI included in the other CG PUSCH. In addition, the UE may perform at least one of multiplexing all data only to newly calculated PUSCH resources, multiplexing all UCI only to newly calculated PUSCH resources, or multiplexing some data and some UCI to newly calculated PUSCH resources in consideration of the relationships among the data, the UCI, and one selected CG PUSCH or the other CG PUSCH.

[Additional Method 2] The UE may select one CG PUSCH according to one method (or in consideration of a combination of multiple methods) among the detailed methods 1 to 14 described in the (2-1)^{th} embodiment, and may multiplex information transmitted to an unselected CG PUSCH to the transmitted CG PUSCH. In this case, the UE may additionally multiplex only the UCI transmitted to the untransmitted CG PUSCH to the transmitted CG PUSCH. Alternatively, the UE may additionally multiplex only the data transmitted to the untransmitted CG PUSCH to the transmitted CG PUSCH. Alternatively, the UE may additionally multiplex both the UCI and the data transmitted to the untransmitted CG PUSCH to the transmitted CG PUCH. Alternatively, the UE may additionally multiplex the data transmitted to the untransmitted CG PUSCH to the transmitted CG PUSCH. The UE may determine whether to multiplex the UCI included in the untransmitted CG PUSCH to the transmitted CG PUSCH in consideration of the type of the UCI included in the transmitted CG PUSCH and the type of the UCI included in the untransmitted CG PUSCH. Unlike additional method 1, in additional method 2, the UE may not perform the operation of calculating one PUSCH resource in consideration of scheduling resources of two CG PUSCHs.

[Additional method 3] The UE may select one CG PUSCH according to one method (or in consideration of a combination of multiple methods) among the detailed methods 1 to 14 described in the (2-1)^{th} embodiment, and transmit the same. The UE may transmit the other CG PUSCH though other time resources after transmitting the one CG PUSCH. For example, the UE cannot simultaneously transmit two CG PUSCHs by using multiple panels, but may transmit two CG PUSCHs through different time resources, respectively. In this case, when CG PUSCHs are repeatedly transmitted, the UE may transmit the other CG PUSCH by using other time resources after repeated transmission of a CG PUSCH selected by the UE is completed. Alternatively, for CG PUSCHs repeatedly transmitted using a cyclical mapping method, the UE may perform only the first repeated transmission of the selected CG PUSCH and then perform the first repeated transmission of the other CG PUSCH in the resource in which the PUSCH can be transmitted. When the first repeated transmission of the other CG PUSCH is completed, the UE may perform the second repeated transmission of the selected CG PUSCH in the resource in which the PUSCH can be transmitted. Until repeated transmission of the CG PUSCH selected by the UE and the other PUSCH is completed, the UE may alternately transmit the above-described signals. Alternatively, the UE may repeatedly transmit the selected CG PUSCH N times (here, N is a positive integer smaller than equal to a total number of repeated transmission by the UE), and then may repeatedly transmit the other CG PUSCH N times. For example, the UE may repeatedly and alternately transmit the CG PUSCH selected by the UE and the other CG PUSCH N times.

[Additional method 4] When the UE cannot simultaneously transmit, based on multiple panels, two CG PUSCHs overlapping in the time domain, the UE may drop all CG PUSCH transmissions for multi-panel simultaneous transmission. For example, when the base station indicates, to the UE, two TCI states in which multi-panel simultaneous transmission cannot be performed and the two CG PUSCHs for multi-panel simultaneous transmission overlap in the time domain, the UE may drop both the overlapping CG PUSCHs. When the base station indicates, to the UE, two TCI states in which multi-panel simultaneous transmission cannot be performed and the two CG PUSCHs for multi-panel simultaneous transmission do not overlap in the time domain, the UE may transmit one CG PUSCH by referring to (applying) the associated TCI states.

[Additional method 5] When the UE cannot simultaneously transmit, based on multiple panels, two CG PUSCHs overlapping in the time domain, the UE may select one CG PUSCH according to one method (or in consideration of a combination of multiple methods) among the detailed methods 1 to 14 described in the (2-1)^{th} embodiment, and transmit the selected CG PUSCH by referring to a default beam defined in advance by the base station and the UE. In this case, the defined default beam is a beam defined in advance by the base station and the UE, and may be determined according to a specific rule. For example, the default beam may be the first TCI state configured using RRC. Alternatively, the TCI state may be the first TCI state of the first codepoint among codepoints activated through the MAC CE. Alternatively, the base station may separately configure a TCI state for determining the default beam for the UE through a higher-layer parameter. A new parameter for indicating the default beam may be included in a higher-layer configuration for a CG PUSCH, or may be included in a PUSCH configuration (e.g., PUSCH-Config) for a corresponding active UL BWP to apply the same to all PUSCHs. Alternatively, the default beam may be defined as a beam for receiving a specific CORESET. For example, the default beam is a beam for receiving CORESET #0, and may be defined in advance by the base station and the UE. Alternatively, the base station and the UE may define a beam used to transmit a RACH (Msg 1) used to perform initial access as a default beam in advance. Alternatively, the base station and the UE may define a beam sued to transmit Msg 3 used to perform initial access as a default beam in advance.

In the disclosure, a case where the base station and the UE operate according to a unified TCI frame is assumed, and a case of using a TCI state to indicate uplink and downlink transmission or reception based on a joint TCI among the multiple unified TCI framework-based operations is assumed. However, this is merely provided as an example, and the base station and the UE may operate based on a separate TCI. For example, the base station may configure a TCI-UL-state through a higher-layer parameter and active the AMC CE to indicate uplink transmission to the UE. The base station may indicate one of multiple codepoints (when the base station activates multiple codepoints through the MAC CE) through DCI, and the UE may transmit uplink signals by referring to the indicated TCI-UL-state from the first slot after the BAT.

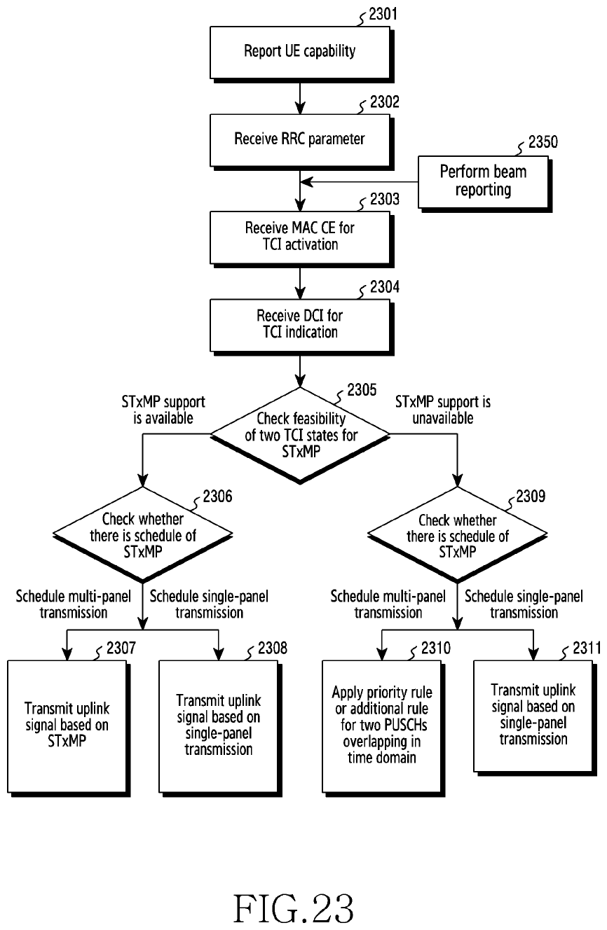

FIG. 23 is a flowchart illustrating an operation of a UE capable of supporting multi-panel simultaneous transmission.

In operation 2301, the UE may report, to the base station, UE capability including a parameter for indicating that multi-panel simultaneous transmission is available.

In operation 2302, the UE may receive a higher-layer parameter from the base station. In this case, the higher-layer parameter may include a parameter for supporting multi-panel simultaneous transmission and a parameter for a configured grant PUSCH (a type 1 CG PUSCH and/or a type 2 CG PUSCH) for supporting multi-panel simultaneous transmission. In addition, the UE may receive, through the higher-layer parameter received from the base station, both a configuration for supporting a unified TCI state and a higher-layer configuration for a TCI state according thereto.

In operation 2350, before receiving a MAC CE for activating a TCI state, the UE may perform beam reporting to the base station. Such beam reporting may be performed based on one or multiple combinations among the methods described in the first embodiment.

In operation 2303, the UE may receive the MAC CE for activating a codepoint used to indicate the TCI state from the base station.

In operation 2304, the UE may receive DCI indicating one of the activated codepoints from the base station, and may identify, based on the DCI, a TCI state applied to uplink transmission and downlink reception.

In operation 2305, the UE may identify, based on the received DCI, whether a TCI state applied from the first slot after a BAT from a time point at which a scheduled PUCCH is transmitted indicates a beam combination appropriate for multi-panel simultaneous transmission (STxMP).

In operation 2306, when the indicated TCI state indicates a beam combination in which the UE can support STxMP, the UE may identify whether the base station indicates that scheduled PUSCHs are simultaneously transmitted based on multiple panels.

In operation 2307, when the base station schedules CG PUSCHs to be transmitted across multiple panels, the UE may simultaneously transmit the scheduled PUSCHs by using the multiple panels.

In operation 2308, when the base station schedules CG PUSCHs to be transmitted through a single panel, the UE may simultaneously transmit the scheduled PUSCHs by using the single panel.

In operation 2309, when the indicated TCI state indicates a beam combination in which the UE cannot support STxMP, the UE may identify whether the base station indicates that scheduled PUSCHs are simultaneously transmitted based on multiple panels.

In operation 2310, when the base station schedules CG PUSCHs to be transmitted across multiple panels, the UE may transmit PUSCHs determined through one method (or a combination of multiple methods) among the above-described (2-1)^{th} embodiment and (2-3)^{th} embodiment. Here, when the base station schedules CG PUSCHs to be transmitted across multiple panels, it may mean a case where two CG PUSCHs, which are determined through the time/frequency resource, periodicity, and the like configured for the UE through the higher-layer parameter by the base station, overlap in the time domain and are transmitted. The base station may assume the higher-layer parameter so that the two CG PUSCHs satisfy a configuration condition for STxMP as described in the second embodiment above.

In operation 2311, when the base station schedules CG PUSCHs to be transmitted across a single panel, the UE may simultaneously transmit the scheduled PUSCHs by using the single panel.

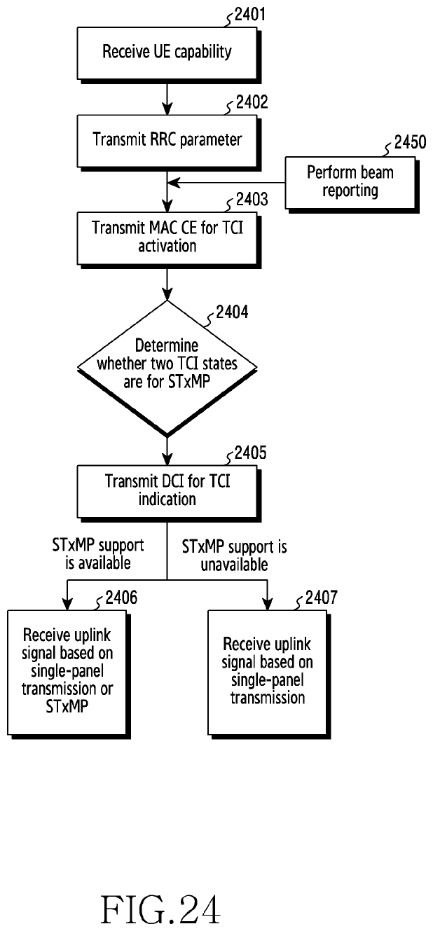

FIG. 24 is a flowchart illustrating an operation of a base station supporting a UE capable of supporting multi-panel simultaneous transmission.

In operation 2401, the base station may receive UE capability reported from the UE. In this case, the base station may identify through the UE capability received from the UE that the UE can perform multi-panel simultaneous transmission.

In operation 2402, the base station may transmit, based on the UE capability received from the UE, higher-layer parameters to the UE.

In operation 2450, the base station may receive beam reporting from the UE before transmitting a MAC CE for activating a TCI state to the UE. In this case, the beam reporting made by the UE may be an operation performed based on one or multiple combinations of the methods described in the first embodiment.

In operation 2403, the base station may transmit, to the UE, a MAC CE for indicating a codepoint for activating a TCI state, based on the received beam reporting.

In operation 2404, in order to indicate the corresponding UE, the base station may determine whether to indicate a TCI state for indicating a beam in which multi-panel-based simultaneous transmission is available or to indicate a TCI state for indicating a beam in which multi-panel-based simultaneous transmission is unavailable.

In operation 2405, the base station may transmit DCI to the UE to indicate the determined TCI state to the UE.

In operation 2406, when the TCI state indicated by the base station indicates a beam combination in which the UE can perform multi-panel simultaneous transmission, the base station may receive, from the UE, uplink signals transmitted based on multiple panels and uplink signals transmitted based on a single panel.

In operation 2407, when the TCI state indicated by the base station indicates a beam combination in which the UE cannot perform multi-panel simultaneous transmission, the base station may receive uplink signals transmitted based on a single panel from the UE.

According to various embodiments of the disclosure, some of the operations of the UE or the base station described in FIGS. 23 and 24 above may be omitted or the sequence of which may be changed. For example, the base station and the UE may perform the remaining operations even though the UE capability information is not transmitted or received, and the respective operations are not limited to be essential operations. In addition, detailed descriptions of the operations of FIGS. 23 and 24 can be specified by the related operations or configurations described throughout the description above.

### (2-4)^{th} Embodiment: Method in which UE Receives SPS PDSCH when UE Receives Indication of TC States in which Multi-Panel-Based Simultaneous Transmission or Reception is Unavailable

The (2-4)^{th} embodiment describes, in detail, additional methods in which the UE solves ambiguity in the UE operation by performing a specific operation according to a determined rule when the base station configures, for the UE, a higher-layer parameter for simultaneous transmission or reception based on multiple panels and indicates, to the UE, two TCI states in which multi-panel simultaneous transmission or reception cannot be performed.

Similar to the multi-panel uplink simultaneous reception, the ambiguity in the UE operation may also occur accosting to the indicated TCI state similar to the description above when the UE simultaneously receive semi-persistent (SPS) PDSCHs periodically received after receiving activation DCI. Accordingly, the methods described in detail in the (2-1)^{th} embodiment to the (2-3)^{th} embodiment may be also applied for simultaneous reception using multiple panels. For example, similar to the description in the (2-1)^{th} embodiment, the priorities may be applied to two PDSCHs overlapping in the time domain and the UE may thus select and receive one PDSCH. Accordingly, the operations described in the (2-1)^{th} embodiment to the (2-3)^{th} embodiment may be applied the same to the downlink signal reception operation based on the same contents.

### (2-5)^{th} Embodiment: Method in which UE Receives SRS when UE Receives Indication of TCI States in which Multi-Panel-Based Simultaneous Transmission or Reception is Unavailable

The (2-5)^{th} embodiment describes, in detail, additional methods in which the UE solves ambiguity in the UE operation by performing a specific operation according to a determined rule when the base station configures, for the UE, a higher-layer parameter for simultaneous transmission or reception based on multiple panels and indicates, to the UE, two TCI states in which multi-panel simultaneous transmission or reception cannot be performed.

According to various embodiments of the disclosure, when the UE is able to perform multi-panel uplink simultaneous transmission, the UE may simultaneously transmit SRS resources in two different SRS resource sets through the same OFDM symbol by using UE capability reporting for supporting multi-panel simultaneous transmission or additional UE capability. In order to support multi-panel-uplink simultaneous transmission, the usage of the two SRS resource sets transmitted by the UE may be configured as “codebook” or “nonCodebook”.

According to an embodiment, when “resourceType” corresponding to an RRC parameter for configuring a time domain behavior in two SRS resource sets for supporting multi-panel uplink simultaneous transmission is configured as “periodic”, the UE may repeatedly transmit the corresponding SRS resource sets at each determined period.

According to an embodiment, alternatively, when “resourceType” corresponding to an RRC parameter in two SRS resource sets is configured to be “semi-persistent”, the UE may receive DCI for activating transmission for the corresponding SRS resource sets and repeatedly transmit the corresponding SRS resource sets at each determined period before receiving DCI for deactivating the transmission. In this case, when the UE is able to simultaneously transmit SRS resources in different SRS resource sets by using different panels (for example, when the UE performs UE capability reporting for supporting the corresponding function to the base station), the base station may configure an RRC parameter so that the SRS resources in the two SRS resource sets are overlapped in the same OFDM symbol and transmitted. In a specific example, an RRC parameter may be configured so that an SRS resource (e.g., the first SRS resource) in the first SRS resource set and an SRS resource (e.g., the first SRS resource) in the second SRS resource set are overlapped in the same OFDM symbol and simultaneously transmitted. On the other hand, two different SRS resources in the same SRS resource set (e.g., the first SRS resource in the first SRS resource set and the second SRS resource in the first SRS resource set) may not be configured to be in the same OFDM symbol and simultaneously transmitted.

According to various embodiments of the disclosure, similar to the description made above, the ambiguity in the UE operation may also occur according to the indicated TCI state when SRS resources of two different SRS resource sets for supporting the multi-panel simultaneous transmission are simultaneously transmitted or received. Accordingly, the methods described in detail in the (2-1)^{th} embodiment to the (2-3)^{th} embodiment may be also applied to perform simultaneous reception using multiple panels. For example, similar to the description made in the (2-1)^{th} embodiment, the priorities may be applied to two SRS resources which need to overlap in the time domain, and the UE may select and receive one SRS resource. Accordingly, the operations described in the (2-1)^{th} embodiment to the (2-3)^{th} embodiment may be applied the same to the above-described SRS resource transmission and reception operation based on the same contents.

### Third Embodiment: Method in which UE Transmits, Based on Higher-Layer Operation, One CG PUSCH when UE when UE Receives Indication of TCI States in which Multi-Panel-Based Simultaneous Transmission or Reception is Unavailable

The third embodiment describes, in detail, a method in which the UE transmits one CG PUSCH through an operation of determining whether to perform higher-layer CG PUSCH transmission by the UE when the UE cannot perform multi-panel simultaneous transmission or reception, based on TCI states indicated to the UE by the base station.

According to various embodiments of the disclosure, when the UE cannot perform multi-panel simultaneous transmission or reception, based on TCI states indicated by the base station, the UE may transmit, through a higher layer, information indicating that currently indicated TCI state information is not appropriate for multi-panel simultaneous transmission or reception. To this end, when new information generated in the physical layer of the UE is transmitted to the base station through a higher layer, it may be understood that, in the higher-layer of the UE, physical resources of two CG PUSCHs simultaneously transmitted using multiple panels cannot be all used even though the physical resources overlap in the time domain.

According to an embodiment, when physical resources of two CG PUSCHs to be simultaneously transmitted using multiple panels by the UE can be transmitted at the same time, the UE may transmit two MAC PDUs to the physical layer through the higher layer of the UE so that the two MAC PDUs can be transmitted on the CG PUSCHs, respectively. For example, the UE may simultaneously transmit the CG PUSCHs by using panels, respectively, the UE may transmit two MAC PDCU transferred from the higher layer, to the base station by using the respective PUSCHs. However, as described above, the information indicating that multi-panel simultaneous transmission is not available due to the characteristics of the currently indicted TC states (for example, a case where two DCI states indicating two RSs not included in the same beam group of the group-based beam reporting, as reference signals, are indicated by the base station) has been notified from the physical layer to the higher layer of the UE, and thus the UE may determine only one MAC PDU to be transferred to the physical layer and transmitted to the base station and the other MAC PDU to be transmitted through another resource in the time domain even though two MAC PDUs to be transmitted in the higher layer are generated. For example, the UE may notify the higher layer of the UE of whether multi-panel simultaneous transmission is available from the physical layer of the UE, and the following higher-layer operations of the UE may be performed according to whether the multi-panel simultaneous transmission is available.

### (Operation 1: When Multi-Panel-Based Simultaneous Transmission by UE is Available)

When the UE generates two MAC PDUs to be transmitted to the base station and can use two different CG PUSCHs which can be simultaneously transmitted based on multiple panels, the higher layer of the UE may transfer the two generated MAC PDUs to the physical layer. Thereafter, the UE may simultaneously transmit MAC PDUs to the base station by using physical resources of two CG PUSCHs according to the configuration of the two CG PUSCHs which may overlap in the time domain.

### (Operation 2: When Multi-Panel-Based Simultaneous Transmission by UE is Unavailable)

When the UE generates two MAC PDUs to be transmitted to the base station and two CG PUSCHs which can be simultaneously transmitted based on multiple panels overlap in the time domain, the higher layer of the UE may transfer only one of the two generated MAC PDUs to the physical layer. Thereafter, the UE may transmit one MAC PDU to the base station by using only one of the physical resources of the two CG PUSCHs according to the configuration of the two CG PUSCHs which may overlap in the time domain. Thereafter, the UE may transmit the remaining MAC PDU not transmitted to the physical layer, by using PUSCH resources scheduled in other time resources. Alternatively, the UE may not transmit the MAC PDU which has failed to be transmitted to the physical layer to the base station.

### (Operation 3: When Multi-Panel-Based Simultaneous Transmission by UE is Unavailable)

When the UE generates two MAC PDUs to be transmitted to the base station and two CG PUSCHs which can be simultaneously transmitted based on multiple panels overlap in the time domain, the higher layer of the UE may transfer the two generated MAC PDUs to the physical layer. Thereafter, irrespective of whether the two indicated TCI states are appropriate for multi-panel-based simultaneous transmission, the UE may determine a transmission filter of a CG PUSCH transmitted through the first panel by using the first TCI state, and may determine a transmission filter of a CG PUSCH transmitted through the second panel as the second TCI state. When the UE does not determines a transmission filter for a panel in advance, the UE may determine a predetermined transmission filter according to the implementation of the UE. Accordingly, the UE may simultaneously transmit MAC PDUs to the base station by using physical resources of two CG PUSCHs according to configurations of two different CG PUSCHs which may overlap in the time domain by using the transmission filter determined for two panels.

### (Operation 4: When Multi-Panel-Based Simultaneous Transmission by UE is Unavailable)

When the UE generates two MAC PDUs to be transmitted to the base station and two CG PUSCHs which can be simultaneously transmitted based on multiple panels overlap in the time domain, the higher layer of the UE may transfer two MAC PDUs to the physical layer. Thereafter, the UE may transmit one MAC PDU to the base station by using only one of the physical resources of two CG PUSCHs according to configurations of two different CG PUSCHs which may overlap in the time domain. Thereafter, the UE may transmit the remaining MAC PDU transmitted to the physical layer to the base station by using a PUSCH resource scheduled to another time resource. Alternatively, the UE may not transmit the MAC PDU which has failed to be transmitted to the physical layer to the base station.

According to various embodiments of the disclosure, the description is merely provided as an example, operations 1 to 4 above may be operated in combination with various embodiments of the disclosure, and the base station may operate in consideration of a combination of all or some of operations 1 and 4 above.

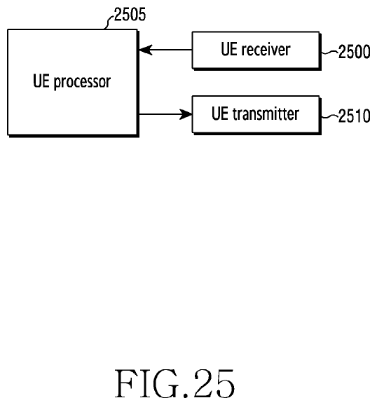

FIG. 25 illustrates a structure of a UE in a wireless communication system according to an embodiment of the disclosure.

Referring to FIG. 25, the UE may include a transceiver, which refers to a UE receiver 2500 and a UE transmitter 2510 as a whole, a memory (not illustrated), and a UE processor 2505 (or UE controller or processor). The UE transceiver 2500 and 2510, the memory, and the UE processor 2505 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with base stations. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver. In addition, the transceiver may receive signals through a radio channel, output the same to the processor, and transmit signals output from the processor through the radio channel.

The memory may store programs and data necessary for the operation of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform the operation of controlling the components of the UE by executing programs stored in the memory.

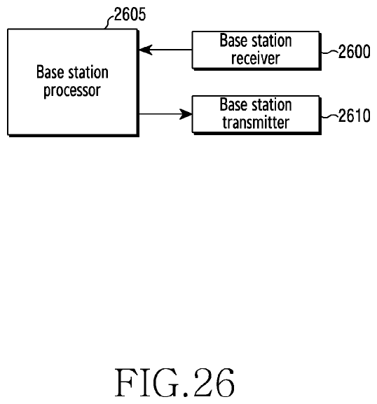

FIG. 26 illustrates a structure of a base station in a wireless communication system according to an embodiment of the disclosure.

Referring to FIG. 26, the base station may include a transceiver, which refers to a base station receiver 2600 and a base station transmitter 2610 as a whole, a memory (not illustrated), and a base station processor 2605 (or base station controller or processor). The base station transceiver 2600 and 2610, the memory, and the base station processor 2605 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver. In addition, the transceiver may receive signals through a radio channel, output the same to the processor, and transmit signals output from the processor through the radio channel.

The memory may store programs and data necessary for the operation of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform the operation of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A user equipment (UE) in a wireless communication system, the UE comprising:
a transceiver; and
a controller coupled to the transceiver,
wherein the controller is configured to:
receive, from a base station, a radio resource control (RRC) message including first information configuring a first configured grant (CG) physical uplink shared channel (PUSCH) and second information configuring a second CG PUSCH, wherein the first CG PUSCH is configured with a transmission configuration indicator (TCI) state associated with a first sounding reference signal (SRS) resource set index, and the second CG PUSCH is configured with a TCI state associated with a second SRS resource set index; and
in case that simultaneous transmission across multi-panel (STxMP) of the first CG PUSCH and the second CG PUSCH, based on the first TCI state and the second TCI state, is not available, transmit, to the base station, at least one of the first CG PUSCH or the second CG PUSCH according to a priority.

2. The UE of claim 1, wherein the priority includes at least one of a priority between the first TCI state and the second TCI state, a priority in a time domain between the first CG PUSCH and the second CG PUSCH, a priority in a frequency domain between the first CG PUSCH and the second CG PUSCH, a priority between a modulation coding scheme (MCS) of the first CG PUSCH and an MCS of the second CG PUSCH, a priority between a transport block (TB) size of the first CG PUSCH and a TB size of the second CG PUSCH, or a priority between a periodicity of the first CG PUSCH and a periodicity of the second CG PUSCH.

3. The UE of claim 1, wherein, in case that STxMP of the first CG PUSCH and the second CG PUSCH, based on the first TCT state and the second TCI state, is not available, the controller is further configured to:
transmit data associated with the first CG PUSCH and data associated with the second CG PUSCH on a resource corresponding to the first CG PUSCH;
transmit the second CG PUSCH with which the data associated with the first CG PUSCH is multiplexed;
prohibit transmitting the first CG PUSCH and the second CG PUSCH in transmission opportunities of the first CG PUSCH and the second CG PUSCH; or
transmit at least one of the first CG PUSCH or the second CG PUSCH according to a predefined default beam.

4. The UE of claim 1, wherein the controller is further configured to transmit, to the base station, capability information including information on a group of at least one beam supporting the STxMP.

5. A base station in a wireless communication system, the base station comprising:
a transceiver; and
a controller coupled to the transceiver,
wherein the controller is configured to:
transmit, to a user equipment (UE), a radio resource control (RRC) message including first information configuring a first configured grant (CG) physical uplink shared channel (PUSCH) and second information configuring a second CG PUSCH, wherein the first CG PUSCH is configured with a transmission configuration indicator (TCI) state associated with a first sounding reference signal (SRS) resource set index, and the second CG PUSCH is configured with a TCI state associated with a second SRS resource set index; and
in case that simultaneous transmission across multi-panel (STxMP) of the first CG PUSCH and the second CG PUSCH, based on the first TCI state and the second TCI state, is not available, receive, from the UE, at least one of the first CG PUSCH or the second CG PUSCH according to a priority.

6. The base station of claim 5, wherein the priority includes at least one of a priority between the first TCI state and the second TCI state, a priority in a time domain between the first CG PUSCH and the second CG PUSCH, a priority in a frequency domain between the first CG PUSCH and the second CG PUSCH, a priority between a modulation coding scheme (MCS) of the first CG PUSCH and an MCS of the second CG PUSCH, a priority between a transport block (TB) size of the first CG PUSCH and a TB size of the second CG PUSCH, or a priority between a periodicity of the first CG PUSCH and a periodicity of the second CG PUSCH.

7. The base station of claim 5, wherein, in case that STxMP of the first CG PUSCH and the second CG PUSCH, based on the first TCT state and the second TCI state, is not available, the controller is further configured to:
receive data associated with the first CG PUSCH and data associated with the second CG PUSCH on a resource corresponding to the first CG PUSCH;
receive the second CG PUSCH with which the data associated with the first CG PUSCH is multiplexed;
prohibit receiving the first CG PUSCH and the second CG PUSCH in transmission opportunities of the first CG PUSCH and the second CG PUSCH; or
receive at least one of the first CG PUSCH or the second CG PUSCH according to a predefined default beam.

8. The base station of claim 5, wherein the controller is further configured to receive, from the UE, capability information including information on a group of at least one beam supporting the STxMP.

9. A method performed by a user equipment (UE) in a wireless communication system, the method comprising:
receiving, from a base station, a radio resource control (RRC) message including first information configuring a first configured grant (CG) physical uplink shared channel (PUSCH) and second information configuring a second CG PUSCH, wherein the first CG PUSCH is configured with a transmission configuration indicator (TCI) state associated with a first sounding reference signal (SRS) resource set index, and the second CG PUSCH is configured with a TCI state associated with a second SRS resource set index; and
in case that simultaneous transmission across multi-panel (STxMP) of the first CG PUSCH and the second CG PUSCH, based on the first TCI state and the second TCI state, is not available, transmitting at least one of the first CG PUSCH or the second CG PUSCH to the base station according to a priority.

10. The method of claim 9, wherein the priority includes at least one of a priority between the first TCI state and the second TCI state, a priority in a time domain between the first CG PUSCH and the second CG PUSCH, a priority in a frequency domain between the first CG PUSCH and the second CG PUSCH, a priority between a modulation coding scheme (MCS) of the first CG PUSCH and an MCS of the second CG PUSCH, a priority between a transport block (TB) size of the first CG PUSCH and a TB size of the second CG PUSCH, or a priority between a periodicity of the first CG PUSCH and a periodicity of the second CG PUSCH.

11. The method of claim 9, further comprising, in case that STxMP of the first CG PUSCH and the second CG PUSCH, based on the first TCT state and the second TCI state, is not available:
transmitting data associated with the first CG PUSCH and data associated with the second CG PUSCH on a resource corresponding to the first CG PUSCH;
transmitting the second CG PUSCH with which the data associated with the first CG PUSCH is multiplexed;
transmitting the first CG PUSCH and the second CG PUSCH in transmission opportunities of the first CG PUSCH and the second CG PUSCH; or
transmitting at least one of the first CG PUSCH or the second CG PUSCH according to a predefined default beam.

12. The method of claim 9, further comprising transmitting, to the base station, capability information including information on a group of at least one beam supporting the STxMP.

13. A method performed by a base station in a wireless communication system, comprising:
transmitting, to a user equipment (UE), a radio resource control (RRC) message including first information configuring a first configured grant (CG) physical uplink shared channel (PUSCH) and second information configuring a second CG PUSCH, wherein the first CG PUSCH is configured with a transmission configuration indicator (TCI) state associated with a first sounding reference signal (SRS) resource set index, and the second CG PUSCH is configured with a TCI state associated with a second SRS resource set index; and
in case that simultaneous transmission across multi-panel (STxMP) of the first CG PUSCH and the second CG PUSCH, based on the first TCI state and the second TCI state, is not available, receiving, from the UE, at least one of the first CG PUSCH or the second CG PUSCH according to a priority.

14. The method of claim 13, wherein the priority includes at least one of a priority between the first TCI state and the second TCI state, a priority in a time domain between the first CG PUSCH and the second CG PUSCH, a priority in a frequency domain between the first CG PUSCH and the second CG PUSCH, a priority between a modulation coding scheme (MCS) of the first CG PUSCH and an MCS of the second CG PUSCH, a priority between a transport block (TB) size of the first CG PUSCH and a TB size of the second CG PUSCH, or a priority between a periodicity of the first CG PUSCH and a periodicity of the second CG PUSCH.

15. The method of claim 13, further comprising, in case that STxMP of the first CG PUSCH and the second CG PUSCH, based on the first TCT state and the second TCI state, is not available:
receiving data associated with the first CG PUSCH and data associated with the second CG PUSCH on a resource corresponding to the first CG PUSCH;
receiving the second CG PUSCH with which the data associated with the first CG PUSCH is multiplexed;
receiving the first CG PUSCH and the second CG PUSCH in transmission opportunities of the first CG PUSCH and the second CG PUSCH; or
receiving at least one of the first CG PUSCH or the second CG PUSCH according to a predefined default beam.
